(19) United States
(12) Patent Application Publication
(10) Pub. No.: US 2003/0068097 A1
(43) Pub. Date: Apr. 10, 2003

(54) Adaptive mean estimation and normalization of data

(75) Inventors: Sanford L. Wilson, Chelmsford, MA (US); Thomas J. Green JR., Oak Hill, VA (US); Eric J. Van Allen, Woburn, MA (US); William H. Payne JR., Nashua, NH (US); Steven T. Smith, Cambridge, MA (US)

Correspondence Address: Theresa A. Lober, T. A. Lober Patent Services, 45 Walden Street, Concord, MA, 01742, US

(73) Assignee: Massachusetts Institute of Technology, Cambridge, OH

(21) Appl. No.: 10/172,250

(22) Filed: Jun. 14, 2002

Related U.S. Application Data
(60) Provisional application No. 60/298,479, filed on Jun. 15, 2001.

(51) Int. Cl. G06K 9/36

(52) U.S. Cl. 382/276

(57) ABSTRACT

A method of determining a mean for a data set of data element values. A form of a probability density function statistical distribution is selected for each data element of the data set, based on the value of that data element. Then a mean of the probability density function of each data element is estimated, by, e.g., a digital or analog processing technique. The estimated mean of each data element's probability density function is then designated as the mean for that data element. In a method of normalizing a data set of data element values based on estimated probability density function means of the data set, each data element value in the data set is processed based on the estimated mean of the probability density function of that data element to normalize each data element value, producing a normalized data set.

This application claims the benefit of U.S. Provisional Application No. 60/298,479, filed Jun. 15, 2001, the entirety of which is hereby incorporated by reference.

### STATEMENT REGARDING FEDERALLY SPONSORED RESEARCH

This invention was made with Government support under Contract No. F19628-00-C-002, awarded by the Air Force. The Government has certain rights in the invention.

### BACKGROUND OF THE INVENTION

This invention relates to techniques for reducing the dynamic range of data, and more particularly relates to data normalization methods for dynamic range reduction.

Many data acquisition systems produce data having a high dynamic range. For example, digitized image data produced by, e.g., an imager capable of high dynamic range, will be of a correspondingly high dynamic range. Similarly, the inherent characteristics of X-ray, ultrasound, sonar, and other such acquisition techniques can result in a high dynamic range of data. Although a high dynamic range data set can be advantageous in its inclusion of a substantial range of data values, a high dynamic range data set can pose significant processing and analysis challenges. For example, a conventional display device often cannot accommodate display of the full dynamic range of a high dynamic range image. Similarly, a transmission channel often cannot accommodate the bandwidth required to transmit high dynamic range data, resulting in a requirement for data compression. In addition, a high dynamic range data set often cannot be fully perceived and/or interpreted; the dynamic range of signals over which human perception extends is generally about 12 dB. High dynamic range data sets also can pose difficulties for pattern recognition and other such intelligent processing techniques.

To overcome these and other challenges presented by high dynamic range data, there have been proposed many techniques for reducing the dynamic range of a data set to a reduced dynamic range that can be more easily accommodated. This is typically achieved in general by normalization of the data set by a selected parameter related to the data. In one such technique, a statistical mean is determined for each data element in the set of data element values, and each data element value is then normalized by its corresponding mean. The resulting data element set is characterized by a dynamic range that is lower than that of the original data element set. Each data element's mean is here determined as the statistical mean, i.e., statistical average, of a neighborhood, or group, of data values around and including that data element in the set. It is found that this technique can indeed reduce the dynamic range of a data set, with increasing dynamic range reduction resulting as the neighborhood of data elements over which a given element's statistical mean is determined is reduced.

Although this generalized normalization technique, often referred to as the sliding window averaging technique, is widely applicable, it is found to have a limited ability to accommodate many data set characteristics and peculiarities. For example, consider a data element set in which a particular data element has a value that is significantly different, e.g., higher, than that of its neighboring data elements. In this case, the statistical mean for the data element neighborhood including the high-valued element would be correspondingly biased high, and when normalized by this high mean value, the normalized high-valued data element would be biased quite low. As a result, the contrast of the high-valued data element with its neighbors would be lost in the normalized data set. But for many applications, this loss of local contrast is unacceptable because the high-valued data element could be representative of an important aspect of the data. For example, in an image data array, a high-valued data element could represent a star in the sky; it would be preferable to maintain local contrast in a normalized image such that the distinction of a pixel value representing a star against the locally dark night sky would be preserved. The inability of conventional normalization techniques to preserve local contrast while at the same time globally reducing dynamic range is thus a significant limitation for many applications.

Similarly, consider a data element set in which a discontinuity in data element values, e.g., from low values to high values, occurs in a neighborhood of data elements. In this case, the statistical mean determined for the element neighborhood would be biased artificially high for elements on the low side of the discontinuity and would be biased artificially low for elements on the high side of the discontinuity. When normalized by the artificially biased statistical means, the neighborhood of data elements would include normalized element values that are fictitious, i.e., element values that are not representative of the true data element values.

Beyond the characteristic failings of conventional sliding window averaging, or neighborhood normalization, techniques described above, such techniques are found generally to accommodate very little processing flexibility. For example, as explained above, the degree of dynamic range reduction produced by such techniques is related to the extent of data elements to be included in an element neighborhood considered in determining the statistical mean of a data element in that neighborhood; a smaller data element neighborhood results in a larger dynamic range reduction. Generally, conventional processes do not accommodate flexibility in the specification of data element neighborhood extent, thereby requiring definition of a separate process for each neighborhood extent of interest. This leads to process inefficiency and for some applications an inability to provide adequate dynamic range reduction with the processes that are made available.

For many critical data acquisition and analysis applications, particularly medical and security applications, operational failures and processing limitations like those described above are unacceptable. Vital data produced by, e.g., medical or security imaging applications, among other critical applications, cannot be assumed to exhibit a particular uniformity or to require a particular dynamic range reduction. But due to the operational failures described above, conventional neighborhood normalization techniques can generally be reliably employed only for data sets in which the data is uniformly distributed across the set. Various elaborations of neighborhood normalization have been proposed to address this limitation by, e.g., iterative determination of the statistical mean of a data element neighborhood that includes data elements having values that exceed or fall below specified thresholds. While such elaborations are found to address operational failures to some extent, they typically cannot accommodate data sets including data element values above or below an expected range of values, and are computationally inefficient due to the nature of statistical averaging and data element comparison operations. Thus, conventional neighborhood normalization techniques are in general not acceptable for providing accurate, robust, reliable dynamic range reduction of critical data.

### SUMMARY OF THE INVENTION

The invention overcomes limitations of prior conventional neighborhood normalization techniques to enable normalization of a data set by a technique that is sufficiently robust to be applied with confidence to even critical medical and security data acquisition and analysis applications. Such a robust normalization process is enabled by providing, in accordance with the invention, a method of determining a mean for a data set of data element values. In this method, a form of a probability density function statistical distribution is selected for each data element of the data set, based on the value of that data element. Then a mean of the probability density function of each data element is estimated, by, e.g., a digital or analog processing technique. The estimated mean of each data element's probability density function is then designated as the mean for that data element.

This model-based mean estimation technique provided by the invention inherently takes into account the values of all data elements in a data set when estimating the probability density function mean of each data element in the set. As a result, no local neighborhoods, or blocks, of data elements need be defined and/or adjusted to estimate a probability density function mean for each data element. Further, no assumptions of the data element values themselves are required.

In addition, the probability density function mean estimation method of the invention accommodates discontinuities from one estimated data element probability density function mean to the next. That is, local discontinuities are acceptable, with the estimated probability density function means of data elements not in the neighborhood of a discontinuity expected to change locally smoothly. This guarantees that the operational failures of the conventional techniques described above do not occur.

The invention further provides a method of normalizing a data set of data element values based on estimated probability density function means of the data set. Here each data element value in the data set is processed based on the estimated mean of the probability density function of that data element to normalize each data element value, producing a normalized data set.

Because the probability density function mean estimation process of the invention does not artificially bias the estimated probability density function mean of a data element that has a value which significantly departs from that of neighboring elements, local contrast between data element values is preserved even after normalization of the data set by the estimated probability density function means. The probability density function mean estimation method and the corresponding normalization method of the invention thereby overcome the inability of conventional averaging techniques to preserve meaningful data characteristics in normalized data sets, and eliminate the operational failures generally associated with such averaging techniques.

The probability density function mean estimation and normalization processes provided by the invention can be applied to a wide range of data set applications, e.g., processing of images, ultrasound, MRI, X-ray, radar, sonar, radio and video, communications signals, and other such applications. Normalization of a data set in accordance with the invention provides for dynamic range reduction of a data set, thereby to enable, e.g., simultaneous display of the entire dynamic range across an image. Normalization of a data set in accordance with the invention also provides for reduction of noise in a data set, thereby to enable precise measurement and analysis of the data set.

Other features and advantages of the invention will be apparent from the following description and accompanying figures, and from the claims.

### BRIEF DESCRIPTION OF THE DRAWINGS

FIG. 1 is a flow diagram of a data set normalization process provided by the invention;

FIG. 2A is a schematic diagram of a physical spring system the operation of which provides an analogy to the MAP probability density function (pdf) mean estimation process provided by the invention;

FIG. 2B is a schematic diagram of an extension of the physical spring system of FIG. 2A;

FIG. 3 is a plot of input settings and the corresponding output results for the spring system of FIG. 2B;

FIG. 4 is a plot of an input setting of a step discontinuity and the corresponding output results for the spring system of FIG. 2B;

FIG. 5 is a plot of an input setting of a so-called “tophat” discontinuity and the corresponding output results for the spring system of FIG. 2B;

FIG. 6 is a plot of inverted system matrix row values for the spring system of FIG. 2B with a first selected smoothness parameter imposed on the system;

FIG. 7 is a plot of inverted system matrix row values for the spring system of FIG. 2B with a second selected smoothness parameter imposed on the system;

FIG. 8 is a plot of potential energy for a selected probability density function imposed on the spring system of FIG. 2B;

FIG. 9 is a plot of inverted system matrix row values from a first solution iteration of a one-dimensional pdf mean estimation process provided by the invention;

FIG. 10 is a plot of inverted system matrix row values from a second solution iteration of a one-dimensional pdf mean estimation process provided by the invention;

FIG. 11 is a plot of an input including a “tophat” discontinuity and the corresponding outputs produced by two solution iterations of the one-dimensional pdf mean estimation process of the invention for a first selected smoothness parameter;

FIG. 12 is a plot of inverted system matrix row values from an input including a “tophat” discontinuity of the plot of FIG. 11, from a first solution iteration of the pdf mean estimation process of the invention;

FIG. 13 is a plot of inverted system matrix row values to an input including a “tophat” discontinuity of the plot of FIG. 11, from a second solution iteration of the pdf mean estimation process of the invention;

FIG. 14 is a plot of an input including a “tophat” discontinuity and the corresponding outputs produced by two solution iterations of the one-dimensional pdf mean estimation process of the invention for a second selected smoothness parameter;

FIG. 15 is a plot of inverted system matrix row values from an input including a “tophat” discontinuity of the plot of FIG. 14, of a first processing iteration of the pdf mean estimation process of the invention;

FIG. 16 is a plot of inverted system matrix row values from the input including a “tophat” discontinuity of the plot of FIG. 14, of a second processing iteration of the pdf mean estimation process of the invention;

FIG. 17A is a flow diagram of a one-dimensional pdf mean estimation process of the invention;

FIG. 17B is a flow diagram of a one-dimensional by one-dimensional pdf mean estimation process of the invention;

FIG. 17C is a flow diagram of a two-dimensional pdf mean estimation process of the invention;

FIG. 18 is a plot of an example two-dimensional data set to be processed in accordance with the invention;

FIG. 19 is a plot of two-dimensional pdf mean estimation results produced by a first solution iteration of the pdf mean estimation process of the invention when applied to the data set of FIG. 18;

FIG. 20 is a plot of two-dimensional pdf mean estimation results produced by a second solution iteration of the pdf mean estimation process of the invention when applied to the data set of FIG. 18 and the first solution iteration results of FIG. 19;

FIGS. 21A-21B are images of an outdoor night time scene, adjusted to emphasize local contrast in the region of the sky and adjusted to emphasize local contrast in the region of the ground, respectively;

FIG. 21C is the outdoor night time scene image of FIGS. 21A-21B, here rendered by the pdf mean estimation and normalization processes of the invention to produce an image in which local contrast is preserved across the entire image;

FIG. 22 is a flow diagram of an example implementation of the two-dimensional pdf mean estimation and normalization processes provided by the invention;

FIGS. 23A-23L are flow diagrams of particular tasks to be carried out in the example two-dimensional pdf mean estimation and normalization implementation of the flow diagram of FIG. 22; and

FIGS. 24A-24B are outdoor night scene images rendered by the pdf mean estimation and normalization processes of the invention with full normalization and a partial normalization processes, respectively, imposed on the images.

### DETAILED DESCRIPTION OF THE INVENTION

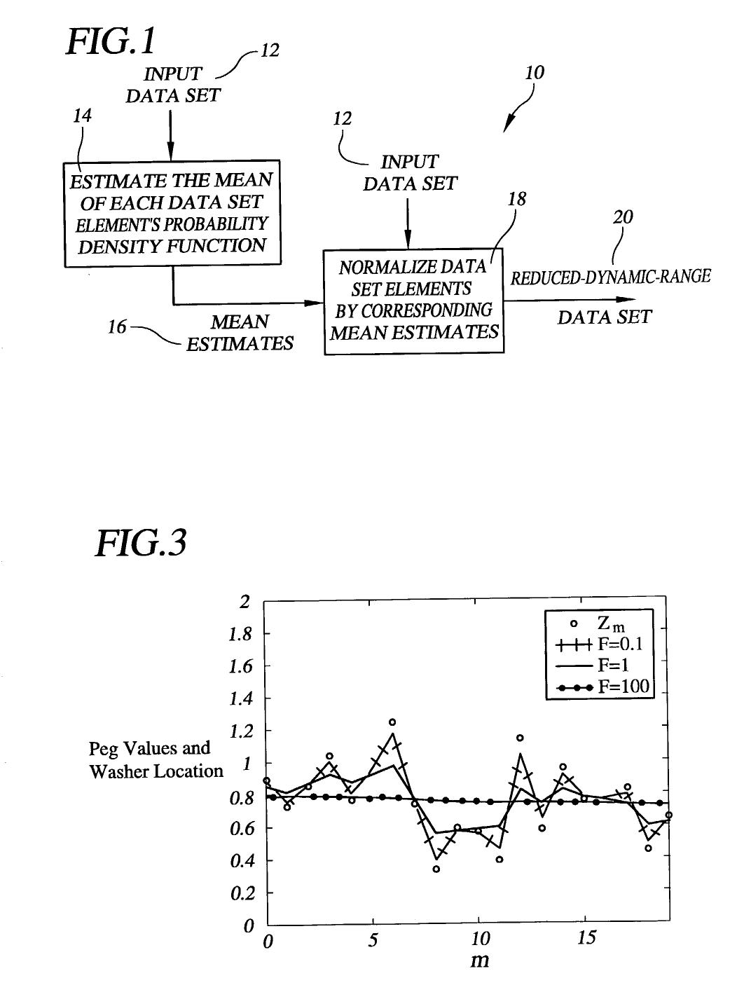

Referring to the block diagram of FIG. 1, the adaptive normalization technique of the invention 10 can be carried out on a wide range of data sets 12, e.g., digitized image data, camera and video images, X-ray and other image data, acoustic data such as sonar and ultrasound data, and in general any data set or array of data for which normalization of the data is desired. In general, such data set normalization is particularly well-suited as a technique for reducing the dynamic range and/or noise level characteristic of the data set. Specific data sets and particular applications of the technique of the invention will be described below, but it is to be recognized that the invention is not strictly limited to such.

In accordance with the invention, a selected data set 12 is first processed to estimate 14 the statistical mean of the probability density function of each data element in the data set. This estimate produces a set of data element probability density function mean estimates 16. The input data set 12 is then processed based on this set of data element probability density function mean estimates 16 to normalize 18 each data set element by its corresponding probability density function mean estimate. The resulting normalized set of data elements is for most applications characterized as a reduced-dynamic-range data set 20; in other words, the as-produced data set dynamic range is reduced by the normalization process. Similarly for many applications, the normalization process results in a reduction in noise of data set element values; i.e., the as-produced data set noise is reduced by the normalization process.

As explained in detail below, the method of the invention for estimating the statistical mean of a probability density function of data elements of a data set provides particular advantages over conventional approaches that carry out a simple averaging of data element values. In accordance with the invention, the value of each data element in a data set is treated as a draw from a distribution of possible values for that data element. Specifically, the form of a probability density function (pdf) statistical distribution of possible values for a data element is a priori assumed for each data element. With this a priori knowledge, the technique of the invention provides an estimation of the statistical mean of the probability density function the form of which has been assumed for each data element, based on the known data element value.

This model-based technique inherently takes into account the values of all data elements in a data set when estimating the pdf mean of each data element in the set. An a priori assumption of the form of a distribution of data element pdf means across the data set enables such. As a result, no local neighborhoods, or blocks, of data elements need be defined and/or adjusted to determine a pdf statistical mean for each data element. Further, no assumptions of the data element values themselves are required. Specifically, the estimation technique of the invention allows for the estimated pdf means to be varying and requires only that such variation be locally smooth away from discontinuities. That is, the statistical means to be estimated for the data set element pdfs are assumed to change smoothly from element to element, i.e., the data element pdf means are locally smooth, but no limits as to data element values are made.

In addition, the pdf mean estimation method of the invention accommodates discontinuities from one estimated data element pdf mean to the next. That is, local discontinuities are acceptable, with the estimated pdf means of data elements not in the neighborhood of a discontinuity expected to change locally smoothly. This guarantees that the operational failures of the conventional techniques described above do not occur. Such accommodation of discontinuities is enabled in accordance with the invention by an adjustable parameter of the estimation process that allows for discontinuities to occur in the most probable manner.

This probabilistic adjustment can be implemented based on a number of estimation procedures provided by the invention, as explained in detail below. One particularly preferably estimation procedure, the Maximum a posteriori (MAP) estimation procedure, further accommodates data element values that significantly depart from the assumed data element pdf; in other words, no local limit on data element values is required. But even without such a data element value limit, the pdf mean estimation method of the invention does not bias the estimated pdf mean of a data element that has a value which significantly departs from that of neighboring elements. This results in preservation of local contrast between data element values even after normalization of the data set. The pdf mean estimation method of the invention thereby overcomes the inability of conventional averaging techniques to preserve meaningful data characteristics, and eliminates the operational failures generally associated with such averaging techniques.

In addition to the operational advantages just described, the pdf mean estimation method of the invention is found to be computationally efficient and to be extremely flexible in accommodating processing adjustments to a achieve a desired normalization or dynamic range reduction. As a result of this computational efficiency, in combination with superior operational performance, the mean estimation method of the invention is particularly well-suited for reliable processing of critical data. Each of these advantages will be more clearly pointed out as the details of the method of the invention are described below.

From the discussion above, it is clear that the pdf statistical mean estimation technique of the invention provides significant advantages over conventional simple averaging techniques. It is contemplated by the invention that this pdf statistical mean estimation technique can be employed for a range of processes in addition to normalization of a data set.

The pdf statistical mean estimation technique preferred in accordance with the invention, namely, the MAP estimation technique introduced above, is based on Bayes estimation, which allows for the minimization of a selected function. Bayes estimation procedure is here specifically employed to carry out minimization of the error between a computation of the joint probability density function of an assumed distribution of data element pdf mean values across a data set and an a priori model for the pdf mean of nearest neighbor data elements in the data set. Consider an observation, Z, that depends on unknown random parameters, X. Bayes estimation procedure enables an estimation of X In the specific context of the invention, the observation, Z, corresponds to a set of data element values, and the random parameter, X, corresponds to the unknown statistical means of the probability density functions that are assumed for the set of data elements.

In accordance with Bayes estimation, a cost function, C(x, \hat{x}(Z)), is defined, where x is the unknown value of a data element's pdf mean and \hat{x}(Z) is an estimate of that unknown pdf mean, based on the known set of data element values Z. An a priori assumption of the distribution form of data element pdf means across a data set is given by pₓ(X). For the pdf mean estimation method of the invention, the Bayes estimation cost function can be defined based on the error of the pdf mean estimate to be made and the unknown pdf mean. This error, x_{ε}, is can be given as:

x_{ε}=\hat{x}(Z)−x. (1)

Various cost function forms can be imposed on this error function. Two well-suited cost functions are a quadratic cost function, C(x_{ε})=x_{ε}², and a uniform cost function given as:

$$C ( {x}_{ϵ} ) = \{ \begin{matrix}0 , & \vert {x}_{ϵ} \vert \leq Δ \text{/} 2 , \\ 1 , & \vert {x}_{ϵ} \vert > Δ \text{/} 2 ,\end{matrix} \qquad ( 2 )$$

where Δ is an arbitrarily small but nonzero number; the limit as Δ→0 will be considered below.

With a selected cost function imposed on the error function of expression (1), a risk function, R, can then be defined as the expected value of the cost function, as:

R=E[C(x,\hat{x}(Z))]=∫dX∫C[X−\hat{x}]p_{x,z}(X,Z) dZ, (3)

where P_{x,z}(X, Z) is the joint a priori probability density functions of the data set elements' unknown pdf means, X, and the observed data set element values, Z. The integration in expression (3) is over all the support of the variables.

In accordance with Bayes estimation, this risk function is to be minimized. Moving to that procedure, it can be convenient to express the joint probability density, p_{x,z}(X,Z), of the a priori unknown data element pdf means and the observed data element values as:

p_{x,z}(X,Z)=p_{z}(Z)p_{x|z}(X|Z), (4)

where p_{z}(Z) is the a priori assumed form of the probability density function of the data elements' value pdfs, and p_{x|z}(X|Z) is the a priori assumed form of the probability density function of the distribution of pdf means across the data set for the given data element values.

As an example consider the first cost function which was the quadratic error. The risk function in this case is called the mean squared error risk function, Rₘₓ, and by changing the order of integration can be expressed as:

Rₘₛ=∫p_{z}(Z)dZ∫(X−\hat{x})^{T}(X−\hat{x})p_{x|z}(X|Z)dX, (5)

where T denotes transposition.

With these definitions, the data element value pdf, p_{z}(Z), and the inner integral of the risk function are non-negative. The risk function can therefore be minimized by minimizing the inner integral. Let the mean square estimate of the unknown data element pdf mean be denoted as \hat{x}ₘₛ. Then differentiation of the inner integral of expression (5) with respect to \hat{x}ₘₛ and setting the result to zero produces the desired minimization as:

0=−2∫Xp_{x|z}(X|Z)dX+2\hat{x}ₘₛ|p_{x|z}(X|Z)dX. (6)

The integral in the second term is unity, resulting in a rearrangement of expression (6) to specify the pdf mean square estimate, \hat{x}ₘₛ, as:

\hat{x}ₘₛ=∫Xp_{x|z}(X|Z)dX, (7)

where this expression formally defines the statistical mean of the a posteriori pdf of a data element.

As a second example consider the second cost function which was the uniform cost function. The risk function in this case is called the uniform error risk function, R_{unf}, and the risk expression (3) can be imposed on this as:

$${R}_{unf} = \int {p}_{z} ( Z ) ⅆ Z [ 1 - {\int }_{{\hat{X}}_{{unf}^{Δ \text{/} 2}}}^{{\hat{X}}_{{unf}^{+ Δ \text{/} 2}}} {p}_{x \vert z} ( X \vert Z ) ⅆ X ] , \qquad ( 8 )$$

that is, the uniform cost function is unity minus the neighborhood of the data element set where the cost function is zero. Note that this neighborhood extends in all directions corresponding to the dimensionality of the unknown set of data element pdf means, X. To minimize this risk, it is sufficient to minimize the inner bracketed term in Equation 8, or equivalently, to maximize the inner integral over dX.

Assuming that Δ is very small, then the best choice for the uniform cost estimate, \hat{x}_{unf}, is located in solution space at the point where the pdf, p_{x|z}(X|Z), of a data element array achieves its maximum; i.e., where the expression subtracts off the largest possible value from unity, to therefore minimize the corresponding risk and error. Because the mathematical function of logarithm is a monotonic function of its argument, this expression can then be restated as a solution of the maximum of 1n p_{x|z}(X|Z) just as well. Then the uniform error case result produces the uniform pdf mean estimate, \hat{x}_{unf}, as the solution to:

∇_{X}1nP_{x|z}(X|Z)|_{X=\hat{x}}_{_{unf}}=0, (9)

where ∇ is the gradient operation in the space of the dimensions of the data set X. This expression is called the maximum a posteriori, or MAP estimate, of the statistical means of data element pdfs, and will be denoted by \hat{x}_{MAP}. Although the mean square error estimator technique described above, as well as a range of alternative estimation techniques, are also viable, it can for many applications be preferred to employ a MAP estimation technique, and such is preferred in accordance with the invention. In most cases the computational requirements of carrying out the derivatives of expression (9) are less than that of carrying out the integration required of expression (7) above.

Considering an example of one of the many alternative estimation techniques contemplated by the invention, consider a cost function of C(x₆₈ )=|x₆₈ |. The corresponding absolute value risk function is given by:

$${R}_{abs} = {\int }_{- ∞}^{∞} ⅆ {Zp}_{Z} ( Z ) {\int }_{- ∞}^{∞} ⅆ X \vert X - {\hat{X}}_{abs} \vert {p}_{X \vert Z} ( X \vert Z ) . \qquad ( 10 )$$

In this expression, let I(Z) denote the value of the inner integral to be minimized. This can be expressed as:

$$\begin{matrix}I ( Z ) = {\int }_{- ∞}^{{\hat{X}}_{abs}} ⅆ X ( {\hat{X}}_{abs} - X ) {p}_{X \vert Z} ( X \vert Z ) + \\ {\int }_{{\hat{X}}_{abs}}^{∞} ⅆ X ( X - {\hat{X}}_{abs} ) {p}_{X \vert Z} ( X \vert Z ) .\end{matrix} \qquad ( 11 )$$

Taking the derivative with respect to \hat{X}_{abs} and setting the result equal to zero results in:

$${\int }_{- ∞}^{{\hat{X}}_{abs}} ⅆ {Xp}_{X \vert Z} ( X \vert Z ) = {\int }_{{\hat{X}}_{abs}}^{∞} ⅆ {Xp}_{X \vert Z} ( X \vert Z ) , \qquad ( 12 )$$

which is the definition of the median of the a posteriori density. In many cases the mean square estimate, the absolute value estimate, and the MAP estimate are all equal and thus using the one that is most efficient is equivalent to using any of the other cost functions. This is a special case of a much more general result for a large class of cost functions possessing either of two properties, the first of which requires that the a posteriori density function p_{X|Z}(X|Z) be symmetric about its conditional mean and be a unimodal function that satisfies the following condition:

lim_{x→∞}C(x)p_{X|Z}(x|Z)=0, (13)

and that the cost function, C(x), be a symmetric nondecreasing function. This property is possessed by the uniform cost function that leads to the MAP estimate preferred in accordance with the invention. The second property requires that the a posteriori density function p_{X|Z}(X|Z) be symmetric about its conditional mean and that the cost function C(x) be symmetric and convex upward, that is, it must satisfy the following two properties:

C(x)=C(−x), (symmetry) (14a)

and

C(bx₁+(1−b)x₂)≦bC(x₁)+(1−b) C(x₂). (convexity) (14b)

This property is possessed by both the absolute value and the mean squared cost functions. The result is that a pdf mean estimate employing almost any cost function possessing either of these properties will be identical to the mean squared estimate. This is a powerful result in that choosing a cost function involves rather subjective judgements. With this understanding, the description below will focus on the MAP estimator as this can be preferred for enabling a computationally efficient estimation implementation.

Given the selection of a MAP estimator, Bayes' theorem gives an expression of the a posteriori density that separates the role of the observed set data elements, Z, and the a priori knowledge of the pdf means of the data elements, given by p_{X}(X) ,as:

$${p}_{X \vert Z} ( X \vert Z ) = \frac{{p}_{z \vert x} ( Z \vert X ) {p}_{x} ( X )}{{p}_{Z} ( Z )} , \qquad ( 15 )$$

where p_{z|x}(Z|X) is the pdf for the data element measurement values given the data element pdf means, X, and p_{X}(X) is the a priori knowledge of the data element pdf means being estimated. Taking logarithms and then applying the gradient operator, and recognizing that p_{z}(Z) does not depend on X, results in a MAP estimation of data element pdf mean being the solution to the MAP expression:

∇_{X}ln P_{Z|X}(Z|X)|_{X=\hat{x}}_{_{MAP}}+∇_{X i ln p}ₓ(X) |_{X=\hat{x}}_{_{MAP}}−0. (16)

This MAP expression operates to determine estimated data element pdf means, \hat{x}_{MAP}, that are at the peak of an assumed distribution form for the data element pdfs, given an assumed distribution form for the data element pdf means across the data set. Thus, in accordance with the invention, this MAP expression is solved for a given set of data element values to produce a pdf mean estimate for each element in the data set. The so-produced pdf mean estimate can then be employed for normalization of the data element values or for other processing purposes.

Indeed, it is recognized in accordance with the invention that the pdf mean estimates of a data set's elements can be employed for a wide range of alternative processes. For example, ultrasound data possesses “speckle,” which is characterized as regions of the ultrasound image data where acoustic energy focuses to produce sharp spikes that contaminate the ultrasound image. In accordance with the invention, such speckle locations can be identified by dividing the ultrasound image data by estimated pdf means produced for the data in accordance with the invention. At each identified speckle location, the original data can then be replaced by the pdf mean estimate for that location to remove the speckle areas in the image. This is but one example of many applications in which the pdf mean estimates produced by the invention can be employed for processes other than normalization.

In solving the MAP pdf mean estimation expression (11) above in accordance with the invention, there is required a defined function for the assumed data element distribution form, p_{z|x}(Z|X), and a defined function for the assumed distribution form, pₓ(X),. of statistical means across the data set. In this initial discussion of the defined functions, a one-dimensional application of the MAP expressions will be assumed for clarity. The extension of the functions to further dimensions will be discussed below.

The assumed data element pdf function, hereinafter referred to as the measurement model, is preferably selected to reflect characteristics of the elements of a given data set and to reflect a possibility of a range of values for a data element. For example, in selecting a measurement model for pixel elements of an image, the distribution of pixel values in a localized region can be evaluated to gain insight into a likely distribution of possible values for any one pixel element. In general, a histogram or other suitable evaluation technique can be employed to analyze data element ranges.

With knowledge of data element characteristics, the measurement model is then preferably selected to reflect the range of possible values that a data element could take on. An exponential distribution, chi-squared distribution, gaussian distribution, or other selected distribution can be employed for the measurement model. For many applications, it can be preferred to employ a gaussian measurement model distribution; a gaussian distribution is in general a good description for a wide variety of processes and the distribution of those process's parameters.

In one preferable method provided by the invention, a gaussian measurement model distribution function form is employed, modeling the possible values of a data element as a collection of gaussian random variables. It can be particularly preferred to employ a gaussian expression that is modified to account for the possibility that a data element value could be significantly different than the unknown mean of that element's pdf. Given a data set having a number, K, of data elements, then a gaussian measurement model for the k^{th} data element in the set can be defined, with data values for that element defined to range between zero and a maximum, represented as Δσₖ. The gaussian distribution for the data element is thus given as having a mean, xₖ, which is unknown, and a corresponding variance, σₖ. The probability that the data known element value significantly departs from the distribution, i.e., falls more than about 3σₖ from the distribution mean, is represented as P_{S}. The gaussian measurement model for the k^{th} data element is then given as:

$${p}_{{Z}_{k} \vert x} ( {Z}_{k} \vert X ) = ( 1 - {P}_{s} ) \frac{{ⅇ}^{- {( {Z}_{k} - {X}_{k} )}^{2} \text{/} 2 {σ}_{k}^{2}}}{\sqrt{2 {πσ}_{k}^{2}}} + \frac{{P}_{s}}{Δ {σ}_{k}} . \qquad ( 17 )$$

The first term of this expression accounts for the probability that the known data element value, zₖ, is relatively close in the distribution of that element's pdf to the unknown mean, xₖ, of the distribution. The second term of the expression accounts for the probability that the known data element value, zₖ, is somewhere in the range of 0 to Δσₖ and may not necessarily fall close to the unknown distribution mean.

This measurement model expression can be extended to describe the pdf distribution form for each element in an entire set of data elements. Here joint probability distributions, Z and X, are employed for the K data set elements giving:

$${p}_{z \vert x} ( Z \vert X ) = {\prod }_{k = 0}^{K - 1} [ ( 1 - {P}_{s} ) \frac{{ⅇ}^{- {( {Z}_{k} - {X}_{k} )}^{2} \text{/} 2 {σ}_{k}^{2}}}{\sqrt{2 {πσ}_{k}^{2}}} + \frac{{P}_{s}}{Δ {σ}_{k}} ] . \qquad ( 18 )$$

Turning now to a model for the form of distribution of data element pdf means across a data set, it can be preferred for many applications to employ a Markov Random Field (MRF) model. Such can take many forms, but as a practical matter, a gaussian form can be preferred to minimize the computational burden.

As explained above, the pdf mean estimation method of the invention overcomes many limitations of prior conventional mean estimation techniques by requiring that the data element pdf means change across a data set in a locally smooth manner, but while accommodating the possibility of discontinuities in the estimated pdf means of the data set. In one example that enables this accommodation, a discrete-space MRF is employed, assuming only nearest neighbor interactions to impose local smoothness, and incorporating a probability of the existence of a discontinuity in pdf means, P_{d}, along with the extent, Δₓαₖ, of the pdf mean discontinuity across the data set. The mean model is then given as:

$${p}_{x} ( X ) = {\prod }_{k = 0}^{K - 2} [ ( 1 - {P}_{d} ) \frac{{ⅇ}^{- {( {X}_{k + 1} - {X}_{k} )}^{2} \text{/} 2 {σ}_{k}^{2}}}{\sqrt{2 {πα}_{k}^{2}}} + \frac{{P}_{d}}{{Δ}_{x} {α}_{k}} ] . \qquad ( 19 )$$

In the expression above, the parameter αₖ is defined as:

αₖ²=σₖ²/F, (20)

where F is a user-adjusted parameter provided to enable control of the degree of “smoothness” in variation of the estimated data element pdf mean to be accommodated from element to element in a data set. The first term of the expression accounts for an expected gaussian behavior and relatively local smoothness in the pdf mean distribution. The second term accounts for the probability of a discontinuity the estimated data element pdf means. Larger values for the smoothness parameter, F, set larger degrees of smoothness, i.e., less variation in pdf mean estimate accepted from element to element. Smaller values for the smoothness parameter set smaller degrees of smoothness, i.e., more variation in pdf mean estimate accepted from element to element.

The smoothness parameter, F, also functions like the passband limit of a data filter; the values of data elements that form a feature of small extent are ignored while those that form a large feature are considered. More specifically, for neighborhoods of elements extending over a number of elements that is large compared to the value of F, the values of those elements are fully considered in estimating the pdf means for the data set. For neighborhoods of elements extending over a number of elements that is small compared to the valued of F, the values of those elements are not considered in estimating the pdf means for the data set. As a result, features of small extent are “passed” and features of large extent are filtered out by a normalization of the data set by the estimated pdf means, thereby accommodating a degree of discontinuity in normalization of the data set. The considerations for and influence of selection of the smoothness parameter will be described in more detail below.

It can be noted that the above mean model is not well defined. If the unknown pdf means, X, have infinite support, that is, are defined upon the entire real axis, then the addition of the constant implies that the integral of the pdf diverges and hence, is not a pdf. But because as a practical matter the data element values are for most applications obtained as sampled data, where the dynamic range of a sampling analog-to-digital sampling converter sets a natural cut-off to the sampling integration, then the pdf is guaranteed to remain finite. As a result, the pdf model and its use in solutions of MAP equations do not depend on an assumed support of the pdf means.

With selected measurement and mean models, the MAP expression (16) described above can be evaluated for an entire data set to estimate pdf means corresponding to the values of data elements in the set. The solution to the MAP expression for an entire data set of elements is for many applications most preferably obtained by setting up a system of matrix MAP expressions for the set of data elements.

The system of MAP expressions is obtained in the following manner. For convenience and clarity, the probability, Pₛ, of a data element value being significantly different than the statistical mean of that element's distribution, and the probability, P_{d}, of a discontinuity in the underlying pdf means are given the following notations:

$$\begin{matrix}{[ {P}_{s} ]}_{k} ≡ [ ( 1 - {P}_{s} ) \frac{{ⅇ}^{- {( {z}_{k} - {x}_{k} )}^{2} \text{/} 2 {σ}_{k}^{2}}}{\sqrt{2 {πσ}_{k}^{2}}} + \frac{{P}_{s}}{Δ {σ}_{k}} ] , & ( 21 ) \\ {[ {P}_{d} ]}_{k} ≡ [ ( 1 - {P}_{d} ) \frac{{ⅇ}^{- {( {x}_{k + 1} - {x}_{k} )}^{2} \text{/} 2 {α}_{k}^{2}}}{\sqrt{2 {πα}_{k}^{2}}} + \frac{{P}_{d}}{{Δ}_{x} {α}_{k}} ] . & ( 22 )\end{matrix}$$

In setting up the system of expressions to be evaluated, it is desirable to treat the end, or boundary, elements of the data set separately. Given that the data set includes a number, K, of data elements, then an index, m, is hereinafter employed to indicate the index of data element, whereby m=0 to K-1. This enables definition of three data element groups, namely, the m=0 data element, data elements having indices where 0<m<K-1, and the K-1 data element.

Now, in general, using the first notation of expression (22) above, the gradient term of the MAP expression (16) above,

$$\frac{\partial }{\partial {x}_{m}} ln {p}_{z \vert x} ( Z \vert X ) ,$$

can be given

as:

$$\frac{\partial }{\partial {x}_{m}} ln {p}_{z \vert x} ( Z \vert X ) = \frac{( 1 - {P}_{s} )}{{[ {P}_{s} ]}_{m}} \frac{{ⅇ}^{- {( {z}_{m} - {x}_{m} )}^{2} \text{/} 2 {σ}_{m}^{2}}}{\sqrt{2 {πσ}_{m}^{2}}} \frac{1}{{σ}_{m}^{2}} ( {z}_{m} - {x}_{m} ) . \qquad ( 23 )$$

This derivative expression can be analyzed separately for the m=0, 0<m<K-1, and m=K-1 groups of data elements. The gradient term for the m=0 data element is then given as:

$$\frac{\partial }{\partial {x}_{0}} ln {p}_{x} ( X ) = \frac{( 1 - {P}_{d} )}{{( [ {P}_{d} ] )}_{0}} \frac{{ⅇ}^{- {( {x}_{1} - {x}_{0} )}^{2} \text{/} 2 {α}_{0}^{2}}}{\sqrt{2 {πα}_{0}^{2}}} \frac{1}{{α}_{0}^{2}} ( {x}_{1} - {x}_{0} ) . \qquad ( 24 )$$

The gradient term for the other boundary element, m=K-1, is given as:

$$\begin{matrix}\frac{\partial }{\partial {x}_{K - 1}} ln {p}_{x} ( X ) = - \frac{( 1 - {P}_{d}}{{[ {P}_{d} ]}_{K - 2}} \frac{{ⅇ}^{- {( {x}_{K - 1} - {x}_{K - 2} )}^{2} \text{/} 2 {α}_{K - 2}^{2}}}{\sqrt{2 {πα}_{K - 2}^{2}}} \\ \frac{1}{{α}_{K - 2}^{2}} ( {x}_{K - 1} - {x}_{K - 2} ) .\end{matrix} \qquad ( 25 )$$

The gradient term for the more general case, for data elements where 0<m<K-1, is given as:

$$\begin{matrix}\frac{\partial }{\partial {x}_{m}} ln {p}_{x } ( X ) = \frac{( 1 - {P}_{d} )}{{( [ {P}_{d} ] )}_{k}} \frac{{e}^{- {( {x}_{k + 1} - {x}_{k} )}^{2} \text{/} 2 {α}_{k}^{2}}}{\sqrt{2 {πα}_{k}^{2}}} \frac{1}{{α}_{k}^{2}} ( {x}_{k + 1} - {x}_{k} ) & \begin{matrix}( 26 ) \\ \end{matrix} \\ [ {δ}_{m , k} - {δ}_{m , k + 1} ] , & \\ = \frac{( 1 - {P}_{d} )}{{( [ {P}_{d} ] )}_{m}} \frac{{e}^{- {( {x}_{m + 1} - {x}_{m} )}^{2} \text{/} 2 {α}_{m}^{2}}}{\sqrt{2 {πα}_{m}^{2}}} \frac{1}{{α}_{m}^{2}} ( {x}_{m + 1} - {x}_{m} ) ) - & \begin{matrix}( 27 ) \\ \end{matrix} \\ \frac{( 1 - {P}_{d} )}{{( [ {P}_{d} ] )}_{m - 1}} \frac{{ⅇ}^{- {( {x}_{m} - {x}_{m - 1} )}^{2} \text{/} 2 {α}_{m - 1}^{2}}}{\sqrt{2 {πα}_{m - 1}^{2}}} & \\ \frac{1}{{α}_{m - 1}^{2}} ( {x}_{m} - {x}_{m - 1} ) . & \end{matrix}$$

To complete the MAP system of equations, the following expression is defined:

$$\begin{matrix}\overline{w} ( α , β , γ , P , Δ ) = \frac{\frac{( 1 - P ) {ⅇ}^{- {( α - β )}^{2} γ \text{/} 2 {β}^{2}}}{\sqrt{2 {πβ}^{2} \text{/} γ}}}{\frac{( 1 - P ) {ⅇ}^{- {( α - β )}^{2} γ \text{/} 2 {β}^{2}}}{\sqrt{2 {πβ}^{2} \text{/} γ}} + \frac{P \sqrt{γ}}{Δ β}} \\ = \frac{{ⅇ}^{- {( α - β )}^{2} γ \text{/} 2 {β}^{2}}}{{ⅇ}^{- {( α - β )}^{2} γ \text{/} 2 {β}^{2}} + \frac{P \sqrt{2 π}}{1 - P Δ}} .\end{matrix} \qquad ( 28 )$$

With these expressions, the system of MAP equations for making pdf mean estimates for an entire set of data elements is achieved. For the data element index m=0:

$$[ \overline{w} ( {z}_{0} , {x}_{0} , N , {P}_{s} , Δ ) \frac{1}{{σ}_{0}^{2}} + \overline{w} ( {x}_{1} , {x}_{0} , NF , {P}_{d} , Δ ) \frac{1}{{α}_{0}^{2}} ] {x}_{0} - \overline{w} ( {x}_{1} , {x}_{0} , NF , {P}_{d} , {Δ}_{x} ) \frac{1}{{α}_{0}^{2}} {x}_{1} = \overline{w} ( {z}_{0} , {x}_{0} , N , {P}_{s} , Δ ) \frac{1}{{σ}_{0}^{2}} {z}_{0} . \qquad ( 29 )$$

For the middle data elements, with indices 0<m<K-1:

$$[ \overline{w} ( {z}_{m} , {x}_{m} , N , {P}_{s} , Δ ) \frac{1}{{σ}_{m}^{2}} + \overline{w} ( {x}_{m + 1} , {x}_{0} , NF , {P}_{d} , {Δ}_{x} ) \frac{1}{{α}_{m}^{2}} + \overline{w} ( {x}_{m} , {x}_{m - 1} , NF , {P}_{d} , {Δ}_{x} ) \frac{1}{{α}_{m - 1}^{2}} ] {x}_{m} - \overline{w} ( {x}_{m + 1} , {x}_{m} , NF , {P}_{d} , {Δ}_{x} ) \frac{1}{{α}_{m}^{2}} {x}_{m + 1} - \overline{w} ( {x}_{m} , {x}_{m - 1} , NF , {P}_{d} , {Δ}_{x} ) \frac{1}{{α}_{m - 1}^{2}} {x}_{m - 1} = \overline{w} ( {z}_{m} , {x}_{m} , N , {P}_{s} , Δ ) \frac{1}{{σ}_{m}^{2}} {z}_{m} . \qquad ( 30 )$$

For the other end data element, with index m=K-1:

$$[ \overline{w} ( {z}_{K - 1} , {x}_{K - 1} , N , {P}_{s} , Δ ) \frac{1}{{σ}_{K - 1}^{2}} + \overline{w} ( {x}_{K - 1} , {x}_{K - 2} , NF , {P}_{d} , {Δ}_{x} ) \frac{1}{{α}_{K - 2}^{2}} ] {x}_{K - 1} - \overline{w} ( {x}_{K - 1} , {x}_{K - 2} , NF , {P}_{d} , {Δ}_{x} ) \frac{1}{{α}_{K - 2}^{2}} {x}_{K - 2} = \overline{w} ( {z}_{K - 1} , {x}_{K - 1} , N , {P}_{s} , Δ ) \frac{1}{{σ}_{K - 1}^{2}} {z}_{K - 1} . \qquad ( 31 )$$

This system of expressions can be evaluated as matrix equations that enable pdf mean estimation. In order to write a matrix equation that fits onto a page some shorthand definitions are here made for clarity. For the diagonal elements of the matrices, the following coefficients, are defined for the three groups of data element indices:

$$\begin{matrix}{d}_{0} = \overline{w} ( {z}_{0} , {x}_{0} , N , {P}_{s} , Δ ) \frac{1}{{σ}_{0}^{2}} + \overline{w} ( {x}_{1} , {x}_{0} , NF , {P}_{d} , {Δ}_{x} ) \frac{1}{{α}_{0}^{2}} , & ( 32 ) \\ \begin{matrix}{d}_{m} = \overline{w} ( {z}_{m} , {x}_{m} , N , {P}_{s} , Δ ) \frac{1}{{σ}_{m}^{2}} + \overline{w} ( {x}_{m + 1} , {x}_{0} , NF , {P}_{d} , {Δ}_{x} ) \frac{1}{{α}_{m}^{2}} + \\ \overline{w} ( {x}_{m} , {x}_{m - 1} , NF , {P}_{d} , {Δ}_{x} ) \frac{1}{{α}_{m - 1}^{2}} ,\end{matrix} & ( 33 ) \\ 0 < m < K - 1 , & ( 34 ) \\ \begin{matrix}{d}_{K - 1} = \overline{w} ( {z}_{K - 1} , {x}_{K - 1} , N , {P}_{s} , Δ ) \frac{1}{{σ}_{K - 1}^{2}} + \\ \overline{w} ( {x}_{K - 1} , {x}_{K - 2} , NF , {P}_{d} , {Δ}_{x} ) \frac{1}{{α}_{K - 2}^{2}} .\end{matrix} & ( 35 )\end{matrix}$$

Similarly, the off-diagonal matrix coefficients are denoted by eₘ and are given by:

$${e}_{m} = - \overline{w} ( {x}_{m + 1} , {x}_{m} , NF , {P}_{d} , {Δ}_{x} ) \frac{1}{{α}_{m}^{2}} . \qquad ( 36 )$$

Finally, the right-hand side matrix coefficients are denoted by bₘ and are given by:

$${b}_{m} = \overline{w} ( {z}_{m} , {x}_{m} , N , {P}_{s} , Δ ) \frac{1}{{σ}_{m}^{2}} . \qquad ( 37 )$$

With these definitions the system matrices A(Z,X) and B(Z,X) for the MAP expression can be given as:

$$\begin{matrix}A ( Z , X ) = ( \begin{matrix}{d}_{0} & {e}_{0} & 0 & 0 & 0 & 0 \\ {e}_{0} & {d}_{1} & {e}_{1} & 0 & 0 & 0 \\ 0 & {e}_{1} & {d}_{2} & {e}_{2} & ⋮ & ⋮ \\ ⋮ & & & ⋰ & & \\ & & & & {d}_{K - 2} & {e}_{K - 2} \\ & & & & {e}_{K - 2} & {d}_{K - 1}\end{matrix} ) , & ( 38 ) \\ B ( Z , X ) = ( \begin{matrix}{b}_{0} & 0 & 0 & 0 & ⋯ \\ 0 & {b}_{1} & 0 & 0 & ⋯ \\ 0 & 0 & {b}_{2} & 0 & ⋯ \\ ⋮ & & & & ⋯ \\ 0 & 0 & 0 & ⋯ & {b}_{K - 1}\end{matrix} ) . & ( 39 )\end{matrix}$$

Using these system matrix definitions, the MAP system to be solved is given as:

A(Z,X)X=B(Z,X)Z (40)

This system is highly non-linear, rendering analytical solutions untenable. However, iterative methods are provided by the invention to produce a solution quickly. Before describing such techniques, it is instructive analyze the MAP system expression in terms of an analogous physical model.

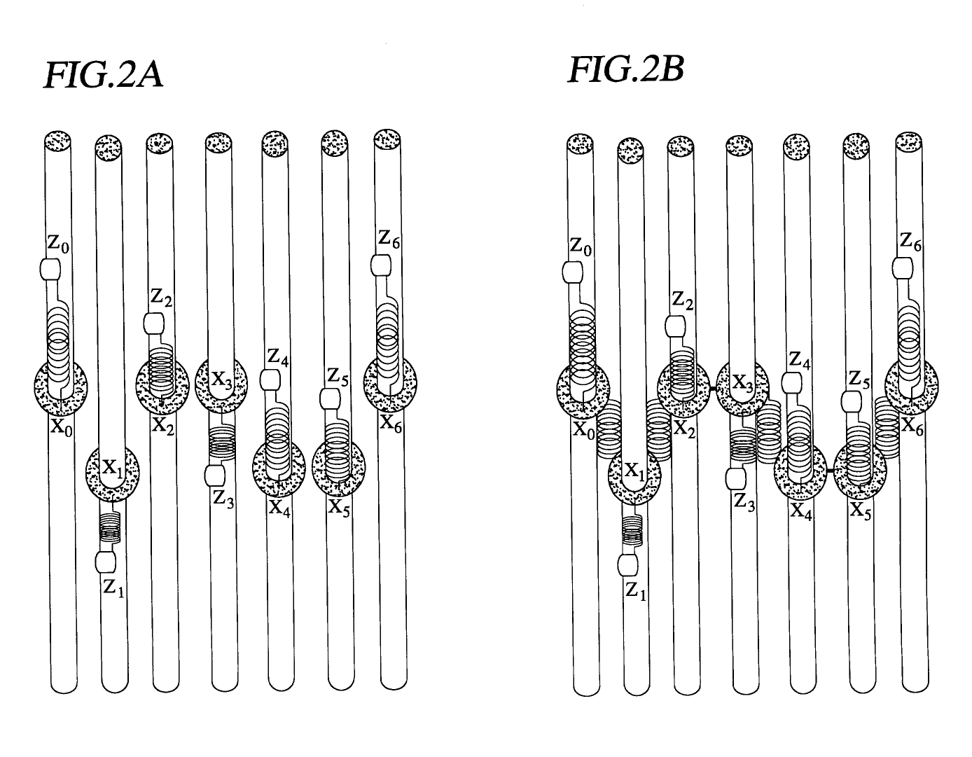

Referring to FIG. 2A, further characteristics and advantages of the MAP system expression can be demonstrated with an analogy to a physical model of a set of coupled springs. The foundation of the model is a set of cylinders, with cylinders m=0 to K-1, having movable sleeves or washers on the cylinders that are connected by “magic” springs to pegs in the cylinders. The springs are “magic” in that their natural length when unstretched is zero. The pegs are placed at locations along the cylinders having location values denoted as zₘ, as shown in the figure. The locations of the washers connected by springs to the peg locations are given as the values xₘ.

The potential energy, V(x,z), of this system can be given as:

$$V ( x , z ) = {\sum }_{m = 0}^{K - 1} \frac{1}{2} \frac{1}{{σ}_{m}^{2}} {( {z}_{m} - {x}_{m} )}^{2} , \qquad ( 41 )$$

where the spring constant is given as 1/σ². If the kinetic energy terms are ignored and if there is a little bit of friction in the system, then asymptotically the system will find its state of lowest energy. To correspondingly minimize the potential energy term of the system expression, partial derivatives are taken and the result is equated to zero. The solution, xₘ=zₘ, ∀m, is not a very interesting system.

Referring then to FIG. 2B, to make the model more interesting, a second set of springs is included, connecting the washers to their nearest neighbor washers, as shown in the figure. These additional springs are defined by a spring constant of F/σ². Here the parameter F is equivalent to the smoothness parameter of the MAP expressions of the invention. Thus the total potential energy of the system, V(x,z) is given here as:

$$V ( x , z ) = {\sum }_{m = 0}^{K - 1} \frac{1}{2} \frac{1}{{σ}_{m}^{2}} {( {z}_{m} - {x}_{m} )}^{2} + {\sum }_{m = 0}^{K - 2} \frac{1}{2} \frac{F}{{σ}_{m}^{2}} {( {x}_{m + 1} - {x}_{m} )}^{2} . \qquad ( 42 )$$

Taking a partial derivative with respect to the xₘ gives rise to a nontrivial system of equations which, when multiplied through by σ², provide the following matrix system:

$$( \begin{matrix}1 + F & - F & 0 & 0 & 0 & 0 \\ - F & 1 + 2 F & - F & 0 & 0 & 0 \\ 0 & - F & 1 + 2 F & - F & ⋮ & ⋮ \\ ⋮ & & & ⋰ & & \\ & & & & 1 + 2 F & - F \\ & & & & - F & 1 + F\end{matrix} ) ( \begin{matrix}{x}_{0} \\ {x}_{1} \\ {x}_{2} \\ ⋮ \\ {x}_{K - 2} \\ {x}_{K - 1}\end{matrix} ) = ( \begin{matrix}{z}_{0} \\ {z}_{1} \\ {z}_{2} \\ ⋮ \\ {z}_{K - 2} \\ {z}_{K - 1}\end{matrix} ) \qquad ( 43 )$$

Because the system matrix is nonsingular and is not a function of x or z, a unique solution to the system exists. For a given realization of peg locations, zₘ, the system will relax to a state where all the springs are stretched as little as possible. Depending on how strong the nearest neighbor parameter F is, the washers will either try to follow the pegs, for small F, or will try to minimize inter-neighbor deflections, for very large F. In between these two extreme conditions, the washers will move to some compromise position to minimize the potential energy of the system, V( x, z). In the limit of an infinite value for the smoothness parameter, F, the xₘ washer locations will all be equal to the same value, which is the average of the zₘ value.

Considering some examples of this behavior, FIG. 3 is a plot showing as circles the peg location values, zₘ, each of which is a block average by eight of exponentially distributed random variables. The various plotted lines show the solution to the system matrix above, as the lowest potential energy configurations, for the estimated washer location values, xₘ, for various values of the smoothness parameter F. For F=0.1, corresponding to very little smoothing, the washer values follow the peg values very closely. For F=1, the washer values smooth out the peg values somewhat and don't follow as closely. For F=100, which nearly qualifies as an infinite value, the washer values almost approach an average of the peg values. These results follow one's intuition as to what a smoothness factor should imply.

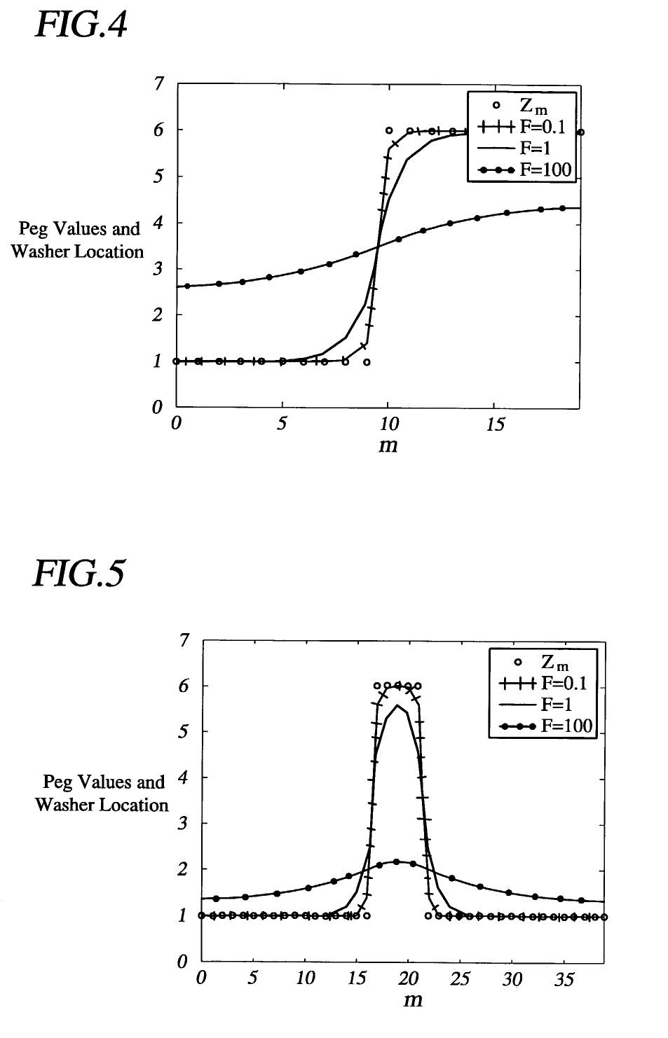

As another example, consider the system response to a step discontinuity in input as shown in the plot of FIG. 4. Here the peg location values, zₘ, include a discontinuity in peg location at cylinder number 9. With this input, a small smoothing function, e.g., a value of F=0.1, causes the system, in settling to the lowest energy configuration, to follow the discontinuity closely, while a very large smoothing function, e.g., a value of F=100, results in only gradual following of the step discontinuity.

In a further example, consider the system response to a “top hat” function of input data as shown in the plot of FIG. 5. Here the peg location values, zₘ, exhibit two discontinuities in value. Note how in coming to the lowest energy configuration, a large smoothness value F=100 causes the system output to not follow the data. In the mean pdf estimation technique of the invention, this corresponds to an estimation of data element pdf means that would be close to the unknown pdf means; normalization of the data element values by such estimated pdf means thus would “pass” the top hat discontinuity data values even though those values significantly depart from the mean. In contrast, a small smoothness value, F=0.1, results in a close following of the data by the output. In this scenario, the top hat discontinuity data values would result in pdf mean estimates that, when employed to normalize the data, would filter out the top hat discontinuity data. This exemplifies how the smoothness parameter,F, can be adjusted to function as a bandpass filter coefficient that selectively retains or eliminates particular data characteristics.

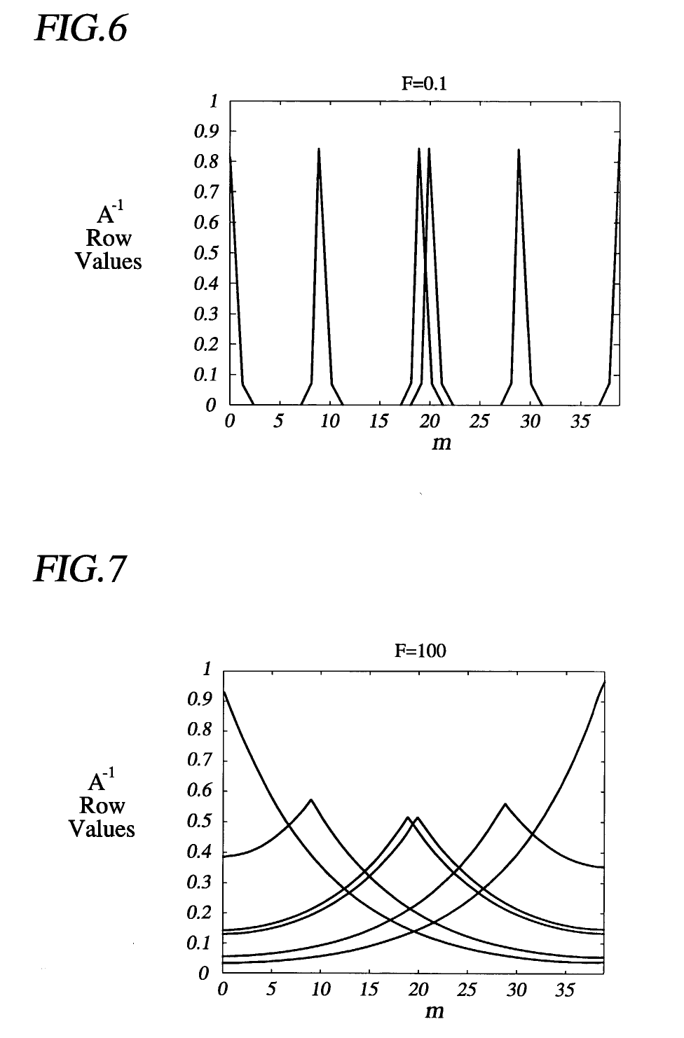

As a final example in analysis of the physical model described above, the system matrix of expression (43) above is inverted and plots made of the rows of the inverse. The rows of the inverse matrix are the coefficients which multiply the zₘ values to produce the washer location estimate values, xₘ. In FIG. 6 there are shown plots of the coefficients for rows 1, 10, 20, 21, 30, and 40 of the inverse of the system matrix, all for a scenario in which the smoothness factor, F, set at 0.1. Note for this small smoothness factor how narrow the coefficient plots are; they essentially operate as two-sided exponential filters that average the value of a given peg location value, zₘ, with only that of its two nearest neighbor cylinders. Thus, the estimates for the washer location, xₘ, Will for this scenario very closely follow the peg location data zₘ as in the previous examples.

FIG. 7 is a plot for row coefficients like that of FIG. 6, here for a smoothness factor, F, set with a value of 100. The exponential filters resulting from the coefficients are here extremely wide; in fact, the width of the filters at the 3 dB points, in say, an index of data elements, is found to be about the square root of F. Accordingly, in FIG. 7 the filters are approximately 10 elements wide at the 3 dB points in accordance with the square root of 100. These wide filters show why large smoothness values do not follow narrow data discontinuities; they operate to average so much data from outside the local neighborhood of a data value discontinuity that they produce an estimate which does not follow the data.

The examples described above have been specifically directed to a physical system of ideal springs. Of note is the similarity between the exponential of the potential energy function employed in this analysis and the distribution functions described above for the pdf mean estimation technique of the invention. The connection between the two comes from statistical mechanics where the Boltzmann factor, e^{-E}^{ₙ}^{/kT}, gives the probability for a system to be in a state with energy Eₙ. Ignoring the kT component, it is found that the term e^{-V(x,z)} is related to the probability that the system is in a state with potential energy V(x,z). Thus, an operation to minimize the potential energy of the system is equivalent to maximizing the probability that the system is in the given energy state.

Extending this analogy further, consider a system pdf function given as:

$$\begin{matrix}pdf = {\prod }_{m = 0}^{K - 1} [ \frac{{ⅇ}^{- {( {z}_{m} - {x}_{m} )}^{2} \text{/} 2 {σ}_{m}^{2}}}{\sqrt{2 {πσ}_{m}^{2}}} + \frac{{P}_{s}}{{Δσ}_{m}} ] \\ {\prod }_{m = 0}^{K - 2} [ \frac{{ⅇ}^{- {( {x}_{m + 1} - {x}_{m} )}^{2} \text{/} 2 {α}_{m}^{2}}}{\sqrt{2 {πα}_{m}^{2}}} + \frac{{P}_{d}}{{Δ}_{x} {α}_{m}} ] .\end{matrix} \qquad ( 44 )$$

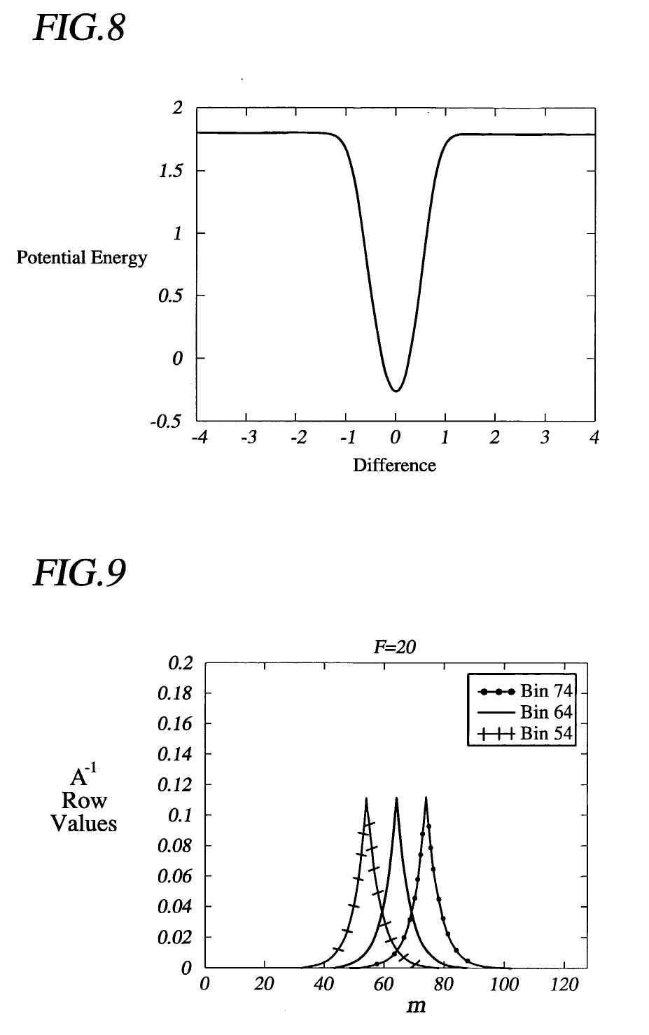

Just as the negative of the natural logarithm of the Boltzmann factor was found to be the energy, or potential, of the ideal spring system described above, the potential for this system pdf can be determined. FIG. 8 is a plot of the potential energy of this system, given a statistical mean of unity, a variance,

$${σ}^{2} = \frac{1}{8} ,$$

a probability of outlying data values, Pₛ=0.5, and Δ=3, allowing for a 3σ departure in a given data element value from its pdf mean. With these characteristics, it is found that this elastic system behaves like a normal harmonic oscillator until it is stretched beyond a certain threshold, at which point it becomes infinitely extensible without a requirement of additional energy. In other words, the system requires a finite energy input to stretch up to some threshold; beyond the threshold, the elastic system can be stretched in any configuration desired without energy input.

This sort of system behavior is exactly what is desired for the pdf mean estimation technique of the invention. The smoothness factor, F, allows for an estimate that demonstrates selected filter characteristics. With such an estimate, second or further, more refined, estimates can then be made, including terms to account for probabilities of discontinuities and outlying data values, P_{d} and P_{s,} with the system manipulated to relax completely to a desired solution estimate. In terms of the physical spring model, narrow band discontinuities in data element values, that is, significant departures from the mean values that are localized to only a few data element values, are retained because the Pₛ probability term allows for a spring that is connected to a peg with a large value of zₘ to be greatly extended without a large energy penalty. Discontinuities in the data set element values and pdf means are accommodated because the P_{d} probability term allows for large extensions between two neighboring washers without a large energy penalty. It is thus found that the spring and washer model just described provides a good analogy for the desirable characteristics of the MAP estimation technique provided by the invention.

Turning then to consider other characteristics of the MAP pdf mean estimation method of the invention, it is found that in the manner just described for the physical spring system, the system matrix of the MAP expressions of the invention behaves as a set of two-sided exponential bandpass filters when inverted, and with the probabilities Pₛ and P_{d} set to zero. This condition is preferably established in the method of the invention during the first pass of two or more iterations of solving the system matrix. Recall that due to the high nonlinearity of the system expressions, the expressions cannot be solved analytically. Thus, for many applications, it can be preferred to iteratively solve the system expressions, with two iterations typically found to be sufficient, but additional iterations acceptable in accordance with the invention.

To set up a first pass at solving the MAP system expressions in accordance with the invention, the probabilities Pₛ and P_{d} are set equal to zero, whereby the \overline{w} function expressions given above are unity. A first pass at solving the MAP system expressions is then carried out with the data element values, Z, used to form the system matrices by letting X=Z; in other words, to enable a first solution to the MAP expressions, the unknown pdf mean values are designated as the data element values themselves. For many applications this is a convenient and efficient technique for providing an initial data value condition that enables a first pass solution of the system expressions. It is recognized, however, that other initial data values can be employed. For example, as mentioned above and explained in detail below, for computational efficiency, it can be preferred for some applications to average several data element values together prior to solution of the MAP expressions. With a selected set of initial data values in place, the system matrices are then solved to produce a first estimate of the data element value pdf means for the data element set.

With this first estimate, second and if desired, further, iterations of processing to solve the MAP system expressions are then carried out; it is preferred that at least a second iteration of processing be carried out. Preferably, beginning with the second iteration, the probabilities Pₛ and P_{d} are set to some nonzero values. For many applications, a reasonable probability figure, e.g., 0.5, can be employed for each. Also, for the second and subsequent iterations, Δₓ=Δ=3, or other reasonable value that preferably imposes a selected range in variance excursion to account for up to a 3σ excursion in data element values. In the second iteration, the data element pdf mean estimates produced by the first iteration are now designated as the unknown pdf mean values for the data elements. With these designated values, the system matrices are then again solved. It is found that for most applications, no more than two iterations of solving the MAP expression system are required to produce very good pdf mean estimates. But it is recognized in accordance with the invention that three or more iterations can be carried out if desired for a particular application or as a technique for accommodating particular data characteristics.

To illustrate the characteristics of first and second iterations of solving the MAP system expressions, it is instructive to manipulate the matrix expression (40) above by dividing each row of matrix A by the diagonal value of matrix B. Note that this manipulation is not carried out in practice to solve the system matrix; this manipulation is carried out here only so that the matrix can be inverted and its rows examined for further description of the system characteristics. With this inversion, the matrix expression (40) above is given as:

[B⁻¹(Z, X)A(Z, X)]Z=Z (45)

With the probabilities P_{d} and Pₛ set to zero, this results in a system matrix as:

$$( \begin{matrix}1 + F & - F & 0 & 0 & 0 & 0 \\ - F \frac{{x}_{1}^{2}}{{x}_{0}^{2}} & 1 + F + F \frac{{x}_{1}^{2}}{{x}_{0}^{2}} & - F & 0 & 0 & 0 \\ 0 & - F \frac{{x}_{2}^{2}}{{x}_{1}^{2}} & 1 + F + F \frac{{x}_{2}^{2}}{{x}_{1}^{2}} & - F & ⋮ & ⋮ \\ ⋮ & & & ⋰ & & \\ & & & & 1 + F + F \frac{{x}_{K - 2}^{2}}{{x}_{K - 3}^{2}} & - F \\ & & & & - F \frac{{x}_{K - 1}^{2}}{{x}_{K - 2}^{2}} & 1 + F \frac{{x}_{K - 1}^{2}}{{x}_{K - 2}^{2}}\end{matrix} ) ( \begin{matrix}{x}_{0} \\ {x}_{1} \\ {x}_{2} \\ ⋮ \\ {x}_{K - 2} \\ {x}_{K - 1}\end{matrix} ) = ( \begin{matrix}{z}_{0} \\ {z}_{1} \\ {z}_{2} \\ ⋮ \\ {z}_{K - 2} \\ {z}_{K - 1}\end{matrix} ) \qquad ( 46 )$$

This system is very similar to that of the physical spring model discussed above, with the inclusion of the factors

$$\frac{{x}_{1}^{2}}{{x}_{0}^{2}} , \frac{{x}_{2}^{2}}{{x}_{1}^{2}} , … , \frac{{x}_{K - 1}^{2}}{{x}_{K - 2}^{2}}$$

on the lower off-diagonal elements and along the diagonal. For purely random data element value input, the system results would, in the mean, be similar to those given for the physical model as described above. But for data element values exhibiting one or more step discontinuities these factors enhance or reduce the coupling between adjacent terms, depending on the selected value of the smoothing parameter, F, and the degree and extent of each discontinuity.

As an example suppose that the set of data element values, Z, and the set of true data element pdf mean values, X, are set to unity in the system matrix expressions, and the above system is inverted. FIG. 9 is a plot of the resulting matrix coefficients for a first iteration solution, i.e., the probabilities P_{d} and Pₛ are set to zero, with a selected smoothness parameter value of F=20, for a data set of 130 data elements; here the results only for data elements 54, 64, and 74 are shown for clarity. The plotted filtering coefficients are the row values of the inverted matrix:

[B⁻¹(Z, X)A(Z, X)]⁻¹ (47)

Note that the system operates to exponentially filter the input data just as described above.

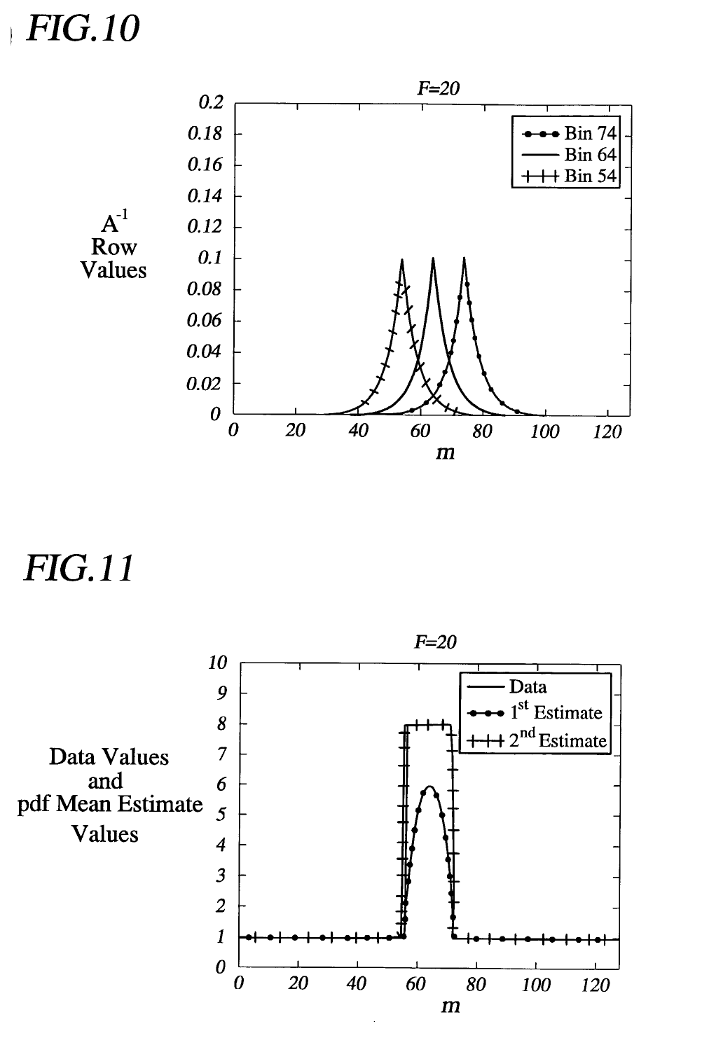

Now imposing values of 0.5 for the probabilities P_{d} and Pₛ, specifying the smoothness parameter value of F=20, and designating the pdf mean estimates that resulted from this first solution iteration as the unknown pdf mean values, a second iteration solution produces the filtering coefficients shown in the plot of FIG. 10 for the data elements 54, 64, and 74.

A more interesting result is obtained when a “top hat” discontinuity in data element values is specified. FIG. 11 is a plot of an example set of data element values exhibiting such a discontinuity, here extending from data element 55 to data element 75, along with plots of the data element pdf means estimated by a first iteration solution and a second iteration solution. Here it can be seen that the first iteration solution produces a reasonably close pdf mean estimate and that the second iteration solution converges substantially to the data. It can be seen that the final pdf mean estimate for data element 56 does not converge with that data element's value. If this characteristic, which does not commonly occur, is unacceptable for a given application, a “symmetric” mean model can be employed. Such a model would treat the set of data elements symmetrically about successive differences in data element index. This ensures identical system behavior at both sides of a discontinuity such as the “top hat” discontinuity, but at a cost of introducing more terms into the system matrix, and therefore may not preferred for all applications.

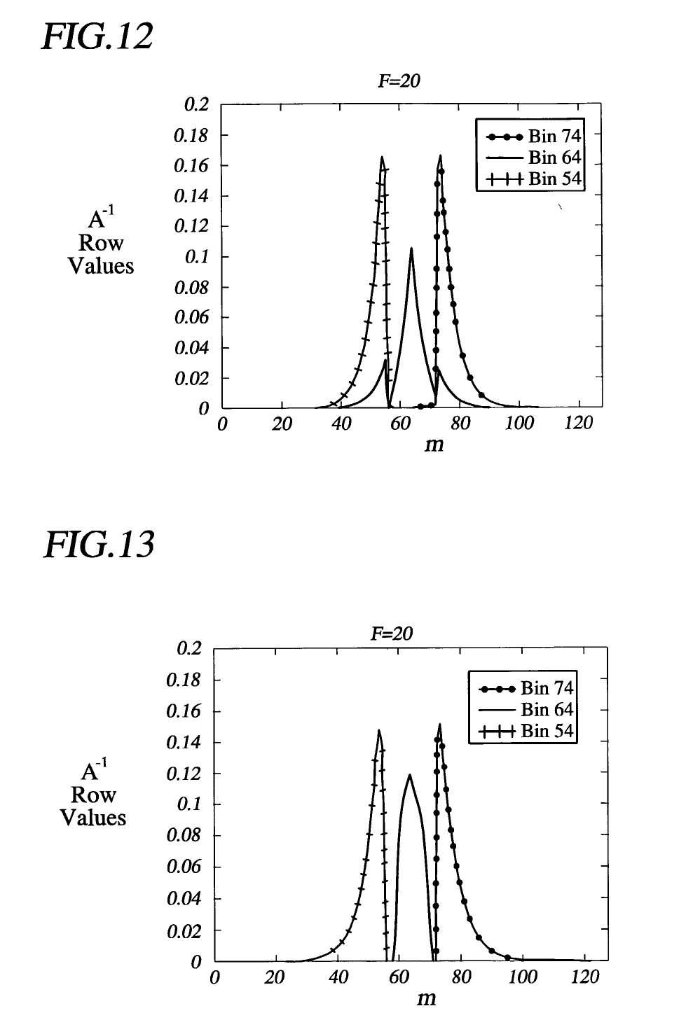

For the “top hat” data discontinuity plotted in FIG. 11, FIGS. 12 and 13 provide plots of the system filter responses produced by the first iteration solution and the second iteration solution, respectively. Note in FIG. 12 how the presence of the data ratio functions in the system matrix cause the filter responses to “cut-off in the presence of the tophat data. This is due to the degree of adaptivity provided in the first iteration solution by setting to zero the probabilities, P_{d} and Pₛ This adaptivity is further enhanced during the second iteration solution, as shown in FIG. 13, where data elements 54 and 74 are shown to be completely desensitized to the ”top hat” discontinuity, while bin 64 is completely desensitized to data outside the “top hat” discontinuity. This illustrates how the two iterations adaptively operate from data element to element, enabling accommodation of discontinuities in the data while maintaining a degree of local smoothness.

As an example of implementation of this adaptability, suppose that a discontinuity in a data element set, e.g., an array of image pixel values, corresponds to the extent in sequential data elements of the “top hat” discontinuity plotted in FIG. 11; note that the discontinuity is about 20 pixels wide. If it is desirable for a given application to “pass” this discontinuity, i.e., to maintain the discontinuity even in a normalized version of the pixel data, then a large smoothness parameter value for F, say F=400, would preferably be selected such that the resulting system filter width would be 20 data elements.

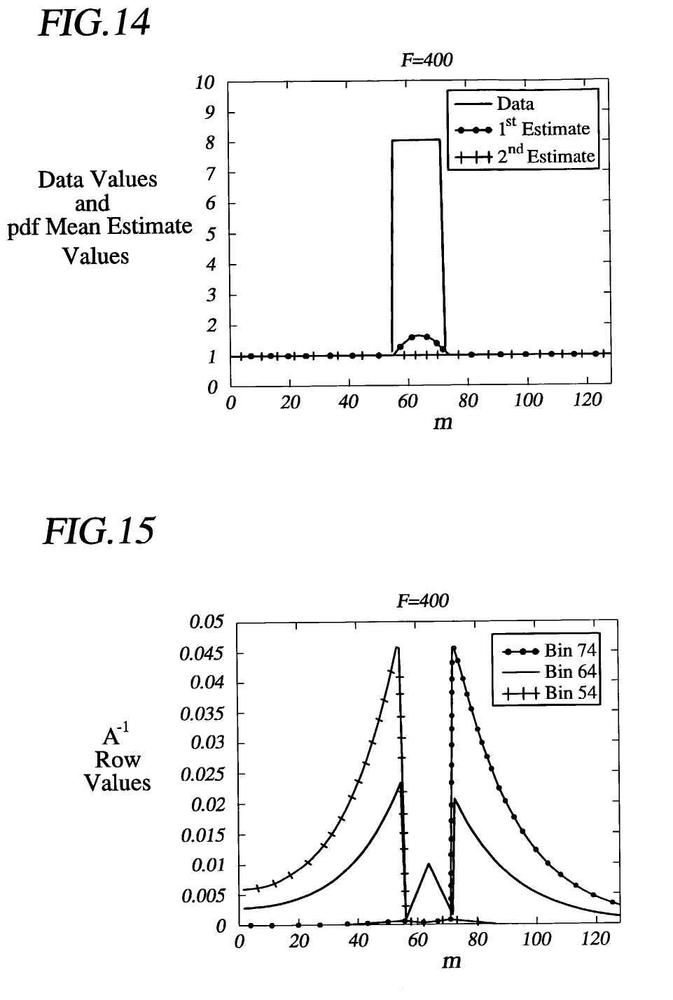

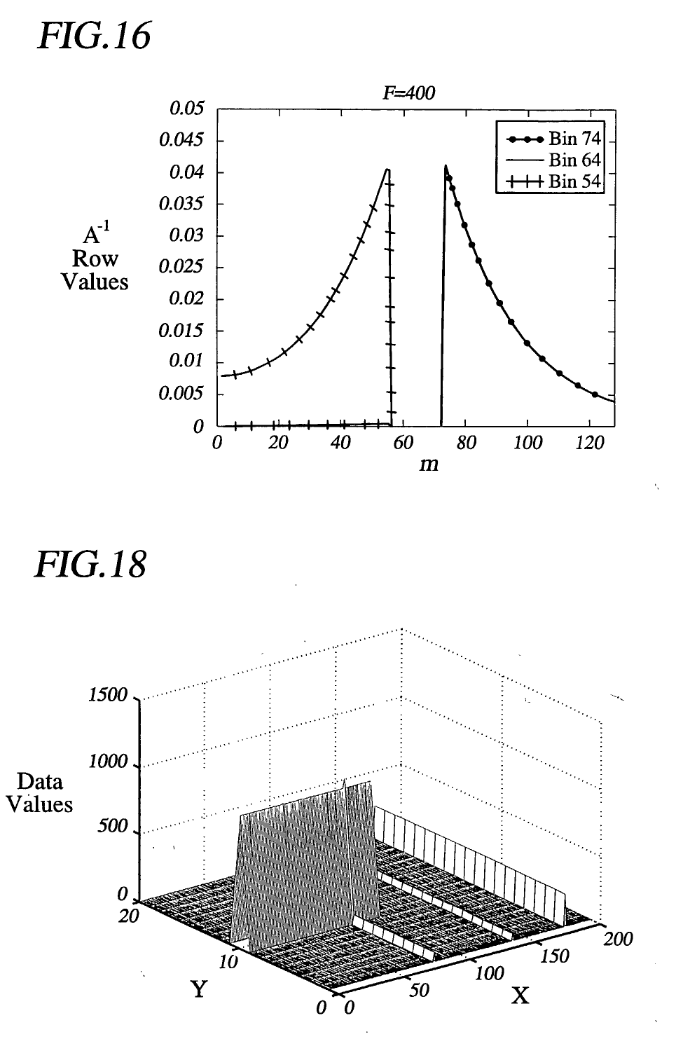

FIGS. 14, 15, and 16 provide plotted data corresponding to this example. Specifically, FIG. 14 provides a plot of the same 20 data element-wide “top hat” data discontinuity of FIG. 13 and the pdf mean estimates produced by two iteration solutions; FIG. 15 provides a plot of the system filter coefficients corresponding to the first iteration solution; and FIG. 16 provides a plot of the system filter coefficients corresponding to the second iteration solution. Note how in this example, even data element 64, right in the middle of the data discontinuity, is desensitized to neighboring discontinuity data, whereby the pdf mean estimate for data element 64 is not artificially biased by the discontinuity.

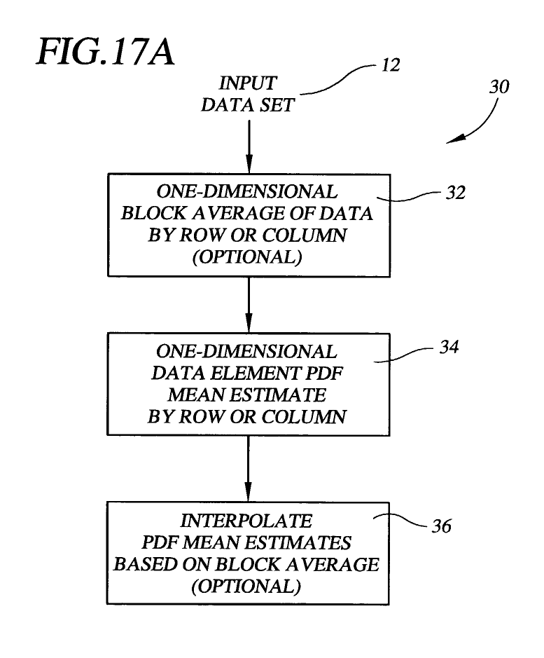

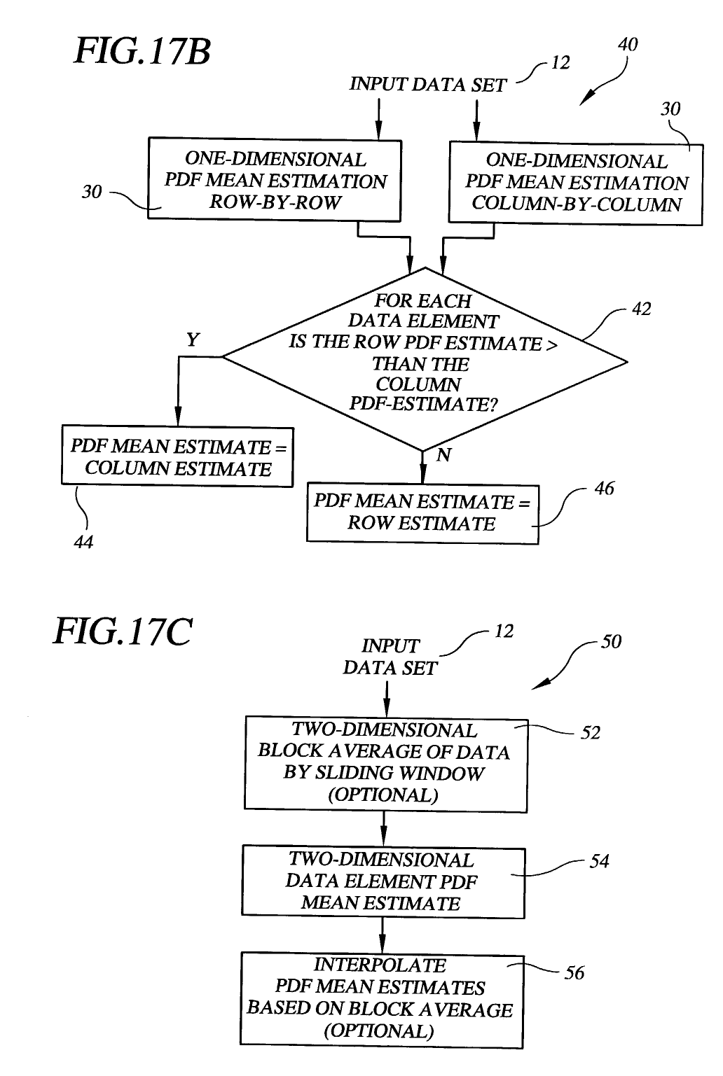

With this discussion, the characteristics of flexibility and adaptability of the MAP pdf mean estimation method of the invention are demonstrated, and the ability of the method to overcome artificial biasing due to large data element values and data discontinuities is proven. In practice, the data element pdf mean estimation method of the invention can be implemented in any of a range of techniques, with a specific implementation preferably selected to address the requirements of a particular application. In a first example implementation, and referring to FIG. 17A, the pdf mean estimation method is carried out as a one-dimensional process 30, that is, a set of data elements under consideration is processed one dimensionally. As mentioned above, the measurement model, mean model, and MAP system expressions presented in the discussion above are all directed to this one-dimensional pdf mean estimation process 30 of the flow chart of FIG. 17A.

In the one-dimensional pdf mean estimation process of the invention, a data set of elements of any dimension is processed in a one-dimensional manner. For example, a two-dimensional array of image data is here processed row by row sequentially, with no provision made for data interaction between rows of data. In other words, here the MAP system expressions model nearest neighbor interactions between data element values only in one dimension. In the expressions above, the identification of a number, K, of data set elements, refers to the number of data set elements in the set when taken altogether as a one-dimensional row, or column, of data, with each data element value interacting only with the previous and next data element value in the row or column.

For many applications, this one-dimensional pdf mean estimation technique can be desirable, particularly where a data set under consideration is indeed one-dimensional in nature, or where processing speed or efficiency is of concern. Referring back to FIG. 17A, the processing efficiency can be further enhanced in a first optional step 32 of block averaging the data element values under consideration. For example, a selected number, say eight, of sequential data element values are here averaged together to produce a representative average value for the sequence.

Block averaging of data element values can be preferred not only because of its reduction in computational requirements, but also to enhance the ability of the MAP system to eliminate unwanted pdf mean biasing as discussed above. Specifically, the averaging of a high data element value with lower sequential values reduces the possible bias of the high data element value on the estimated mean of the sequential values. This then provides a further guard against the artificial biasing of the pdf mean estimates that is typical of conventional techniques. It is to be recognized, however, that block averaging can introduce anomolous values into a normalized data set and therefore must be considered in view of characteristics of the particular data set under consideration.

If a block averaging step is to be carried out, then in the expressions above, the variance, σₖ², of the k^{th} data element's gaussian distribution is given as xₖ²/N, where xₖ is the mean of the distribution and N is the number of data element values that were averaged together.

Once the data is block-averaged, if so desired, then the one-dimensional data element pdf mean estimate process 34 described above is carried out on the data, e.g., row by row or column by column for a two-dimensional array of data. Then, with the estimation process complete, an interpolation process 36 is carried out to map the pdf mean estimates to the original data set size if an initial block averaging step was carried out. The interpolation process can be a simple linear interpolation for most applications, or if desired, a more sophisticated interpolation method such as cubic splines can be employed to prevent the occurrence of anomalies in the interpolated data element set. No particular interpolation technique is required by the invention, and any suitable interpolation method is typically acceptable.

With interpolation complete, the one-dimensional pdf mean set is produced. The plotted data examples described above result from such a one-dimensional process implementation. The thusly produced pdf mean estimates can then be employed, in the manner of the flow chart of FIG. 1, to normalize the data set of elements, or for other selected purpose as described above.

For many applications having data elements that are interrelated in more than one dimension, the one-dimensional pdf mean estimation method can be found lacking in its one-dimensional interaction model. This limitation is addressed by alternative implementations provided by the invention. In a first such implementation, the one-dimensional pdf mean estimation method is carried out in a first dimensional direction and then is carried out in second or more dimensional directions for comparison.

Referring to the flow chart of FIG. 17B, in an implementation of this method 40 specifically for a two-dimensional data set array, the data set array 12 is processed by the one-dimensional pdf mean estimation method 30 given above, row by row as well as column by column. For each of these steps, the array can be processed row by row sequentially or in parallel, and similarly, can be processed column by column sequentially or in parallel. The results of each of the two one-dimensional processing steps are stored, e.g., in electronic memory having a size corresponding to the data set array size, whereby a direct correspondence between each column and row pdf mean estimate can be made.

With the pdf mean estimates thusly stored, in a next process step each pdf mean estimate from the row-by-row one-dimensional processing is compared 42 with the corresponding estimate from the column-by-column one-dimensional processing. A pdf mean estimate for a given data element is then taken to be the smaller of the two pdf mean estimates. This results in a least-of pdf mean estimation for each data element. For each data element, if the row-processed pdf estimate is larger than the column-processed pdf mean estimate, then the column-processed estimate is selected 44. If the row-processed pdf estimate is smaller than the column-processed pdf mean estimate, then the row-processed estimate is alternatively selected 46.

This one-dimensional by one-dimensional implementation enables a comparison of nearest neighbor data element interactions in more than one dimension even though the process is implemented one dimensionally; i.e., by processing the data set as-grouped in different configurations, e.g., processing a two-dimensional data set by columns as well as separately by rows, both dimensions of interaction are accounted for. It is to be recognized that this implementation can be applied to any number of dimensions of a data set, with a one-dimensional process applied to each dimension and a comparison of the results for each dimension then carried out to select a final pdf mean estimation value for each data element in the set. Once a pdf mean estimation value is determined for each data element in the set, the data elements can be normalized by these values, or other process step or steps can be carried out.

In a further example implementation provided by the invention, the MAP system expressions are adapted to account for two-dimensional interaction of data element values. Referring to the flow chart of FIG. 17C, in this two-dimensional pdf mean estimation method implementation 50, an input data set 12 is first optionally block averaged 52, if desired, to reduce computational requirements. The block average here can be carried out by a sliding window approach, e.g., by averaging the values of a two-dimensional rectangular window of data elements and then sliding the selected window to an adjacent rectangle of data elements for computation of that window's average. Alternatively, and preferably for many applications, a one-dimensional block average of data element values only in, e.g., the X-direction, can be employed.

Once the block averaging is complete, if included, then the pdf mean of each data element in the two-dimensional data set is estimated 54 based on a two-dimensional MAP estimation technique provided by the invention. For many two-dimensional data set applications, such as imaging, this two-dimensional MAP estimation method can be preferred. The two-dimensional MAP estimation method accounts for nearest neighbor data element interactions in both of the two dimensions in a single model, whereby particular two-dimensional characteristics of the data set, such as two dimensional discontinuities, are very well represented and accommodated. The one-dimensional by one-dimensional implementation just described cannot provide this accommodation because it does not account for two-dimensional interactions in a single model. Because this two-dimensional pdf estimation method can be preferred for two-dimensional applications, and because of the wide range of such two-dimensional applications, a detailed description of this implementation is provided later in the description, including details of a particular computer-based implementation.

Once the two-dimensional pdf mean estimation step is complete for the data set, then in a final step, the estimated pdf means are interpolated 56 back to the full data set size if an initial block averaging step was carried out. The estimated pdf means for the data set can then be employed for normalizing the data set in the manner of the process of FIG. 1, or employed for other processing operation.

Turning then to the particulars of the two-dimensional pdf mean estimation method of the invention, the expression (11) given above for the MAP estimation method is here employed with mean and measurement models that account for two-dimensional data characteristics. These models account for the two dimensional nature of the data and their interaction. The data element set is assumed to be provided as an array of data elements having a number, M, of elements in a first dimension and a number, N, of elements in a second dimension. For ease of discussion, the first dimension will be taken as the X dimension and the second dimension will be taken as the Y dimension, as would be conventional for, e.g., image data. With this convention, the data element array indexes from m=1 to M in the X direction and indexes from n=1 to N in the Y direction.

Each data element value can then be identified in the array as having a data element value Zₙₘ. and the pdf mean estimate to be determined for a data element is here given as xₙₘ. The variance of the pdf of a data element in the array is given as σₙₘ². If the data is to be initially averaged, or noncoherently integrated, to reduce computational requirements, in the manner described above, then the number of data elements integrated together is designated as L, and the variance, σₙₘ², of each data element is then given by:

$${σ}_{nm}^{2} = \frac{{x}_{nm}^{2}}{L} , \qquad ( 48 )$$

As in the one-dimensional implementation described above, here a measurement model is selected to provide an assumption of what the form of a distribution of possible values for a data element would be. Any of the distribution models described above can be employed, and as explained previously, for many applications a gaussian distribution model can be preferred. The corresponding two-dimensional gaussian distribution is then given as:

$${p}_{G} ( {z}_{nm} \vert {x}_{nm} ) = \frac{{ⅇ}^{- {( {z}_{nm} - {x}_{nm} )}^{2} \text{/} 2 {σ}_{nm}^{2}}}{\sqrt{2 {πσ}_{nm}^{2}}} . \qquad ( 49 )$$

In determining a measurement model, it is preferably assumed that the data element values can occur randomly across the data element array and are uniformly distributed in value between a minimum value of 0 and a maximum value, Δσₙₘ, where A is taken to be, e.g., 3, to allow for up to a 3σ departure in data element value from the underlying pdf mean value. The probability that a data element value is not well within its gaussian pdf distribution is denoted as Pₛ as above. With this nomenclature, then the two-dimensional gaussian distribution of possible data element values is given as:

$$p ( {z}_{nm} \vert {x}_{nm} ) = ( 1 - {P}_{s} ) \frac{{ⅇ}^{- {( {z}_{nm} - {x}_{nm} )}^{2} \text{/} 2 {σ}_{nm}^{2}}}{\sqrt{2 {πσ}_{nm}^{2}}} + \frac{{P}_{s}}{{Δσ}_{nm}} . \qquad ( 50 )$$

This distribution describes data element values, zₙₘ, which for the most part are expected to be close to the means, xₙₘ, of their respective gaussian pdfs, except for a probability, Pₛ, that a data element value zₙₘ may not be close to the mean and could be of any value between 0 and Δσₙₘ.

In expressing the corresponding data element measurement model for the data set array, an assumption is made that the data element values of the data set form a collection of statistically independent random variables. Thus, the joint probability distribution for z=Z, the set of data element values, given x=X, the set of data element pdf means, is given by:

$${p}_{z \vert x} ( Z \vert X ) = {\prod }_{{1 \leq n \leq N}_{1 \leq m \leq M}} [ ( 1 - {P}_{s} ) \frac{{ⅇ}^{- {( {z}_{nm} - {x}_{nm} )}^{2} \text{/} 2 {σ}_{nm}^{2}}}{\sqrt{2 {πσ}_{nm}^{2}}} + \frac{{P}_{s}}{{Δσ}_{nm}} ] . \qquad ( 51 )$$

This is the measurement model for a data set array of data element values, zₙₘ enforcing a distribution as gaussian random variables having unknown pdf means xₙₘ. To simplify the notation of the model, the symbol Πₙₘ is intended to represent an operation of taking the product over all elements of the indices n=1 to N and m=1 to M.

The two-dimensional mean model is also a straightforward extension of the one-dimensional model. As with the one-dimensional case, any suitable distribution function can be employed. A nearest neighbor Markov Random Field distribution function, and in particular a gaussian function, can be preferred for many applications. In the two-dimensional case, the selected pdf mean smoothness from data element to element is specified as two smoothness parameters, a first parameter, Fₓ for smoothness in the X direction of the data set array, and a second parameter, F_{y}, for smoothness in the Y direction of the data set array. Two discontinuity values are also defined here, a first, Δₓ for discontinuities in the X direction of the array and Δ_{y} for discontinuities in the Y direction of the array.

Similarly, the probability of a pdf mean discontinuity across the array is here defined in two dimensions, with a first probability, Pₓ, defined for the X direction of the data set array and a second probability, P_{y}, defined for the Y direction of the data set array.

The two-dimensional mean model provides for a coupling of data elements that are adjacent in the X direction of the data set array, as well as for a coupling of data elements that are adjacent in the Y direction of the data set array. As explained above, this two-dimensional coupling enables the MAP system to account for two-dimensional neighborhoods of data value characteristics. This is accomplished with a mean model definition, pₓ(X) given as:

$$\begin{matrix}{p}_{x} ( X ) = {\prod }_{{1 \leq k \leq N}_{1 \leq l \leq M}} [ ( 1 - {P}_{dx} ) \frac{{ⅇ}^{- {( {x}_{k , l + 1} - {x}_{kl} )}^{2} \text{/} 2 {α}_{kl}^{2}}}{\sqrt{2 {πα}_{kl}^{2}}} + \frac{{P}_{dx}}{{Δ}_{x} {α}_{kl}} ] \\ {\prod }_{{1 \leq k \leq N}_{1 \leq l \leq M}} [ ( 1 - {P}_{dy} ) \frac{{ⅇ}^{- {( {x}_{k + 1 , l} - {x}_{kl} )}^{2} \text{/} 2 {β}_{kl}^{2}}}{\sqrt{2 {πβ}_{kl}^{2}}} + \frac{{P}_{dy}}{{Δ}_{y} {β}_{kl}} ] ,\end{matrix} \qquad ( 52 )$$

where the two parameters αₖₗ² and βₖₗ² are the logical extension of their one dimensional counterpart αₙ², and are here given as:

$$\begin{matrix}{α}_{kl}^{2} = \frac{{σ}_{kl}^{2}}{{F}_{x}} , & ( 53 ) \\ {β}_{kl}^{2} = \frac{{σ}_{kl}^{2}}{{F}_{y}} . & ( 54 )\end{matrix}$$

Note the different upper limits in the two products in expression (52) above. These are the boundary conditions that lead to some terms being absent in special cases, as described in detail below.

With the two-dimensional measurement and mean models defined, the MAP estimation system expression (11) given above can be implemented to estimate the pdf means of data elements in a two-dimensional data element array. To produce the two-dimensional MAP system expressions based on expression (11) above, derivatives must be taken, with respect to xₙₘ of the natural logarithms of the measurement model, p_{z|x}^{(Z|X), and the mean model, P}ₓ(X) . To simplify the notation in this operation, the symbols [Ps]nm, [P_{dx}]ₖₗ, and [P_{dy}]ₖₗ are hereinafter employed to refer to the full bracketed expressions with those indices. The derivative of the log of the measurement model, ln p_{z|x}(Z|X), is then given as:

$$\frac{\partial }{\partial {x}_{nm}} ln {p}_{z \vert x} ( Z \vert X ) = \frac{( 1 - {P}_{s} )}{{[ {P}_{s} ]}_{nm}} \frac{{ⅇ}^{- {( {z}_{nm} - {x}_{nm} )}^{2} \text{/} 2 {σ}_{nm}^{2}}}{\sqrt{2 {πσ}_{nm}^{2}}} \frac{1}{{σ}_{nm}^{2}} ( {z}_{nm} - {x}_{nm} ) . \qquad ( 55 )$$

The derivative of the log of the mean model, In pₓ(X), is given as:

$$\begin{matrix}\frac{\partial }{\partial {x}_{nm}} ln {p}_{x} ( X ) = \frac{( 1 - {P}_{dx} )}{{[ {P}_{dx} ]}_{kl}} \frac{{ⅇ}^{- {( {x}_{k , l + 1} - {x}_{kl} )}^{2} \text{/} 2 {α}_{kl}^{2}}}{\sqrt{2 {πα}_{kl}^{2}}} \frac{1}{{α}_{kl}^{2}} \\ ( {x}_{kl + 1} - {x}_{kl} ) {δ}_{nk} ( {δ}_{ml} - {δ}_{m , l + 1} ) + \\ \frac{( 1 - {P}_{y} )}{{[ {P}_{dy} ]}_{kl}} \frac{{ⅇ}^{- {( {x}_{k + 1. l} - {x}_{kl} )}^{2} \text{/} 2 {β}_{kl}^{2}}}{\sqrt{2 {πβ}_{kl}^{2}}} \frac{1}{{β}_{kl}^{2}} \\ ( {x}_{k + 1 , l} - {x}_{kl} ) {δ}_{ml} ( {δ}_{nk} - {δ}_{n . k + 1} ) .\end{matrix} \qquad ( 57 )$$

This derivative will generate eight terms in the general case. The boundary conditions for data elements at the edges of the array, where the indices are given as n=1, m=1, n=N, and m=M will generate special cases with corresponding terms taken out of this expression in a straightforward extension. In evaluating this derivative, it is useful to define the following function:

$$w ( x , y , LF , P Δ ) = \frac{( 1 - P ) \frac{{ⅇ}^{- {( x - y )}^{2} LF \text{/} 2 {y}^{2}}}{\sqrt{2 π \frac{{y}^{2}}{LF}}}}{( 1 - P ) \frac{{ⅇ}^{- {( x - y )}^{2} LF \text{/} 2 {y}^{2}}}{\sqrt{2 π \frac{{y}^{2}}{LF}}} + \frac{P}{Δ} \frac{\sqrt{LF}}{y}} . \qquad ( 57 )$$

Note that this expression explicitly defines the dependence on the number of block-averaged data elements, L. This function (27) can then allow for the introduction of a shorthand notation given as the following:

w_{σ}(zₙₘ,xₙₘ) for the w function with Pₛ, Δ, and L;

W_{α}(xₙₘ₊₁,xₙₘ) for the w function with P_{dx}, Δₓ, and LFₓ; and

W_{β}(xₙ₊₁ₘ,xₙₘ) for the w function with P_{dy}, Δ_{y}, and LF_{y}.

With this shorthand notation, the derivative of the mean model, pₓ(X), can be expressed as:

$$\begin{matrix}\frac{\partial }{\partial {x}_{nm}} ln {p}_{x} ( X ) = \frac{{w}_{α} ( {x}_{n , m + 1} , {x}_{nm} )}{{α}_{nm}^{2}} ( {x}_{n , m + 1} - {x}_{nm} ) + \\ \frac{{w}_{α} ( {x}_{nm} , {x}_{n , m - 1} )}{{α}_{n , m - 1}^{2}} ( {x}_{n , m - 1} - {x}_{nm} ) + \\ \frac{{w}_{β} ( {x}_{n + 1 , m} , {x}_{nm} )}{{β}_{nm}^{2}} ( {x}_{n + 1 , m} - {x}_{nm} ) + \\ \frac{{w}_{β} ( {x}_{nm} , {x}_{n - 1 , m} )}{{β}_{n - 1 , m}^{2}} ( {x}_{n - 1 , m} - {x}_{nm} ) .\end{matrix} \qquad ( 58 )$$

The following MAP estimation system then is to be solved:

$$\frac{\partial }{\partial {x}_{nm}} [ ln {p}_{z \vert x} ( Z \vert X ) + ln {p}_{x} ( X ) ] = 0. \qquad ( 59 )$$

The various groups of elements to be considered are the general case, where the data element indices are given as 1<n<N and 1<m<M, and the eight data array boundary cases. The general case is given as:

$$\begin{matrix}[ {w}_{σ} ( {z}_{nm} , {x}_{nm} ) \text{/} {x}_{nm}^{2} + {F}_{x} {w}_{α} ( {x}_{n , m + 1} , {x}_{nm} ) / {x}_{nm}^{2} + \\ {F}_{x} \frac{1}{{x}_{n , m - 1}^{2}} {w}_{α} ( {x}_{nm} , {x}_{n , m - 1} ) + \\ {F}_{y} {w}_{β} ( {x}_{n + 1 , m} , {x}_{nm} ) + \\ {F}_{y} \frac{1}{{x}_{n - 1 , m}^{2}} {w}_{β} ( {x}_{nm} , {x}_{n - 1 , m} ) ] {x}_{nm} - \\ {F}_{x} {w}_{α} ( {x}_{n , m + 1} , {x}_{nm} ) {x}_{n , m + 1} \text{/} {x}_{nm}^{2} - \\ {F}_{x} \frac{1}{{x}_{n , m - 1}^{2}} {w}_{α} ( {x}_{nm} , {x}_{n , m - 1} ) {x}_{n , m - 1} - \\ {F}_{y} {w}_{β} ( {x}_{n + 1 , m} , {x}_{nm} ) {x}_{n + 1 , m} \text{/} {x}_{nm}^{2} - \\ {F}_{y} \frac{1}{{x}_{n - 1 , m}^{2}} {w}_{β} ( {x}_{nm} , {x}_{n - 1 , m} ) {x}_{n - 1 , m} = \\ {w}_{σ} ( {z}_{nm} , {x}_{nm} ) {z}_{nm} \text{/} {x}_{nm}^{2}\end{matrix} \qquad ( 60 )$$

For the case n=1, m=1:

[w_{σ}(z₁₁, x₁₁)+Fₓw_{α}(x₁₂, x₁₁)+F_{y}w_{β}(x₂₁, x₁₁)]x_{11-F}ₓw_{α}(x₁₂, x₁₁)x_{12-F}_{y}w_{β}(x₂₁, x₁₁)x₂₁=w_{σ}(z₁₁,x₁₁)z₁₁. (61)

For the case n=1, m=M:

$$\begin{matrix}[ {w}_{σ} ( {z}_{1 M} , {x}_{1 M} ) \text{/} {x}_{1 M}^{2} + {F}_{x} \frac{1}{{x}_{1 , M - 1}^{2}} {w}_{α} ( {x}_{1 M} , {x}_{1 M - 1} ) + \\ {F}_{y} {w}_{β} ( {x}_{2 M} , {x}_{1 M} ) ] {x}_{1 M} \text{/} {x}_{1 M}^{2} - \\ {F}_{x} \frac{1}{{x}_{1 , M - 1}^{2}} {w}_{α} ( {x}_{1 M} , {x}_{1 M - 1} ) {x}_{1 M - 1} - \\ {F}_{y} {w}_{β} ( {x}_{2 M} , {x}_{1 M} ) {x}_{2 M} \text{/} {x}_{1 M}^{2} = \\ {w}_{σ} ( {z}_{1 M} , {x}_{1 M} ) {z}_{1 M} \text{/} {x}_{1 M}^{2} .\end{matrix} \qquad ( 62 )$$

For the case n=1, 1<m<M:

$$\begin{matrix}[ {w}_{σ} ( {z}_{1 m} , {x}_{1 m} ) \text{/} {x}_{1 m}^{2} + {F}_{x} {w}_{α} ( {x}_{1 , m + 1} {x}_{1 m} ) \text{/} {x}_{1 m}^{2} + \\ {F}_{x} \frac{1}{{x}_{1 , m - 1}^{2}} {w}_{α} ( {x}_{1 m} , {x}_{1 , m - 1} ) + \\ {F}_{y} {w}_{β} ( {x}_{2 m} , {x}_{1 m} ) ] {x}_{1 m} \text{/} {x}_{1 m}^{2} - \\ - {F}_{x} {w}_{α} ( {x}_{1 , m + 1} , {x}_{1 m} ) {x}_{1 , m + 1} , {x}_{1 m}^{2} - \\ {F}_{y} \frac{1}{{x}_{1 , m - 1}^{2}} {w}_{α} ( {x}_{1 m} , {x}_{1 , m - 1} ) {x}_{1 , m - 1} - \\ {F}_{y} {w}_{β} ( {x}_{2 m} , {x}_{1 m} ) {x}_{2 m} \text{/} {x}_{1 m}^{2} = \\ {w}_{σ} ( {z}_{1 m} , {x}_{1 m} ) {z}_{1 m} \text{/} {x}_{1 m}^{2} .\end{matrix} \qquad ( 63 )$$

For the cas n=N, M=1:

$$\begin{matrix}[ {w}_{σ} ( {z}_{N1} , {x}_{N1} ) \text{/} {x}_{N1}^{2} + {F}_{x} {w}_{α} ( {x}_{N2} , {x}_{N1} ) \text{/} {x}_{N1}^{2} + \\ {F}_{y} \frac{1}{{x}_{N - 1 , 1}^{2}} {w}_{β} ( {x}_{N1} , {x}_{N - 1 , 1} ) ] {x}_{N1} - \\ {F}_{x} {w}_{α} ( {x}_{N2} , {x}_{N1} ) {x}_{N2} \text{/} {x}_{N1}^{2} - \\ {F}_{y} \frac{1}{{x}_{N - 1 , 1}^{2}} {w}_{β} ( {x}_{N1} , {x}_{N - 1 , 1} ) {x}_{N - 1 , 1} = \\ {w}_{σ} ( {z}_{N1} , {x}_{N1} ) {z}_{N1} \text{/} {x}_{N1}^{2} .\end{matrix} \qquad ( 64 )$$

For the case n=N, m=M:

$$\begin{matrix}[ {w}_{σ} ( {z}_{NM} , {x}_{NM} ) \text{/} {x}_{NM}^{2} + {F}_{x} \frac{1}{{x}_{N , M - 1}^{2}} {w}_{α} ( {x}_{NM} , {x}_{N , M - 1} ) \\ {F}_{y} \frac{1}{{x}_{N - 1 , M}^{2}} {w}_{β} ( {x}_{NM} , {x}_{N - 1 , M} ) ] {x}_{NM} - \\ {F}_{x} \frac{1}{{x}_{N , M - 1}^{2}} {w}_{α} ( {x}_{NM} , {x}_{N , M - 1} ) {x}_{N , M - 1} - \\ {F}_{y} \frac{1}{{x}_{N - 1 , M}^{2}} {w}_{β} ( {x}_{NM} , {x}_{N - 1 , M} ) {x}_{N - 1 , M} = \\ {w}_{σ} ( {z}_{NM} , {x}_{NM} ) {z}_{NM} \text{/} {x}_{NM}^{2}\end{matrix} \qquad ( 65 )$$

For the case n=N, 1<m<M:

$$\begin{matrix}[ {w}_{σ} ( {z}_{Nm} , {x}_{Nm} ) \text{/} {x}_{NM}^{2} + {F}_{x} {w}_{α} ( {x}_{N , m + 1} , {x}_{Nm} ) / {x}_{Nm}^{2} + \\ {F}_{x} \frac{1}{{x}_{N , m - 1}^{2}} {w}_{α} ( {x}_{Nm} , {x}_{N , m - 1} ) + \\ {F}_{y} \frac{1}{{x}_{N - 1 , m}^{2}} {w}_{β} ( {x}_{Nm} , {x}_{N - 1 , m} ) ] {x}_{Nm} - \\ {F}_{x} {w}_{α} ( {x}_{N , m + 1} , {x}_{Nm} ) {x}_{N , m + 1} \text{/} {x}_{Nm}^{2} - \\ {F}_{x} \frac{1}{{x}_{N , M - 1}^{2}} {w}_{α} ( {x}_{Nm} , {x}_{N , m - 1} ) {x}_{N , M - 1} - \\ {F}_{y} \frac{1}{{x}_{N - 1 , m}^{2}} {w}_{β} ( {x}_{Nm} , {x}_{N - 1 , m} ) {x}_{N - 1 , m} = \\ {w}_{σ} ( {z}_{Nm} , {x}_{Nm} ) {z}_{Nm} \text{/} {x}_{Nm}^{2} .\end{matrix} \qquad ( 66 )$$

For the case 1<n<N, m=1:

$$\begin{matrix}[ {w}_{σ} ( {z}_{n1} , {x}_{n1} ) \text{/} {x}_{n1}^{2} + {F}_{x} {w}_{α} ( {x}_{n2} , {x}_{n1} ) \text{/} {x}_{n1}^{2} + \\ {F}_{y} {w}_{β} ( {x}_{n + 1 , 1} , {x}_{n1} ) \text{/} {x}_{n1}^{2} \\ {F}_{y} \frac{1}{{x}_{n - 1 , m}^{2}} {w}_{β} ( {x}_{n1} , {x}_{n - 1 , 1} ) ] {x}_{n1} - \\ {F}_{x} {w}_{α} ( {x}_{n2} , {x}_{n1} ) {x}_{n2} \text{/} {x}_{n1}^{2} - \\ {F}_{y} {w}_{β} ( {x}_{n + 1 , 1} , {x}_{n1} ) {x}_{n + 1 , 1 / {x}_{n1}^{2}} - \\ {F}_{y} \frac{1}{{x}_{n - 1 , 1}^{2}} {w}_{β} ( {x}_{n1} , {x}_{n - 1 , 1} ) {x}_{n - 1 , 1} = \\ {w}_{σ} ( {z}_{n1} , {x}_{n1} ) {z}_{n1} \text{/} {x}_{n1}^{2} .\end{matrix} \qquad ( 67 )$$

And finally, for the case 1<n<N, m=M:

$$\begin{matrix}[ {w}_{σ} ( {z}_{nM} , {x}_{nM} ) / {x}_{nM}^{2} + {F}_{x} \frac{1}{{x}_{n , M - 1}^{2}} {w}_{α} ( {x}_{nM} , {x}_{n , M - 1} ) + \\ {F}_{y} {w}_{β} ( {x}_{n + 1 , M} , {x}_{n , M} ) / {x}_{nM}^{2} + \\ {F}_{y} \frac{1}{{x}_{n - 1 , M}^{2}} {w}_{β} ( {x}_{nM} , {x}_{n - 1 , M} ) ] {x}_{nM} - \\ {F}_{x} \frac{1}{{x}_{n , M - 1}^{2}} {w}_{α} ( {x}_{nM} , {x}_{n , M - 1} ) {x}_{n , M - 1} - \\ {F}_{y} {w}_{β} ( {x}_{n + 1 , M} , {x}_{nM} ) {x}_{n + 1 , M} / {x}_{nM}^{2} - \\ {F}_{y} \frac{1}{{x}_{n - 1 , M}^{2}} {w}_{β} ( {x}_{nM} , {x}_{n - 1 , M} ) {x}_{n - 1 , M} = \\ {w}_{σ} ( {z}_{nM} , {x}_{nM} ) {z}_{nM} / {x}_{nM}^{2} .\end{matrix} \qquad ( 68 )$$

With each of these cases defined, the system of expressions can be solved in a number of ways. One can either group the X-direction indices together or group the Y-direction indices together. In one example scenario, the Y-direction indices are grouped together, that is, xₙₘ and zₙₘ are regarded not as matrices but as long vectors formed by stacking groups of Y-direction indices on top of each other ordered by the X-direction index. Visually what is meant here is given as:

$$x = ( \begin{matrix}{x}_{11} \\ {x}_{21} \\ ⋮ \\ {x}_{N1} \\ {x}_{12} \\ {x}_{22} \\ ⋮ \\ {x}_{N2} \\ ⋮ \\ {x}_{NM}\end{matrix} ) . \qquad ( 69 )$$

With this index grouping the MAP expression system matrix becomes the following:

$$( \begin{matrix}• & • & & & & • & & & & & & & & & & & & & & \\ • & • & • & & & & • & & & & & & & & & & & & & \\ & • & • & • & & & & • & & & & & & & & & & & & \\ & & • & • & • & & & & • & & & & & & & & & & & \\ & & & • & • & & & & & • & & & & & & & & & & \\ • & & & & & • & • & & & & • & & & & & & & & & \\ & • & & & & • & • & • & & & & • & & & & & & & & \\ & & • & & & & • & • & • & & & & • & & & & & & & \\ & & & • & & & & • & • & • & & & & • & & & & & & \\ & & & & • & & & & • & • & & & & & • & & & & & \\ & & & & & • & & & & & • & • & & & & • & & & & \\ & & & & & & • & & & & • & • & • & & & & • & & & \\ & & & & & & & • & & & & • & • & • & & & & • & & \\ & & & & & & & & • & & & & • & • & • & & & & • & \\ & & & & & & & & & • & & & & • & • & & & & & • \\ & & & & & & & & & & • & & & & & • & • & & & \\ & & & & & & & & & & & • & & & & • & • & • & & \\ & & & & & & & & & & & & • & & & & • & • & • & \\ & & & & & & & & & & & & & • & & & & • & • & • \\ & & & & & & & & & & & & & & • & & & & • & •\end{matrix} ) = ( \begin{matrix}{E}_{1} & {D}_{1} & & & & \\ {D}_{1} & {E}_{2} & {D}_{2} & & & \\ & {D}_{2} & {E}_{3} & {D}_{3} & & \\ & & {D}_{3} & ⋰ & ⋰ & \\ & & & ⋰ & {E}_{M - 1} & {D}_{M - 1} \\ & & & & {D}_{M - 1} & {E}_{M}\end{matrix} ) . \qquad ( 70 )$$

It is here seen that the system matrix is block tri-diagonal. The Eᵢ's are N×N symmetric tri-diagonal matrices and the Dᵢ's are N×N diagonal matrices. The right hand side of the system matrix is made up of the terms:

w_{σ}(zₙₘ, Xₙₘ)zₙₘ/xₙₘ², (71)

which are grouped into a long vector, hereinafter denoted by b as:

$$b = ( \begin{matrix}{b}_{1} \\ {b}_{2} \\ ⋮ \\ {b}_{M}\end{matrix} ) = ( \begin{matrix}{w}_{σ} ( {z}_{11} , {x}_{11} ) {z}_{11} / {x}_{11}^{2} \\ {w}_{σ} ( {z}_{21} , {x}_{21} ) {z}_{21} / {x}_{21}^{2} \\ ⋮ \\ {w}_{σ} ( {z}_{N1} , {x}_{N1} ) {z}_{N1} / {x}_{N1}^{2} \\ {w}_{σ} ( {z}_{12} , {x}_{12} ) {z}_{12} / {x}_{12}^{2} \\ {w}_{σ} ( {z}_{22} , {x}_{22} ) {z}_{22} / {x}_{22}^{2} \\ ⋮ \\ {w}_{σ} ( {z}_{NM} , {x}_{NM} ) {z}_{NM} / {x}_{NM}^{2}\end{matrix} ) . \qquad ( 72 )$$

This system can be rewritten by block LU factorization as follows:

$$( \begin{matrix}{E}_{1} & {D}_{1} & & & & \\ {D}_{1} & {E}_{2} & {D}_{2} & & & \\ & {D}_{2} & {E}_{3} & {D}_{3} & & \\ & & {D}_{3} & ⋰ & ⋰ & \\ & & & ⋰ & {E}_{M - 1} & {D}_{M - 1} \\ & & & & {D}_{M - 1} & {E}_{M}\end{matrix} ) = ( \begin{matrix}{L}_{1} & I & & & & \\ & {L}_{2} & I & & & \\ & & {L}_{3} & ⋰ & & \\ & & & ⋰ & & \\ & & & & I & \\ & & & & {L}_{M - 1} & I\end{matrix} ) ( \begin{matrix}{U}_{1} & {D}_{1} & & & & \\ & {U}_{2} & {D}_{2} & & & \\ & & {U}_{3} & {D}_{3} & & \\ & & & ⋰ & ⋰ & \\ & & & & {U}_{M - 1} & {D}_{M - 1} \\ & & & & & {U}_{M}\end{matrix} ) = ( \begin{matrix}{U}_{1} & {D}_{1} & & & & \\ {L}_{1} {U}_{1} & {L}_{1} {D}_{1} + {U}_{2} & {D}_{2} & & & \\ & {L}_{2} {D}_{2} & {L}_{2} {D}_{2} + {U}_{3} & {D}_{3} & & \\ & & {L}_{3} {U}_{3} & ⋰ & ⋰ & \\ & & & ⋰ & {L}_{M - 2} {D}_{M - 2} + {U}_{M - 1} & {D}_{M - 1} \\ & & & & {L}_{M - 1} {U}_{M - 1} & {L}_{M - 1} {Δ}_{M - 1} + {U}_{M}\end{matrix} ) . \qquad ( 73 )$$

The system matrix can now be solved for the MAP estimate of the data element pdf means. In a first example implementation of this solution, MatLab™ from The MathWorks, Natick, Mass., or other suitable solution processor, is preferably employed to carry out the estimation solution. In the following example, a MatLab™ solution is assumed. First, define the following equalities:

$${U}_{1} = {E}_{1} , \\ {L}_{1} {U}_{1} = {D}_{1} solve for {L}_{1} = {D}_{1} / {U}_{1} , \\ {U}_{2} = {E}_{2} - {L}_{1} {D}_{1} , \\ {L}_{2} {U}_{2} = {D}_{2} solve for {L}_{2} = {D}_{2} / {U}_{2} , \\ ⋮$$

$${U}_{M - 1} = {E}_{M - 1} - {L}_{M - 2} {D}_{M - 2} , \\ {L}_{M - 1} {U}_{M - 1} = {D}_{M - 1} solve for {L}_{M - 1} = {D}_{M - 1} / {U}_{M - 1} , \\ {U}_{M} = {E}_{M} - {L}_{M - 1} {D}_{M - 1}$$

Note that for clarity, the MatLab™ notation of “right division,” LᵢDᵢ/Uᵢ, has been here used. This is intended to indicate, effectively, that Lᵢ=Dᵢ*Uᵢ⁻¹, even though the inverse is not actually computed in MatLab

In the next step, a solution to the following matrix expression is obtained:

$$( \begin{matrix}I & & & & & \\ {L}_{1} & I & & & & \\ & {L}_{2} & I & & & \\ & & {L}_{3} & ⋰ & & \\ & & & ⋰ & I & \\ & & & & {L}_{M - 1} & I\end{matrix} ) ( \begin{matrix}{y}_{1} \\ {y}_{2} \\ ⋮ \\ {y}_{M}\end{matrix} ) = ( \begin{matrix}{b}_{1} \\ {b}_{2} \\ ⋮ \\ {b}_{M}\end{matrix} ) , \qquad ( 74 )$$

by forward block pivoting as

$${y}_{1} = {b}_{1} , \\ {y}_{2} = {b}_{2} - {L}_{1} {y}_{1} , \\ {y}_{3} = {b}_{3} - {L}_{2} {y}_{2} , \\ ⋮$$

$${y}_{M} = {b}_{M} - {L}_{M - 1} {y}_{M - 1} .$$

Then a solution to the following matrix expression is obtained:

$$( \begin{matrix}{U}_{1} & {D}_{1} & & & & \\ & {U}_{2} & {D}_{2} & & & \\ & & {U}_{3} & {D}_{3} & & \\ & & & ⋰ & ⋰ & \\ & & & & {U}_{M - 1} & {D}_{M - 1} \\ & & & & & {U}_{M}\end{matrix} ) ( \begin{matrix}{x}_{1} \\ {x}_{2} \\ ⋮ \\ {x}_{M}\end{matrix} ) = ( \begin{matrix}{y}_{1} \\ {y}_{2} \\ ⋮ \\ {y}_{M}\end{matrix} ) , \qquad ( 75 )$$

by backward block pivoting as:

$${x}_{M} = {U}_{M} \backslash {y}_{M} , \\ {x}_{M - 1} = {U}_{M - 1} \backslash ( {y}_{M - 1} - {Δ}_{M - 1} {x}_{M} ) , \\ {x}_{M - 2} = {U}_{M - 2} \backslash ( {y}_{M - 2} - {Δ}_{M - 2} {x}_{M - 1} ) , \\ ⋮$$

$${x}_{1} = {U}_{1} \backslash ( {y}_{1} - {Δ}_{1} {x}_{2} ) .$$

Note that again for clarity, the MatLab™ notation of left division was here used, where U_{M}/y_{M} is intended to refer to U_{M}⁻¹y_{M}.

For many implementations of the processing of these expressions, it can be preferred to maintain the MAP system expressions in matrix form for ease of solution; this also enables the MatLab™ coding to follow the theory more closely. In one example of such a technique, a first matrix, ediag, is defined as a matrix of size (N, M) that holds the diagonal elements of the Eᵢ matrices above; eup is defined as a matrix of size (N−1, M) that holds the upper and lower off-diagonal elements of the Eᵢ matrices above; dup is a matrix of size (N, M−1) that holds the diagonal elements of the upper and lower off-block-diagonal matrices D, above; and b is a matrix of size (N, M) that holds the values of the right hand side of the expression.

It can further be preferable, for enabling ease of solution, to define matrices to hold intermediate and final results of the solution. In one example of such a configuration, map is defined as a matrix of size (N, M) to hold the final pdf estimation solution; y is defined as a matrix of size (N, M); l is defined as a hyper-matrix of size (N, N, M−1); u is defined as a hyper-matrix of size (N, N, M); and tdiag is defined as a temporary matrix of size (N, N).

With these matrices defined, a MAP estimate of the pdf means of a two-dimensional data array can be determined. As explained above, it is preferred in accordance with the invention that at least two iterations of processing to solve the MAP system expressions be carried out to determine a final pdf mean estimate for each data element in the data set array. To enable a first iteration of processing of the nonlinear equations, the data element values are for the first iteration designated as the unknown pdf mean values. It is more specifically preferred, as described above, that the data element values first be block averaged, and that resulting average values be designated as the unknown pdf mean values. The block average can be carried out, e.g., as an average of, say, 7-9 data element values, only in one dimension, say the X-dimension.

Just as in the one-dimensional case described above, in the first iteration of the two-dimensional MAP expression solution, the probability factors, Pₛ, P_{dx}, and P_{dy}, are set equal to zero, whereby the w_{σ}, w_{α}, and w_{β} functions given above are all equal to unity. Values for the smoothness parameters in the X and Y directions, Fₓ and F_{y}, are selected; a smoothness value of between 50-1000 can be suitable for many applications, but should be selected based on the particular feature size of interest in a given data element set. Then the solution expressions given above are employed with the initial designation of the values for the unknown pdf means to form the system matrix; specifically, the matrices ediag, eup, dup, and b are formed. The general terms to be processed are given below; the special cases at the boundaries of the data array, where the element indices are given as n=1, n=N, m=1, and m=M, can be similarly be produced by removing the corresponding terms:

$$ediag ( n , m ) = ( 1 + {F}_{x} ) / {x}_{n m}^{2} + {F}_{x} \frac{1}{{x}_{n , m - 1}^{2}} + {F}_{y} / {x}_{n m}^{2} + {F}_{y} \frac{1}{{x}_{n - 1 , m}^{2}}$$

$$eup ( n , m ) = - {F}_{y} / {x}_{n m}^{2}$$

$$dup ( n , m ) = - {F}_{x} / {x}_{n m}^{2}$$

$$b ( n , m ) = {z}_{n m} / {x}_{n m}^{2}$$

With these expressions, the system matrix is then solved to produce a first two-dimensional MAP estimate of the data element pdf means.

A second iteration of processing to produce a second MAP estimate is then carried out, here with the probability parameters, Pₛ, P_{dx}, and P_{dy}, set at a reasonable nonzero value, such as 0.5, whereby the functions w_{σ}, w_{α}, and w_{β} are now less than unity. The discontinuity factors, Δₓ=Δ_{y} are also assigned a value, e.g., 3. With these designated parameter values, the MAP system matrix is then set up, here designating the first iteration pdf mean estimates as the unknown pdf mean values. The general MAP expression to be solved is then given as:

$$\begin{matrix}ediag ( n , m ) = {w}_{σ} ( {z}_{n m} , {x}_{n m} ) / {x}_{n m}^{2} + {F}_{x} {w}_{α} ( {x}_{n , m + 1} , {x}_{n m} ) / {x}_{n m}^{2} + \\ {F}_{x} \frac{1}{{x}_{n , m - 1}^{2}} {w}_{α} ( {x}_{n m} , {x}_{n , m - 1} ) + \\ {F}_{y} {w}_{β} ( {x}_{n + 1 , m} , {x}_{n m} ) / {x}_{n m}^{2} + {F}_{y} \frac{1}{{x}_{n - 1 , m}^{2}} {w}_{β} ( {x}_{n m} , {x}_{n - 1 , m} )\end{matrix}$$

$$eup ( n , m ) = - {F}_{y} {w}_{β} ( {x}_{n + 1 , m} , {x}_{n m} ) / {x}_{n m}^{2}$$

$$dup ( n , m ) = - {F}_{x} {w}_{α} ( {x}_{n , m + 1} , {x}_{n m} ) / {x}_{n m}^{2}$$

$$b ( n , m ) = {w}_{σ} ( {z}_{n m} , {x}_{n m} ) {z}_{n m} / {x}_{n m}^{2}$$

The expressions for the special cases of data array boundaries can be similarly developed. With these expressions, the MAP system is then solved again, to produce a MAP estimate, xₙₘ^{MAP}, that for most applications is sufficient as a final pdf mean estimate. If desired, an additional one or more iterations can be carried out, but for most applications it is found that only two passes of processing are required. With the mean estimates determined, the data set array can be normalized by the estimates, or other desired processing operation can be carried out.

In accordance with the invention, alternative solution techniques can be employed for, e.g., enhancing the efficiency or flexibility of the solution process. For example, sparse matrix manipulation techniques can be employed, and may be preferable for many applications, to enhance the speed of the solution process and/or to reduce the memory requirements of the process. Suitable example sparse matrix methods include general sparse matrix inversion, sparse conjugate gradient algorithms, and preconditioned sparse conjugate gradient algorithms. General sparse matrix inversion can be implemented with, e.g., the SPARSE and MLDIVIDE commands of MatLab™.

The conjugate gradient algorithm is an iterative method for solving linear systems that uses only matrix-vector multiplication operations. For almost-diagonal matrices, it converges quickly; for other matrices, it converges more slowly. This technique tends to converge slowly for the two-dimensional pdf mean estimation process of the invention, and so may not be preferable for many applications. The preconditioned conjugate gradient algorithm is a CG algorithm employing a “preconditioning” matrix that makes the linear system “look” diagonal to achieve fast CG convergence. If the cost of computing the preconditioning matrix is more than offset by the speedup in the CG method, then this method can be preferable. Because the sparse incomplete LU factorization for the two-dimensional pdf estimation process is adequate for many applications, this technique can often be found superior to the others. This linear system solver [sparse matrices (“SPARSE”)+incomplete LU (“LUINC”)+conjugate gradient (“CGS”)] can yield a significant speedup in processing over other matrix manipulation techniques. In general, the technique as implemented here produces the system matrix as a sparse matrix, a, as:

a=a+sparse(row_indices, column_indices, corresponding_data)

until there is filled all of the system matrix non-zero entries, i.e., the main diagonal, the just-off-diagonal terms, and the off-block-diagonal terms, herein referred to as the fringes. Once the system matrix is thusly formed, the matrix is preconditioned into a partial LU decomposition, L and U by:

[L,U]=luinc(a, tolerance)

Finally, there is shown the cgs function passing in the a sparse matrix, along with its partial LU decomposition and tolerance. cgs is an iterative algorithm, whereby iteration continues until its error term is less than the specified tolerance. Two or three iterations generally are sufficient unless the tolerance is set very small. This process completes one solution iteration of the two-dimensional pdf mean estimation process of the invention. A second or more solution iterations can then be carried out, here including non-zero probability parameter values for Pₛ, P_{dx},and P_{dy} in the manner described above.

As explained above, the two-dimensional pdf mean estimation process of the invention can be preferred for many applications, given its ability to account for data characteristics that are inherently two-dimensional in nature. The following examples illustrate this capability. FIG. 18 is a plot of a two dimensional synthetic data set, here displayed employing the conventions of an X axis and a Y axis for identifying the data elements in the two dimensions of the data set. The data includes three distinct data element value characteristics, or discontinuities, that extend across the Y axis of the data set elements, and further includes exponentially distributed noise that extends across a number of the X axis data set elements.

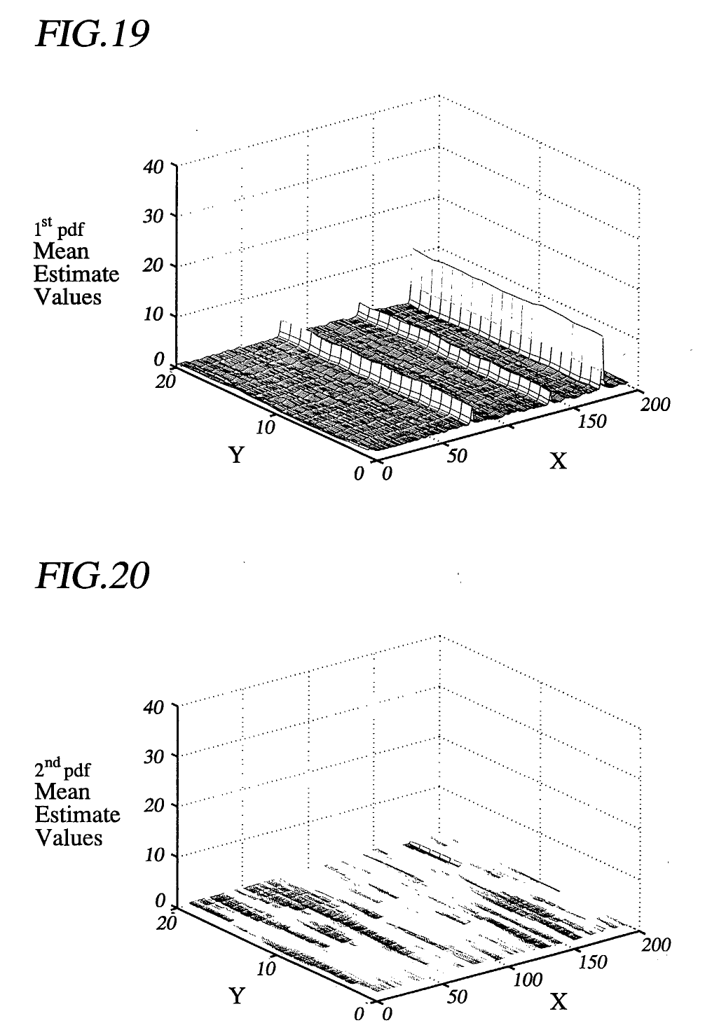

FIG. 19 is a plot of the MAP estimate of the pdf statistical means for the two-dimensional data set after one iteration estimation solution. The two-dimensional smoothness factor values employed here were taken to be 128 in both dimensions of the data set. Note that after the first estimation solution iteration, the data element value discontinuities are accounted for and the noise values are not included. FIG. 20 is a plot of the MAP estimate of the pdf statistical means for the two-dimensional data set after two iterations of estimation solution. Note here that the pdf mean estimates are not artificially biased by the data discontinuities, whereby those data discontinuities would be preserved if the data were to be normalized by the pdf mean estimates. This data demonstrates that the full two-dimensional pdf mean estimation process can distinguish between true data values or signals such as the data discontinuities in both the X and Y dimensions of this data set and the underlying pdf means of the date elements, whereby the data values are not included in the estimate of the data's pdf means.

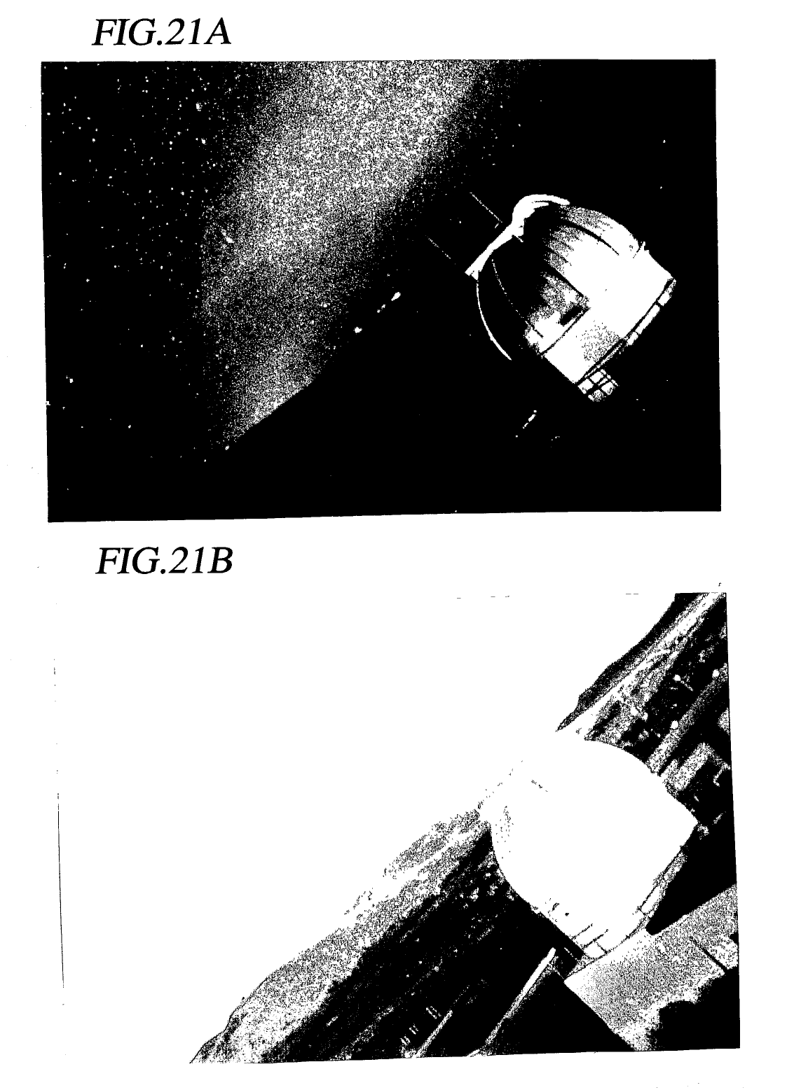

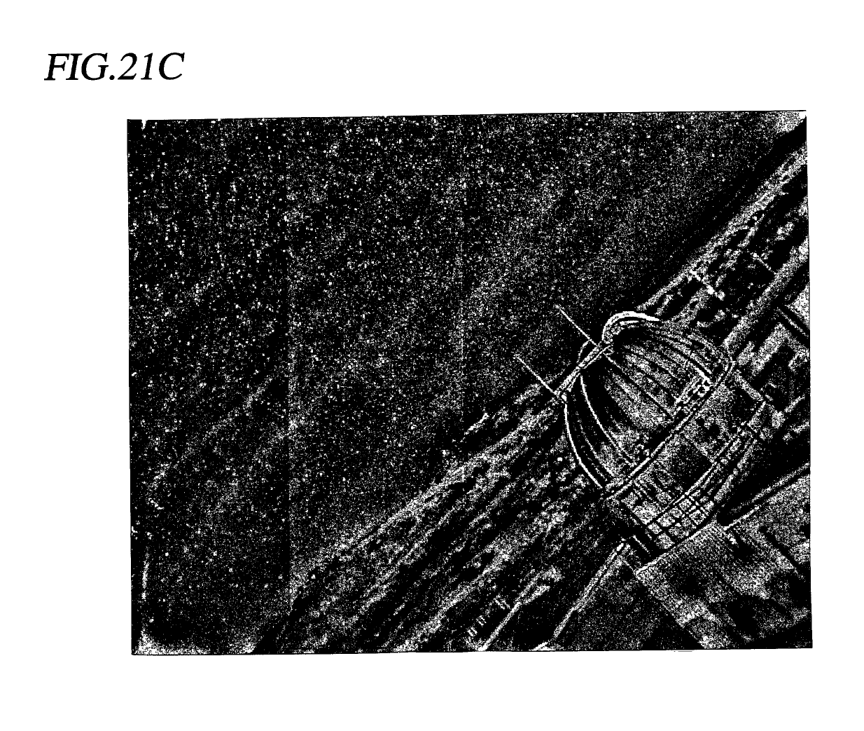

Turning to the results on an actual two-dimensional data set, consider a two-dimensional image having a large dynamic range due to, e.g., artificial lighting in outdoor night time conditions. Typically, for such an image, it is not conventionally possible to display the entire dynamic range of the image; only a sub-range can be displayed at one time. FIG. 21A is an example of such a scenario for an image of an outdoor night scene including a lighted observatory and a ground area against a nighttime sky. In this example, a sub-range of the full dynamic range of the scene has been selected such that local contrast of the sky detail is emphasized. As a result, the dynamic range and local contrast of detail of the ground and observatory areas is lost.

FIG. 21B provides the converse example; here a sub-range of the data values of the scene has been selected such that the local contrast of details of the ground area are emphasized. But as a result, the local contrast of sky detail is here lost. FIG. 21C shows the results of the two-dimensional pdf mean estimation process of the invention when applied to the image to normalize its large dynamic range scene. The pdf mean estimation process enables local contrast across the entire scene; note that the mean of the sky region has been adjusted to correspond to the mean of the ground region and the building region. As a result, specific details of the ground, the sky, and the building can be clearly identified all in one image.

This dynamic range reduction was produced by specifying a value of 128 for the smoothness parameter in both the X- and Y dimensions. The probability of a data element value departing significantly from that element's pdf mean, and the probability of discontinuity in estimated pdf means in the X and Y dimensions were all set at 0.5. The dimensionless parameters for data value excursion and discontinuity values, the Δ parameters, were set to 3 With this processing as-provided by the invention, the dynamic range of the original image has been reduced to a range that enables the preservation of local contrast throughout the various regions of the scene, even though those regions exhibit quite disparate image values.

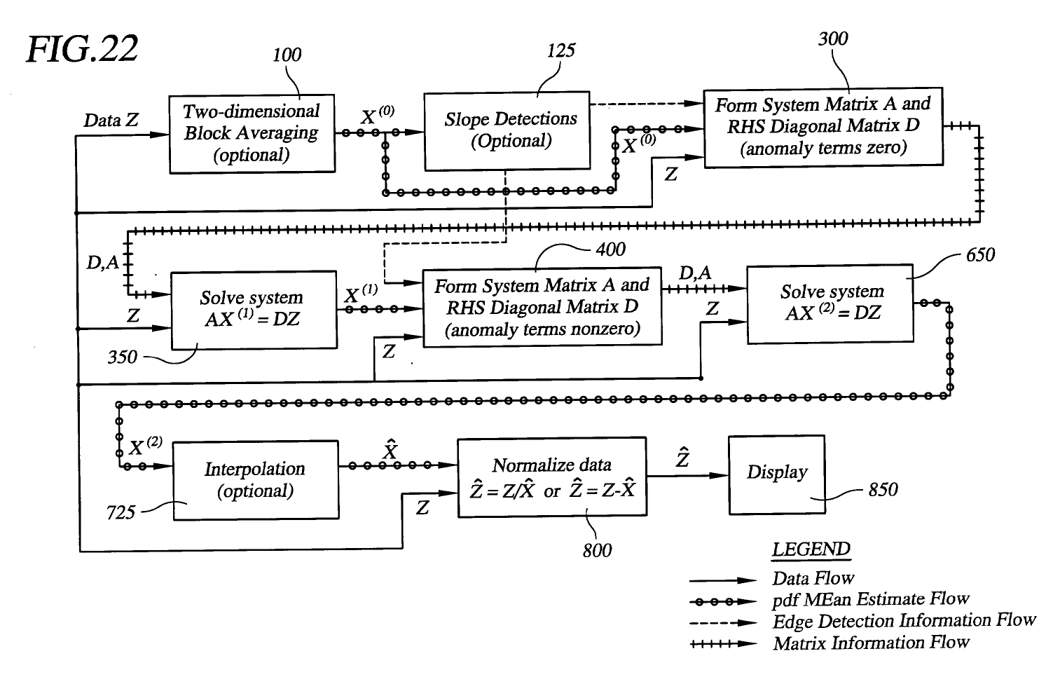

Turning to FIG. 22, there is provided a flow diagram of a specific example two-dimensional data set normalization process implementation 50 provided by the invention to obtain the exceptional results demonstrated by the image of FIG. 21C. Each step of the process will be described in detail below, referring also to additional, corresponding flow diagram blocks of specific implementation tasks not necessarily shown on the higher level diagram of FIG. 22.

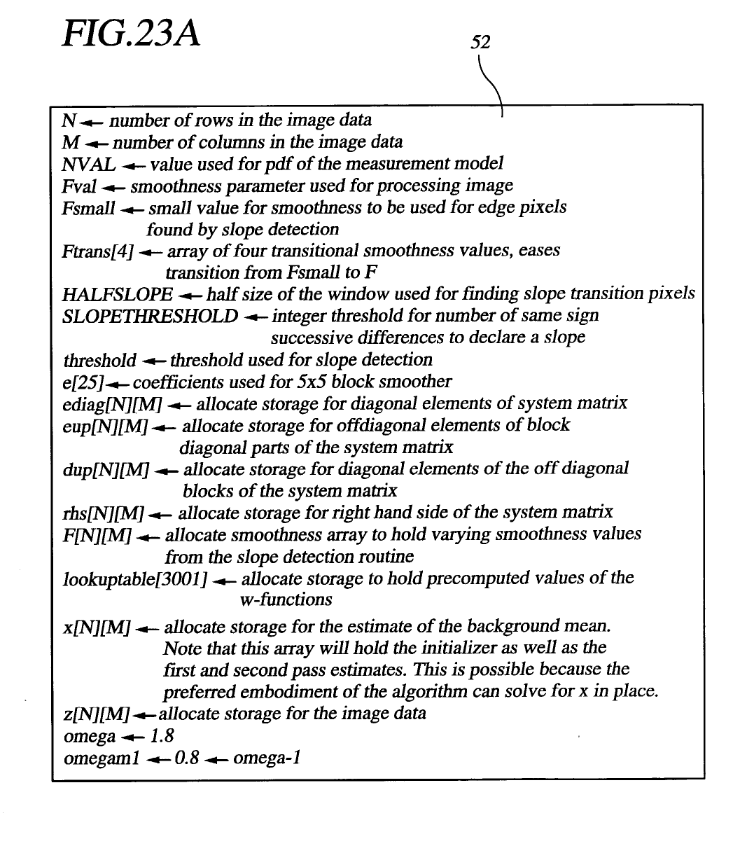

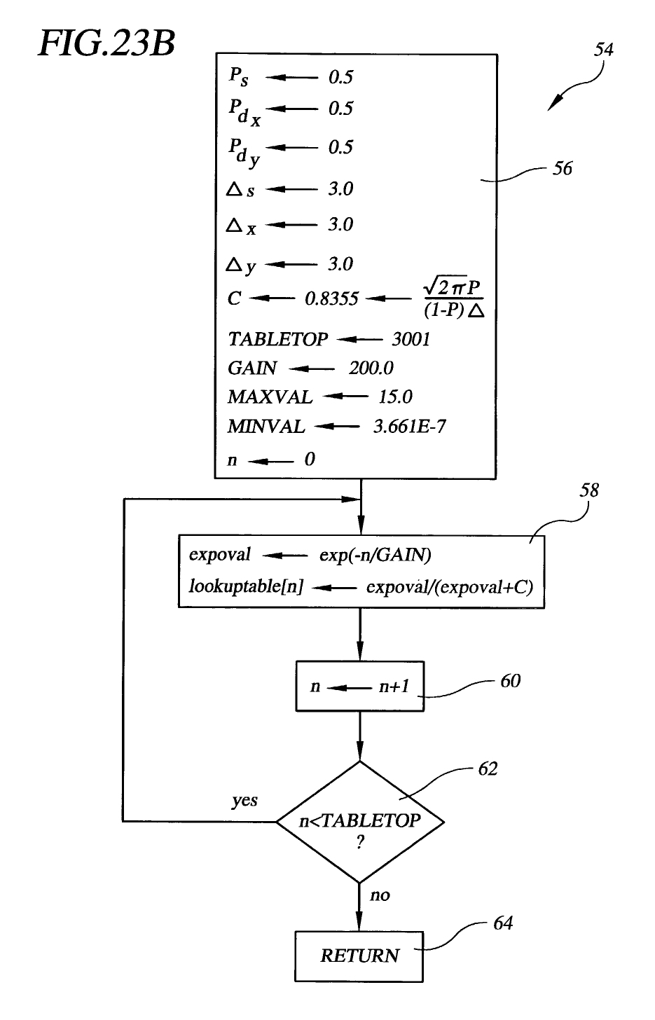

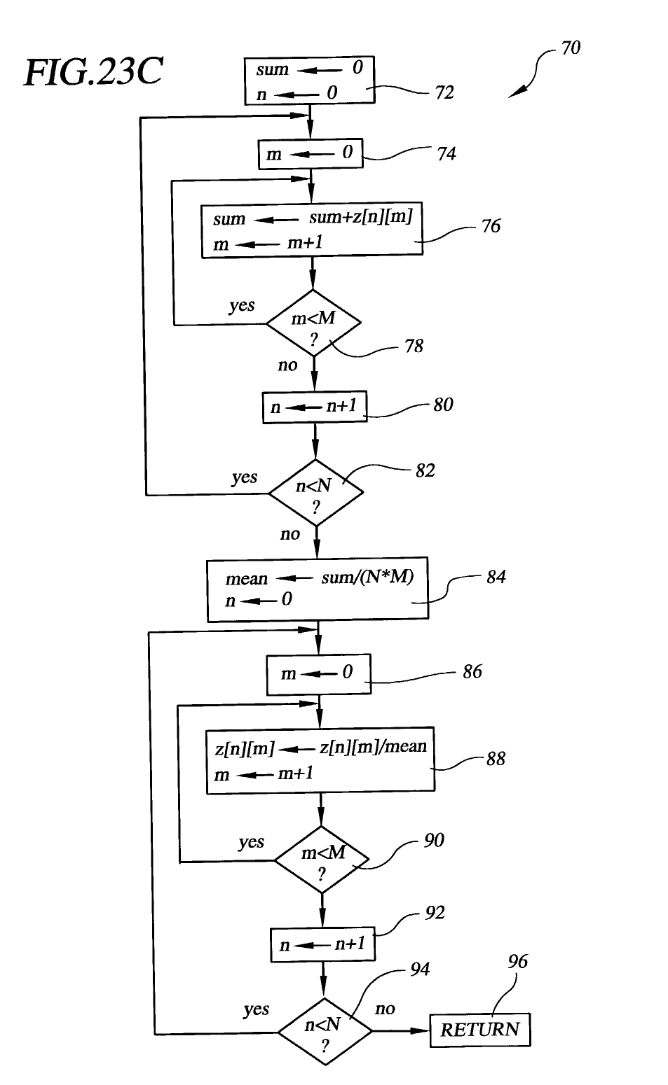

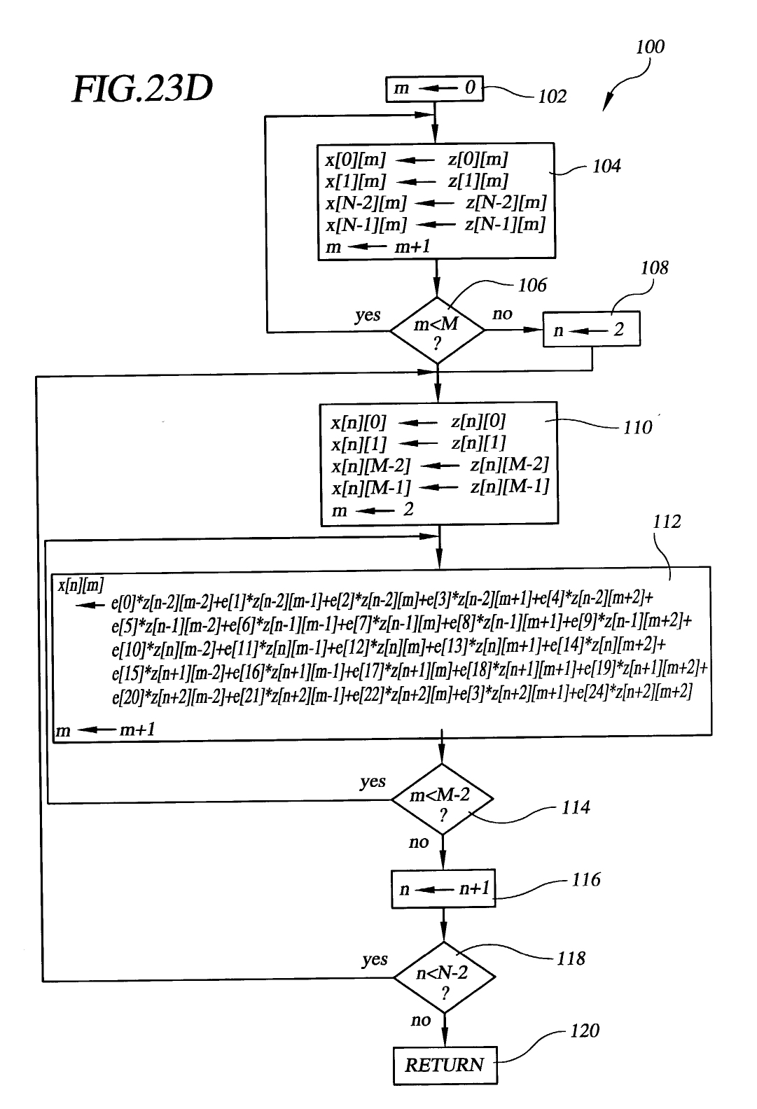

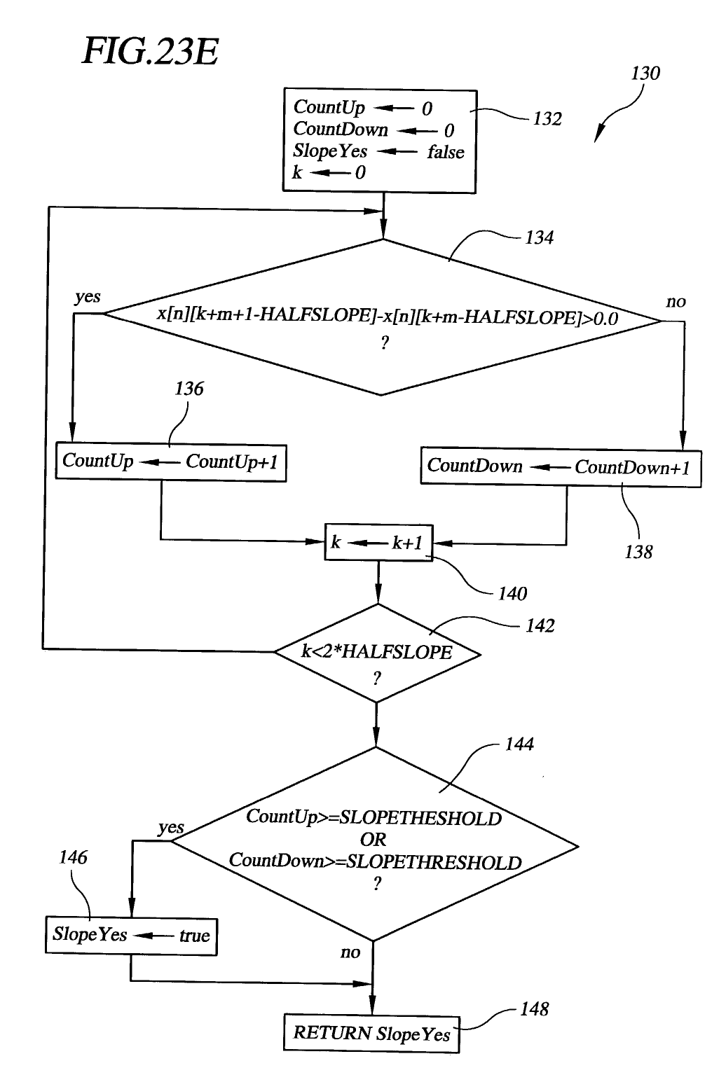

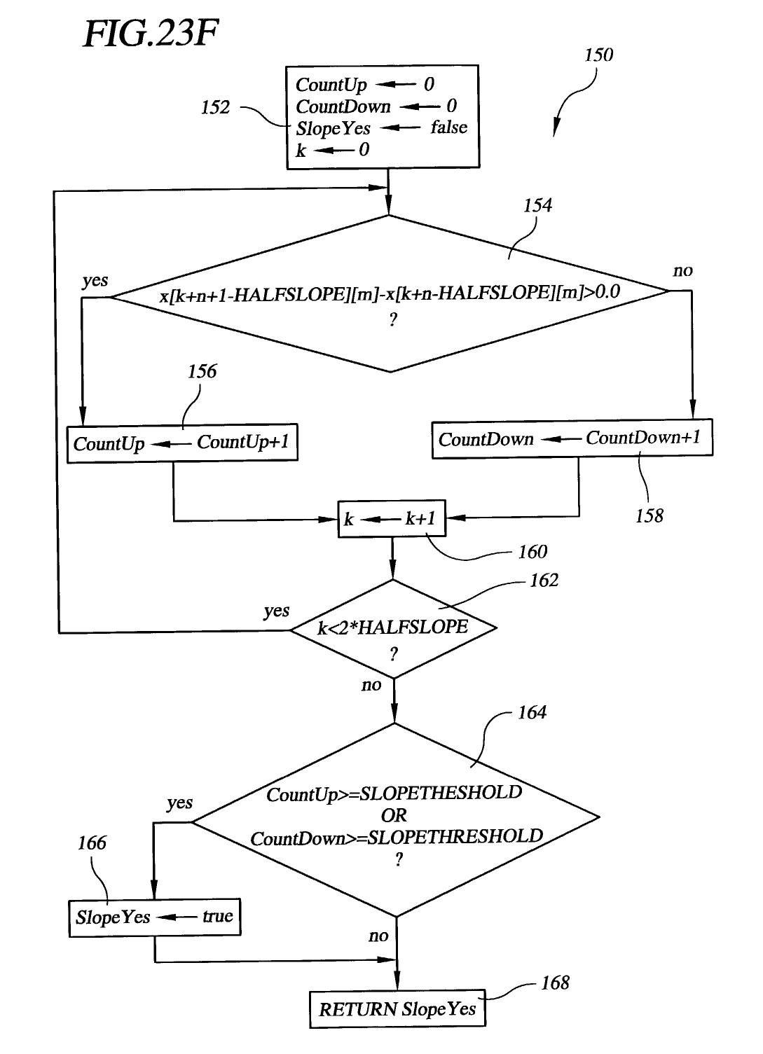

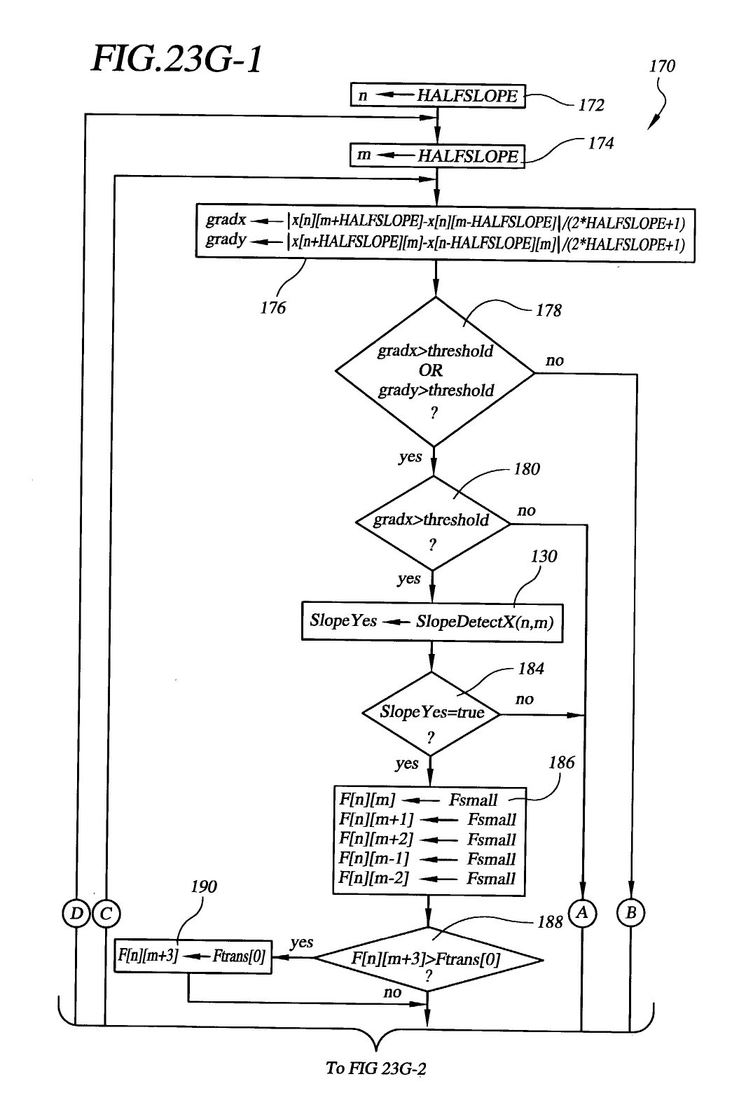

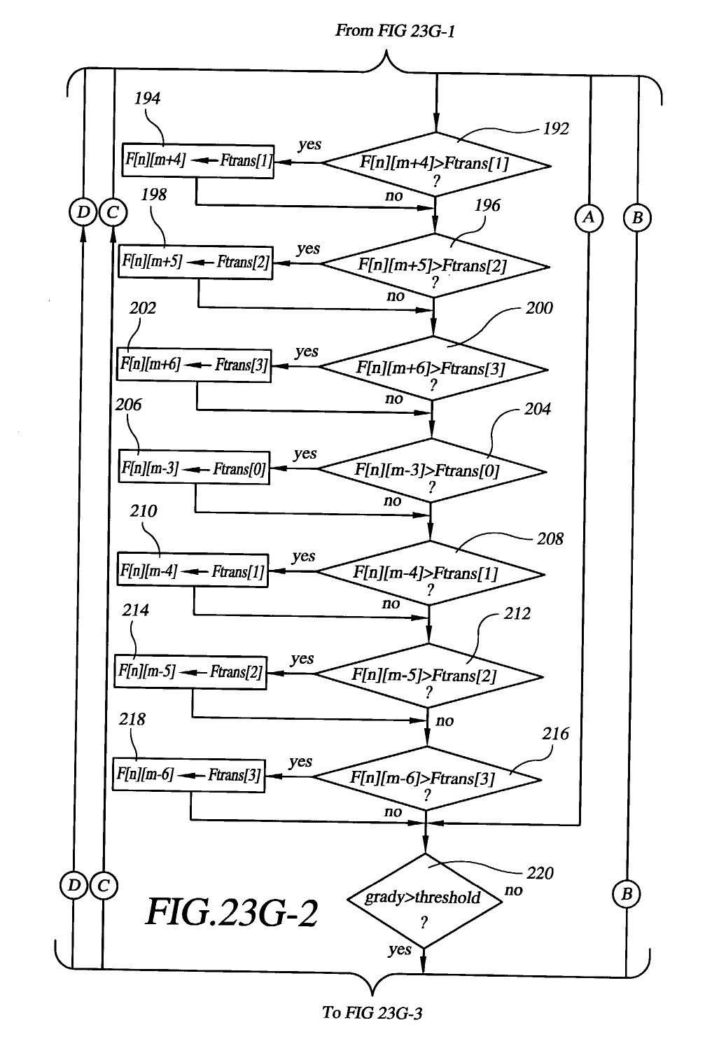

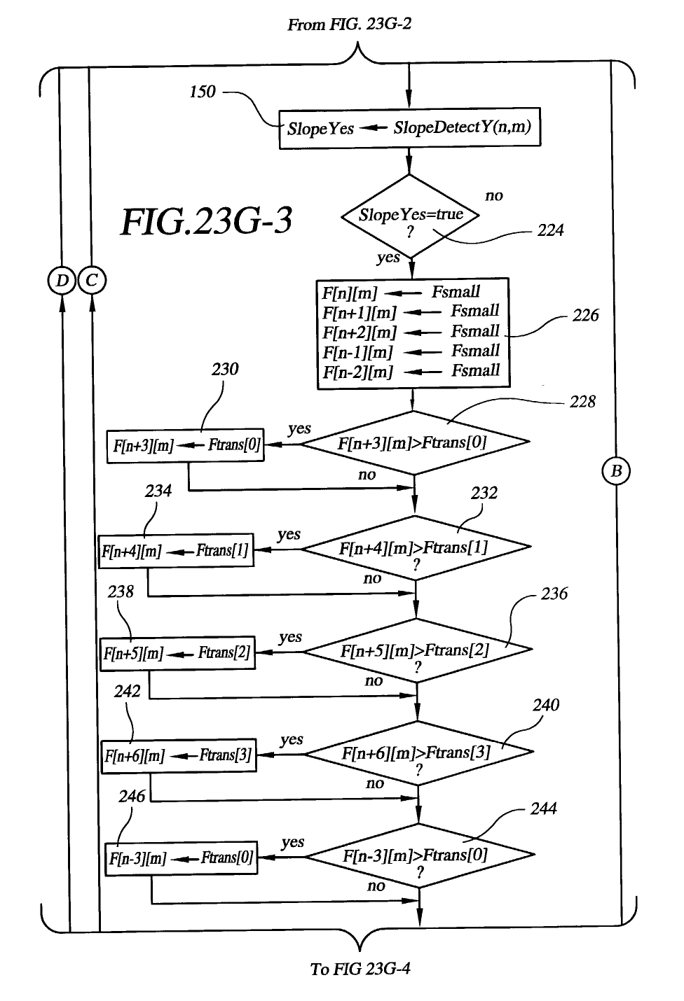

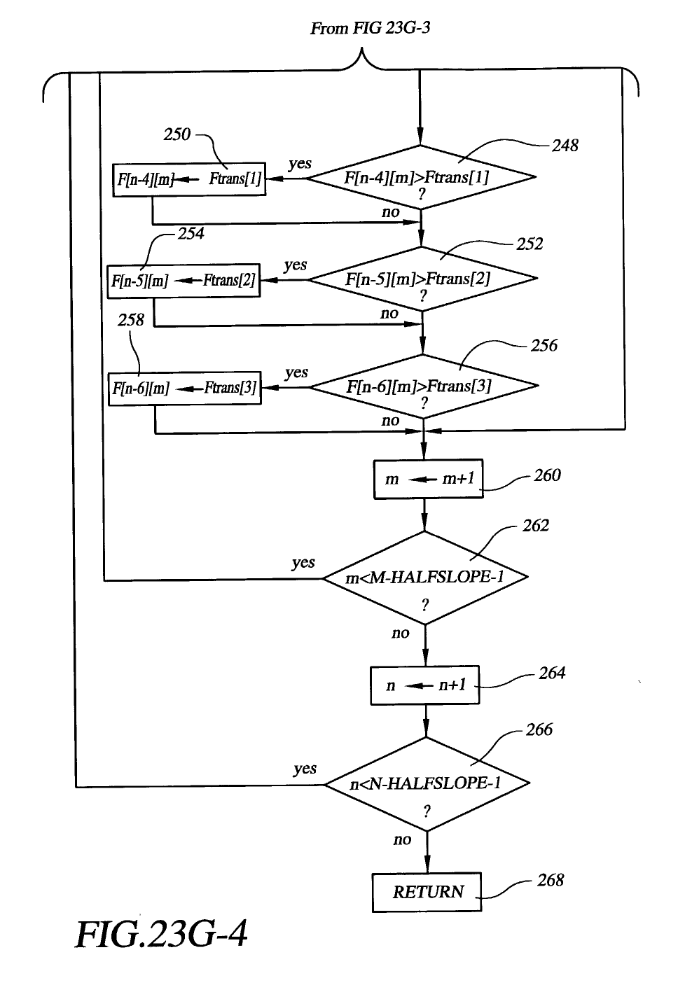

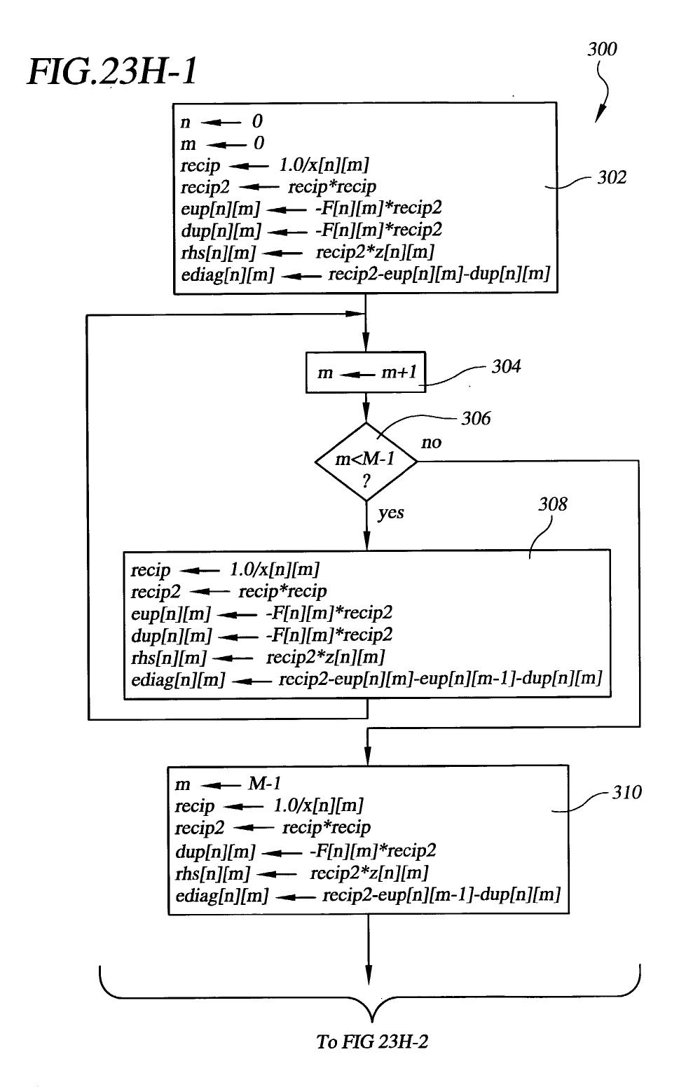

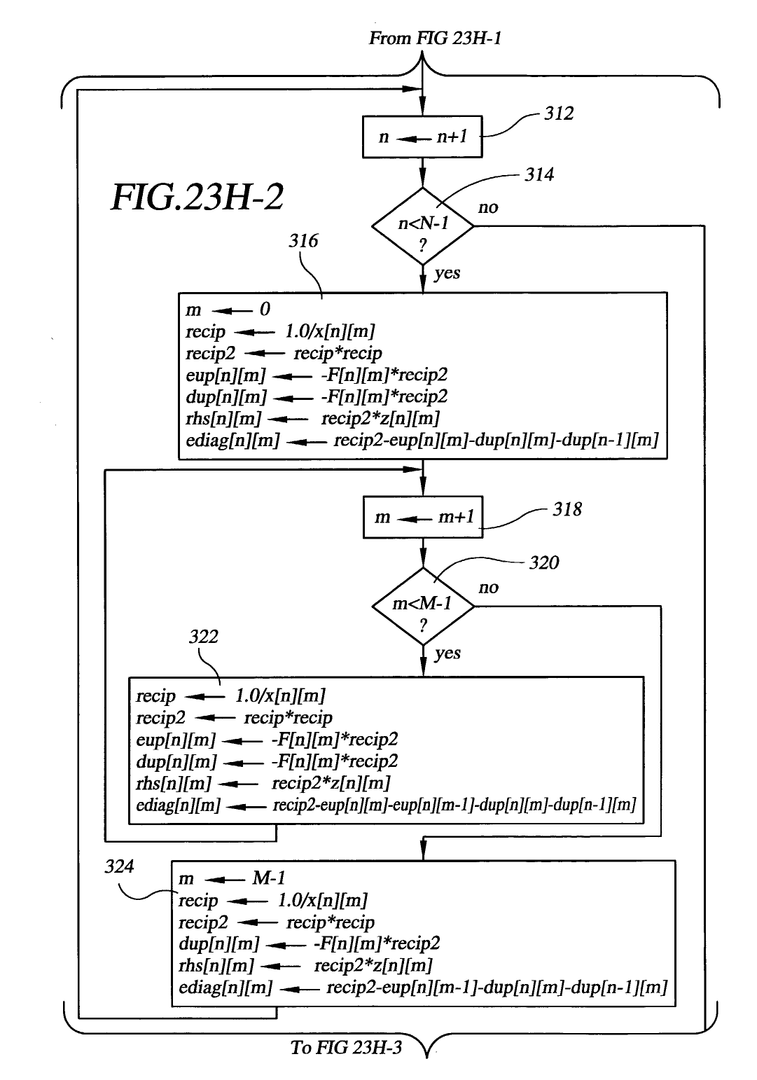

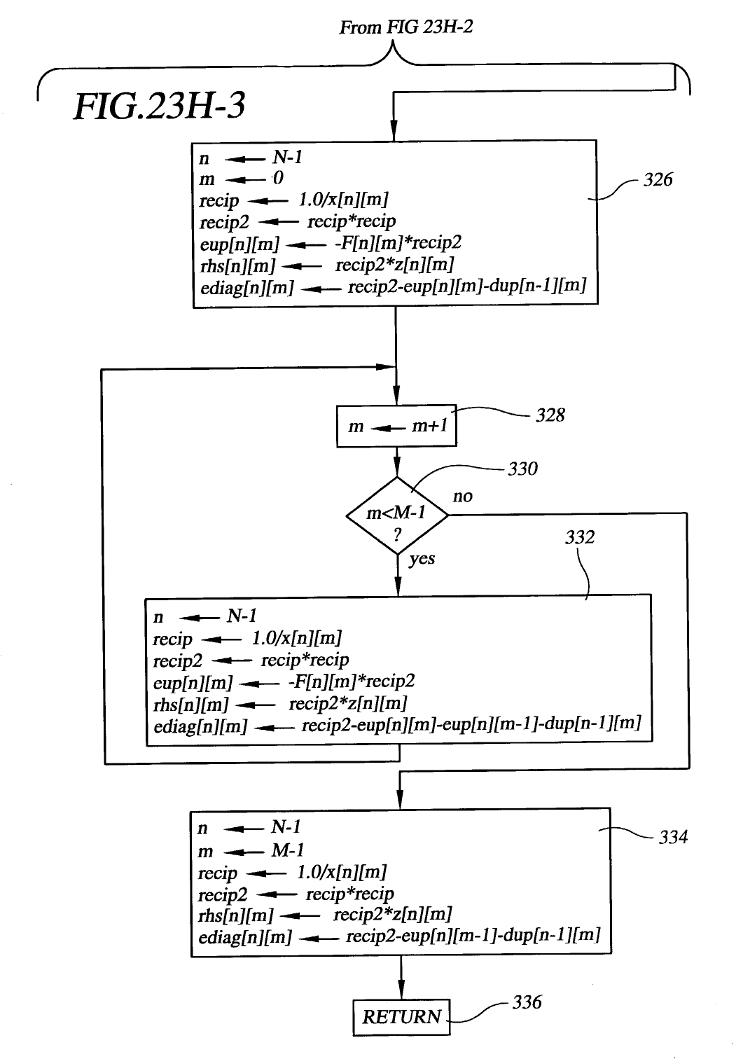

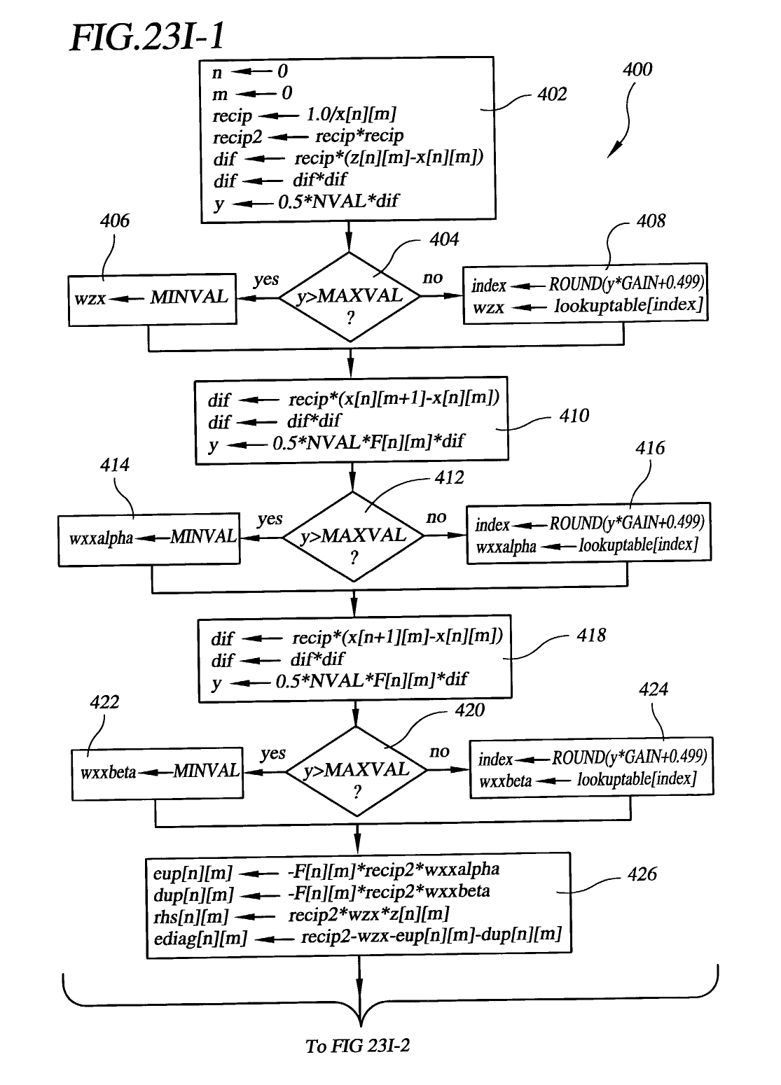

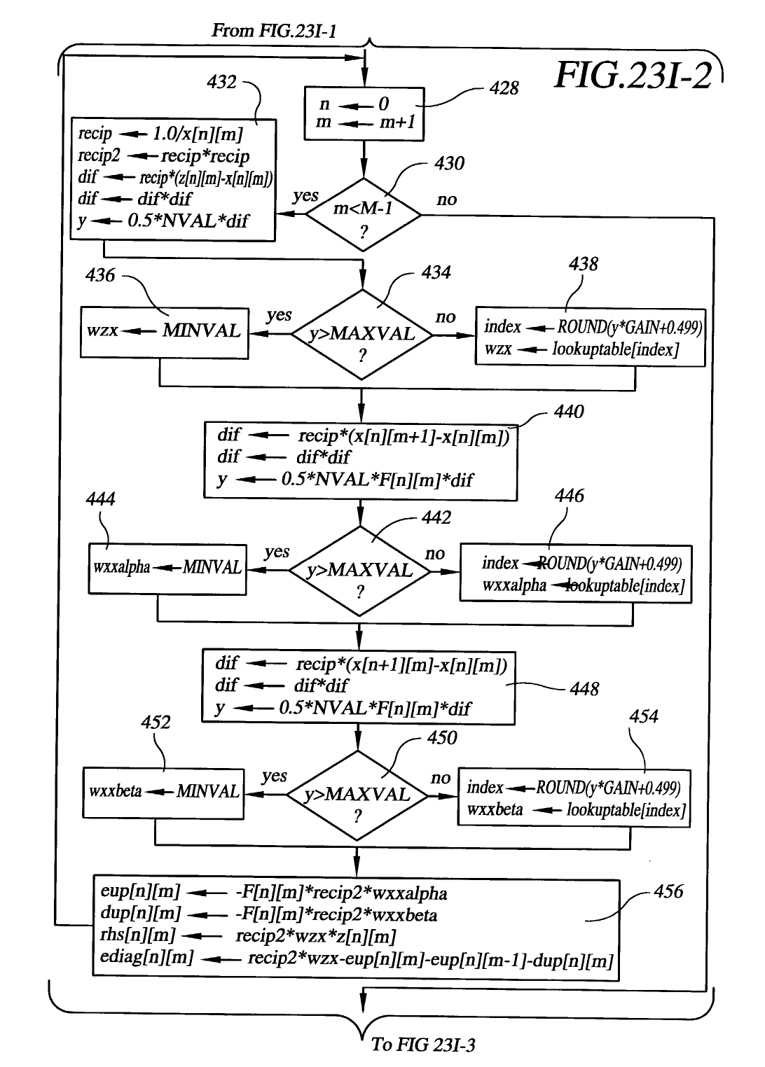

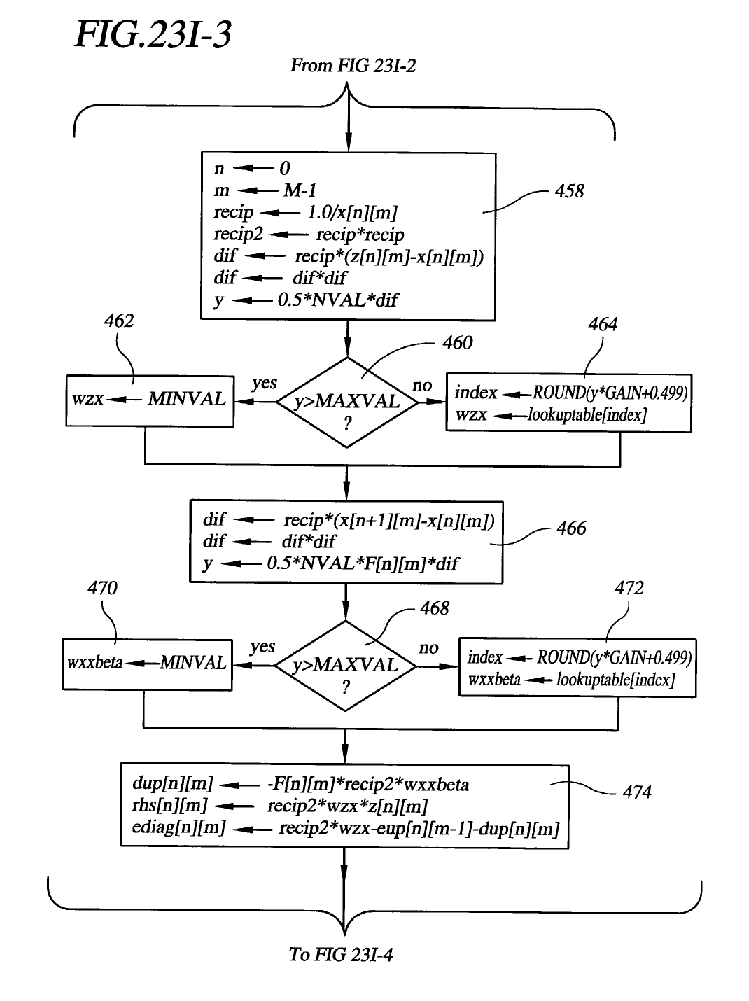

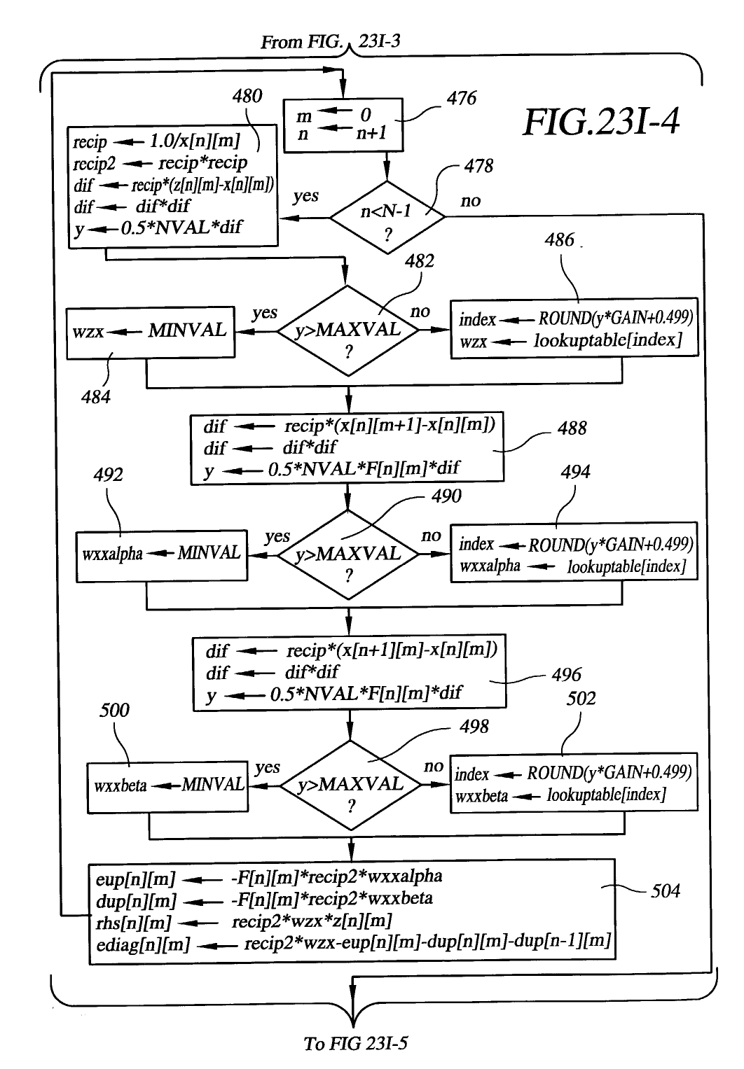

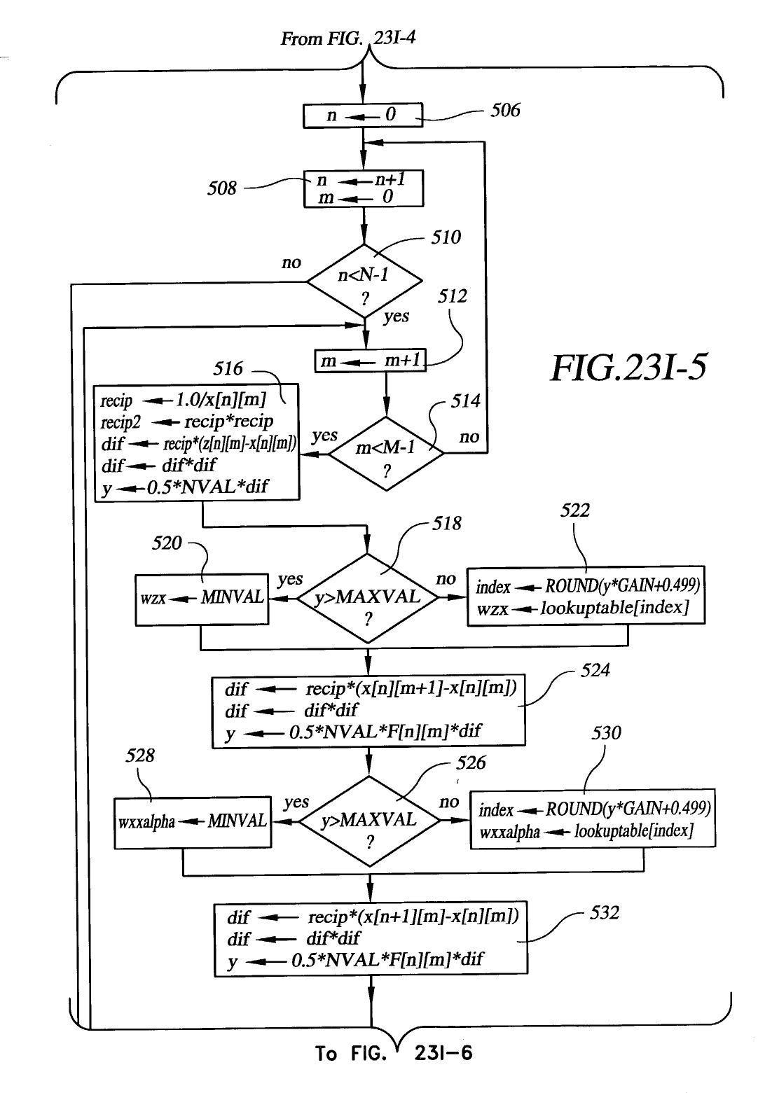

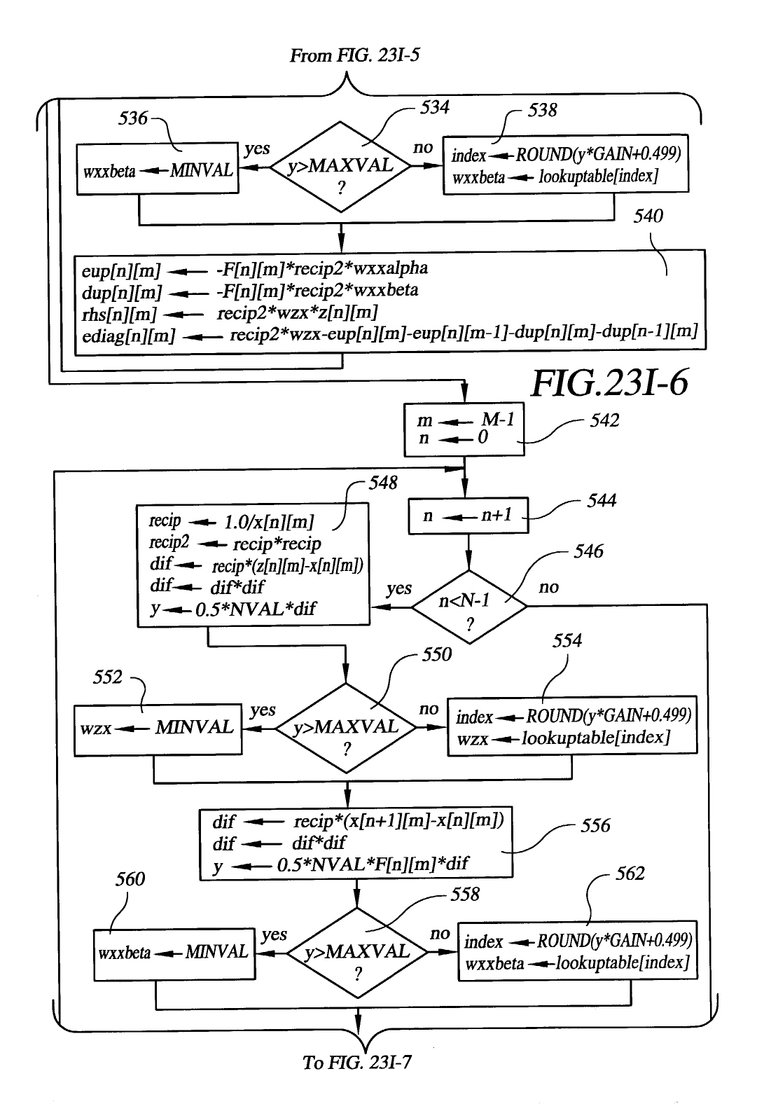

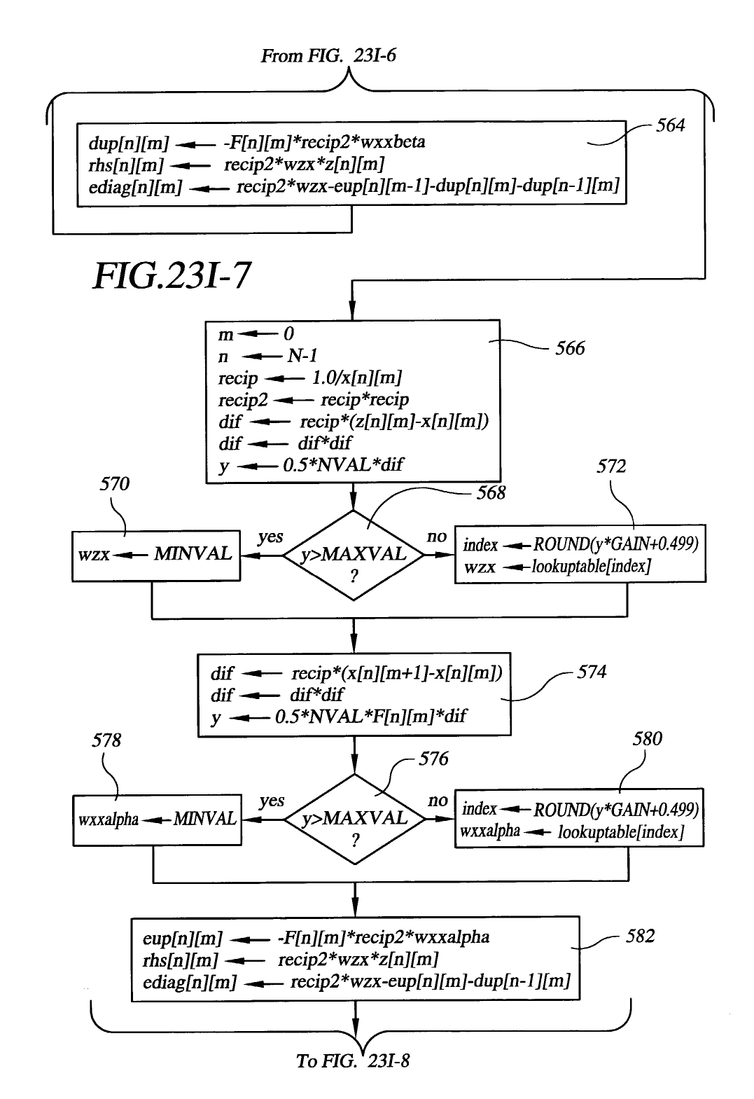

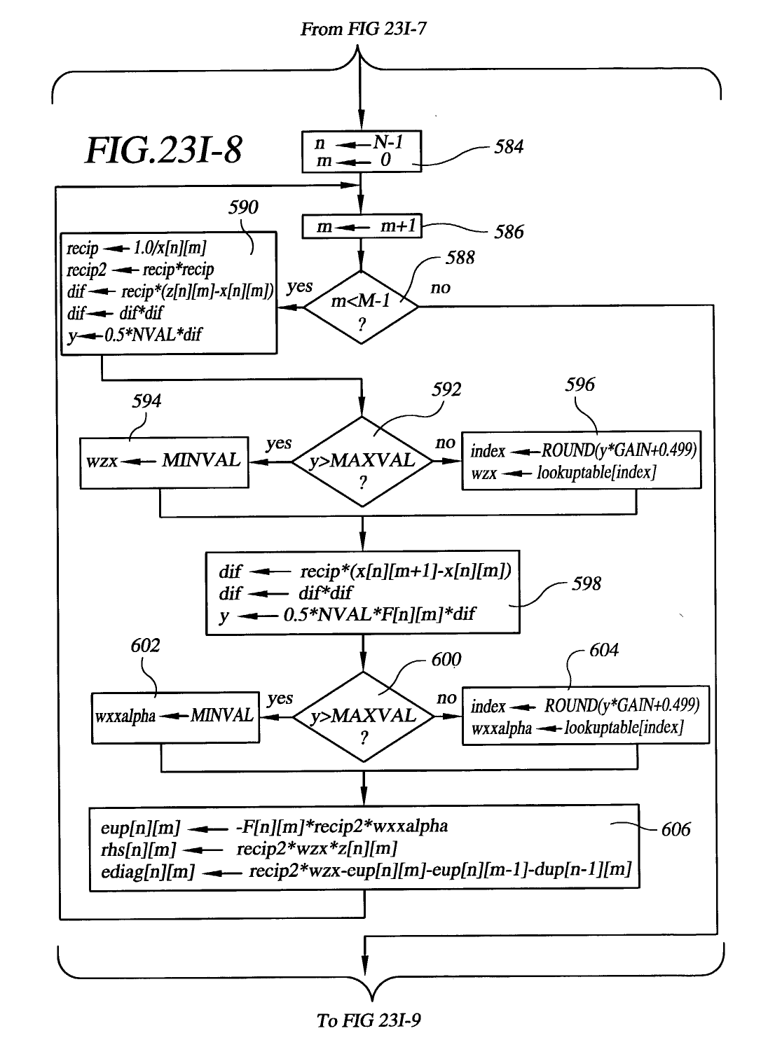

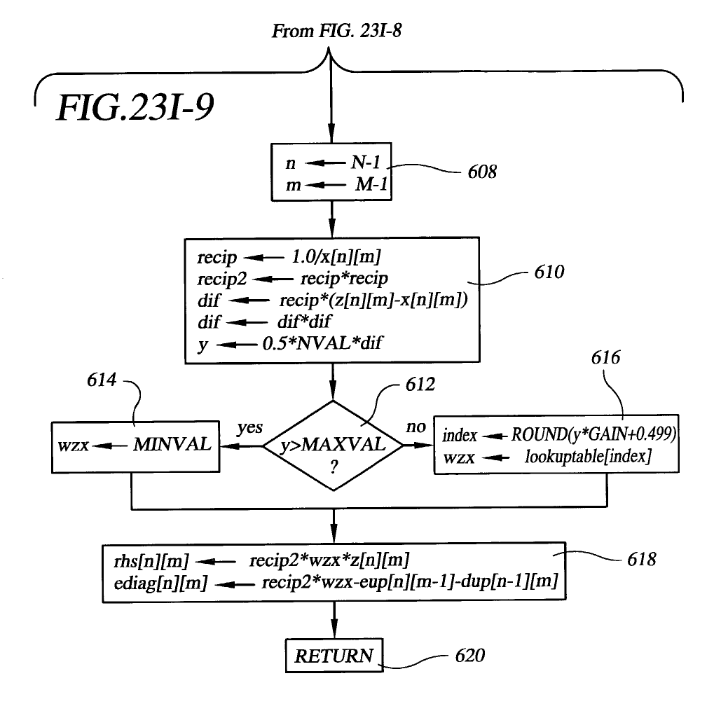

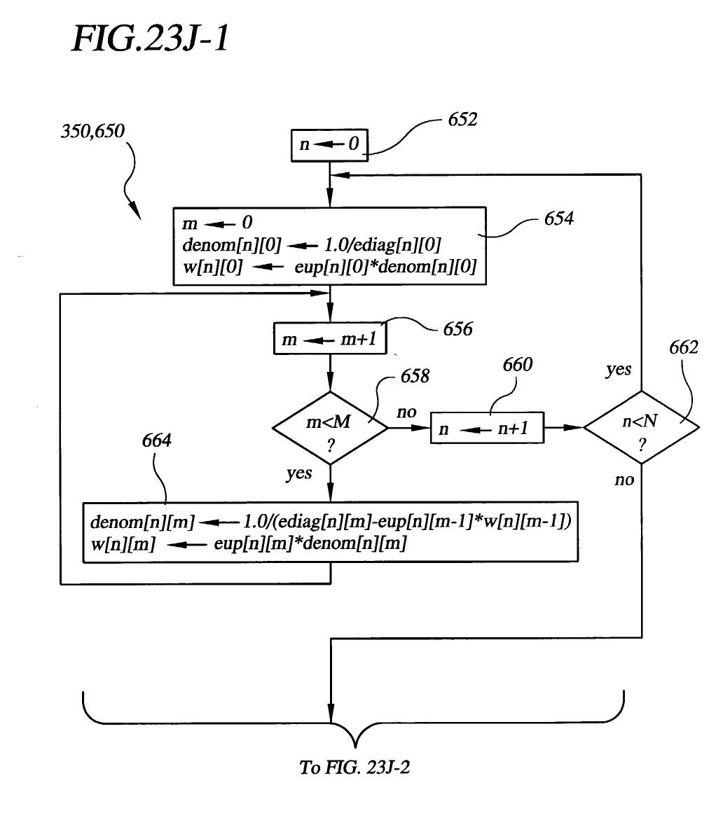

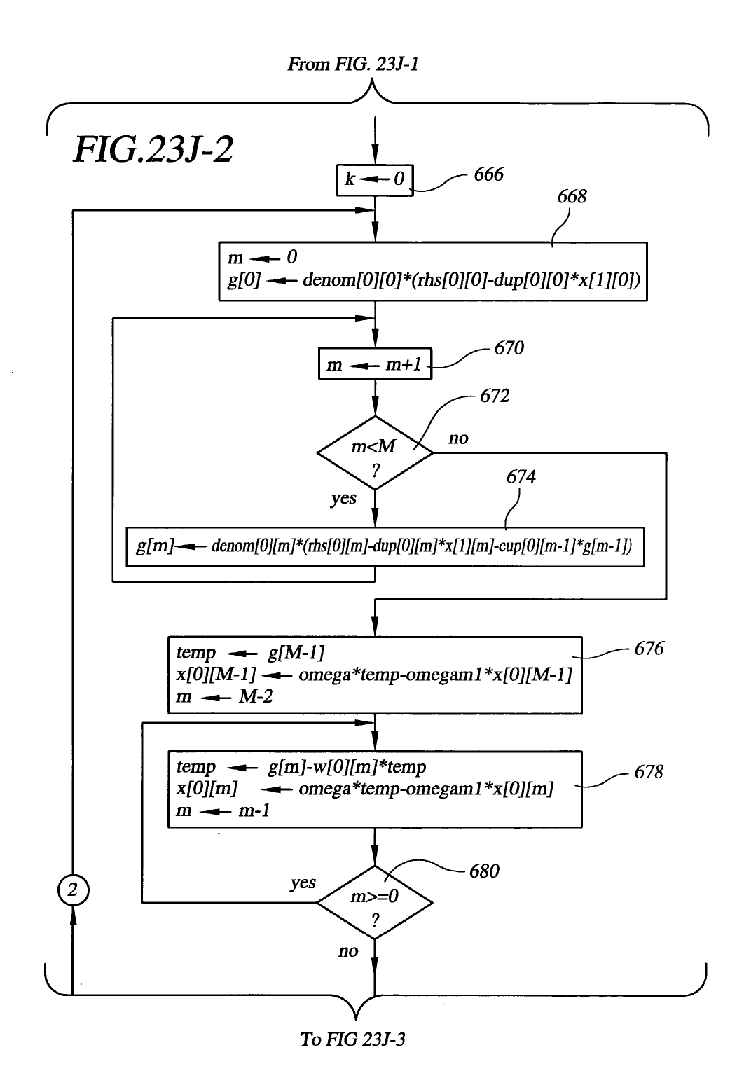

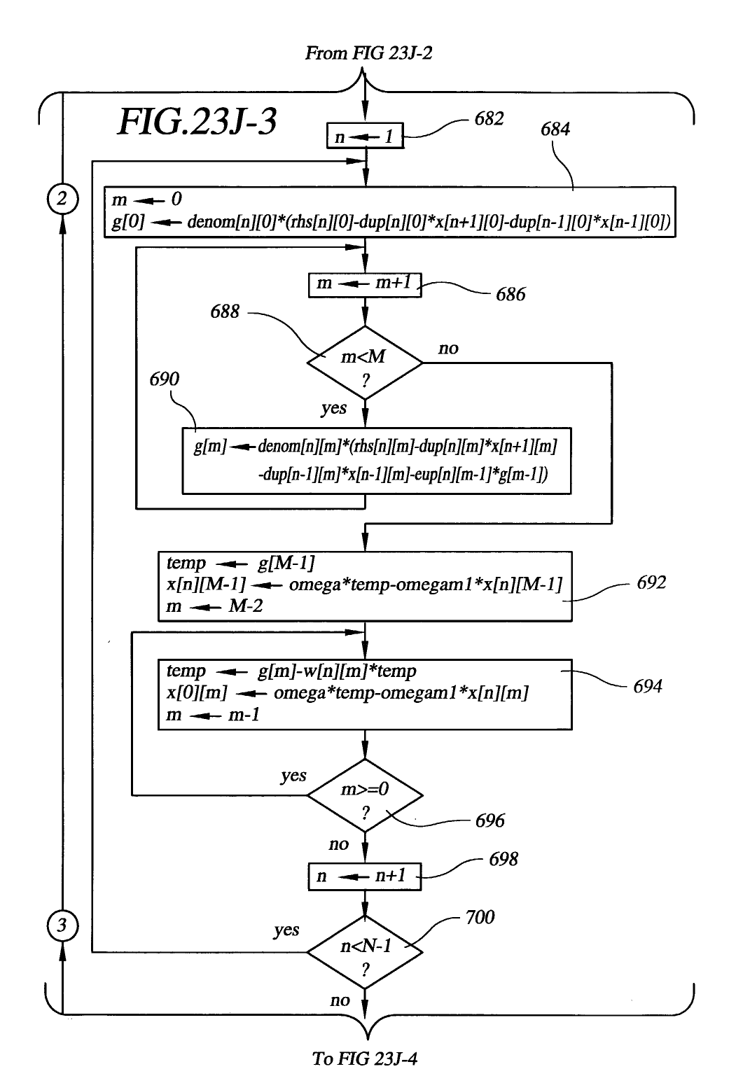

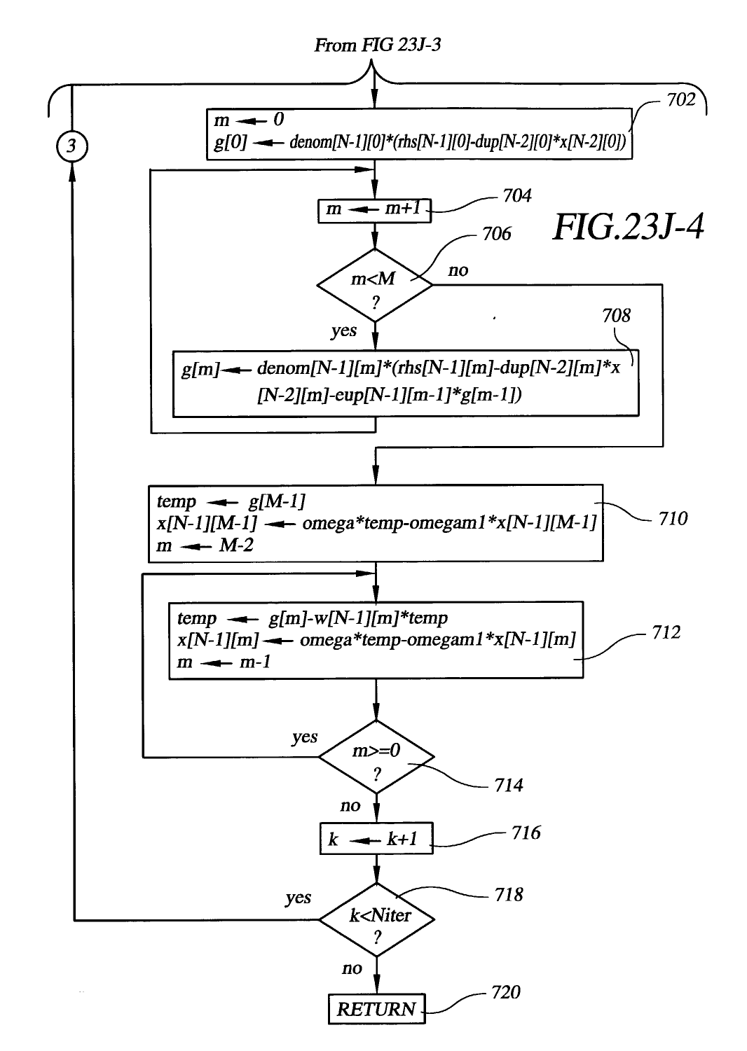

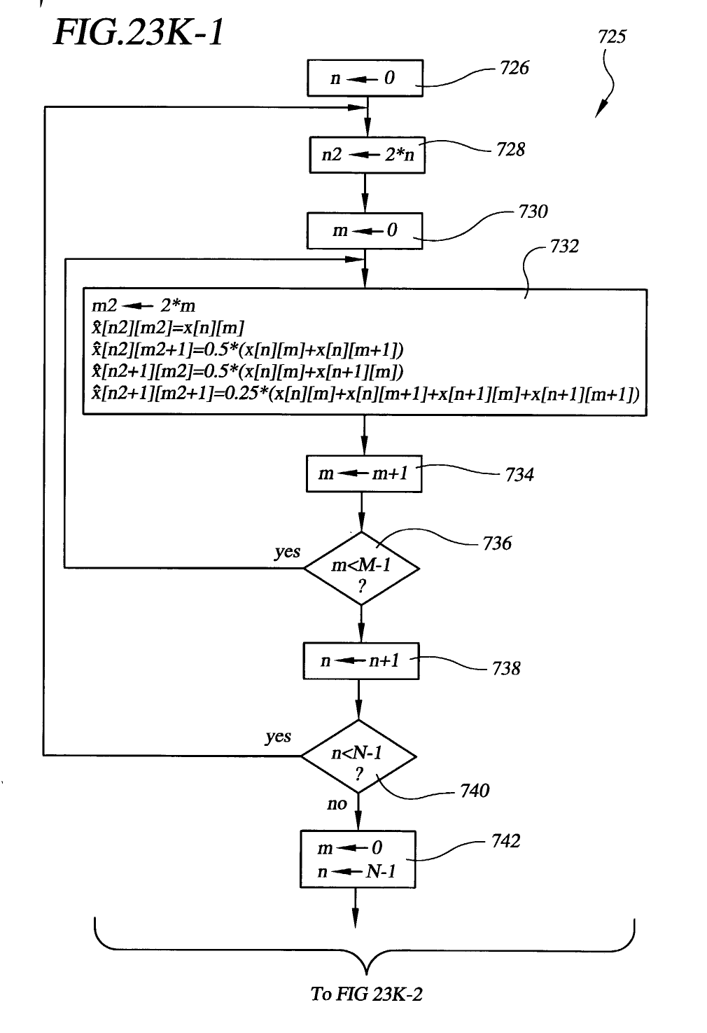

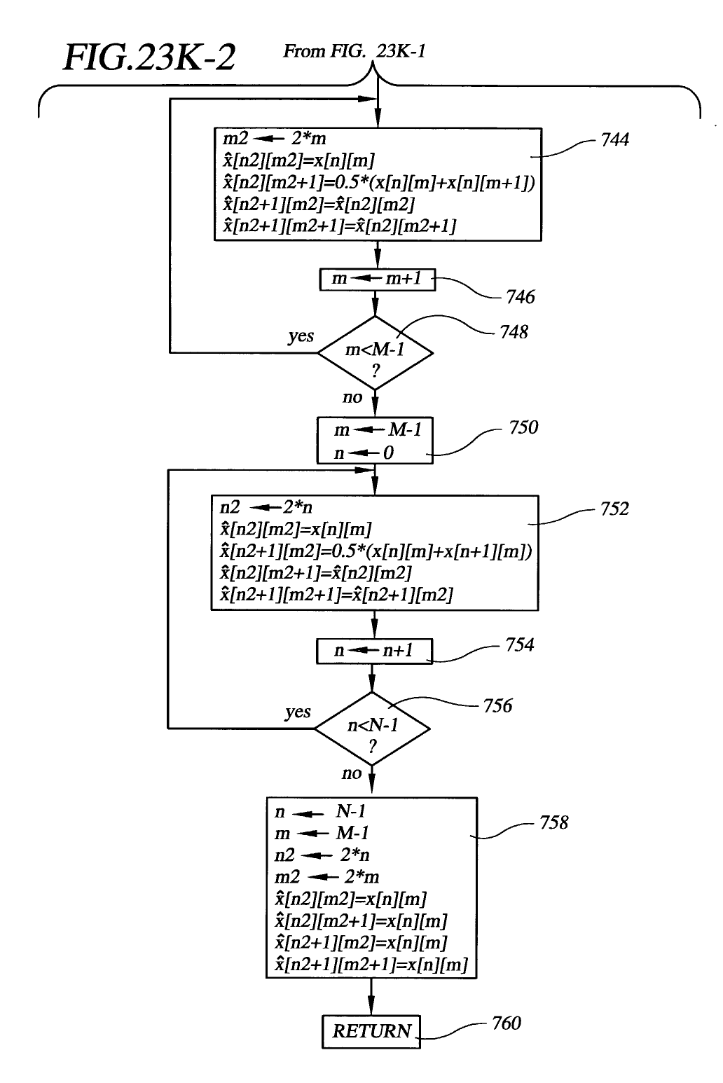

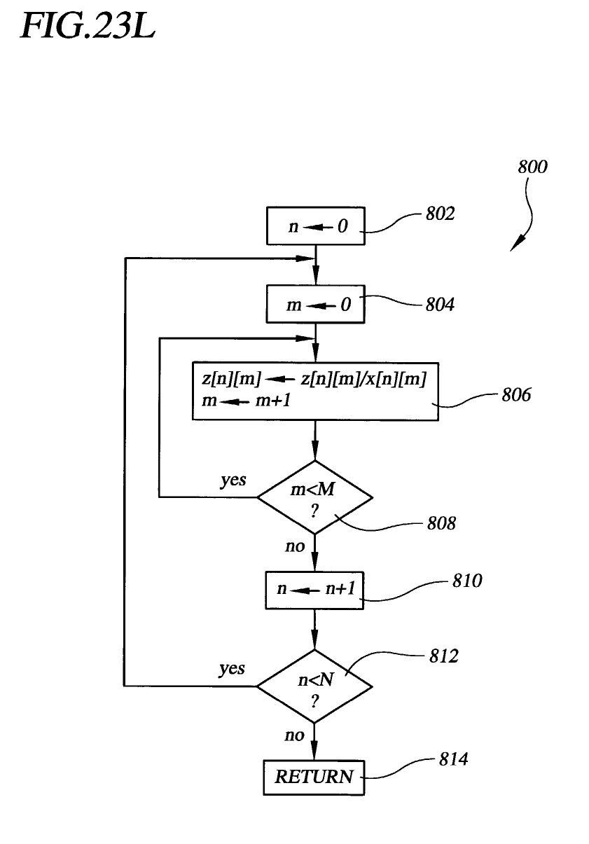

Referring then also to FIG. 23A, in a first processing task, parameter initialization 52 is carried out for analyzing the input data and the various expressions required for producing pdf mean estimates and data normalization. The two dimensions of the data set under consideration, e.g., the X direction of data elements in the data set and the Y direction data elements in the data set, are tracked with separate variables, N and M; e.g., the number of rows of data elements is stored in the N variable and the number of columns of data elements is stored in the M variable.

A variable NVAL is defined as an integer associated with the probability density function (pdf) of the measurement model to be employed in the MAP estimation expression. This is specified by the user based on prior knowledge of the statistics of the data, as described above. The performance of the pdf mean estimation technique of the invention is relatively insensitive to the exact value of this parameter, and thus complete knowledge of the statistics of a given data set is not required.

Fval is a default smoothness value defined in both of the data set dimensions and employed in solving the estimation expression unless otherwise specified. While as explained above, the estimation expressions allows for different values of smoothness to be specified for the X and Y dimensions, in most applications the physics of the data are typically the same in both dimensions, whereby there is no need for the two smoothness values to be different. To make this distinction more precise, consider the two data sets of an optical image and a transmission X-ray mammogram. In both cases the physics is the same in both dimensions; the optical image pixel values represent the amount of light scattered from the image object to the imaging system, and the transmission X-ray mammogram pixel values represent the amount of X-ray energy that has transited breast tissue. In both cases the physics is unchanged from one dimension to the other.

Now contrast these cases with the use of the estimation technique with sonar data. Here the horizontal, or X dimension is the Fourier transform of a sampled time series of acoustical energy. The vertical, or Y dimension, represents time epochs of these Fourier transformed samples. In this specialized application, the underlying physics of the data can be very different. As a result, for such an application, it is preferred to apply different values of smoothness in the two dimensions of the data element array. For example, the size of data characteristics, or features, of the data set in each dimension of the data set and that are of interest to the user can be used to determine corresponding appropriate values of smoothness for each dimension.

Fsmall is a parameter initialized to be the value of smoothness employed for data elements that are found to lie on slopes of data values; as described below, detection of such slopes is enabled by the process of the invention. The Fsmall parameter can for most applications preferably be initialized to a small value of smoothness, e.g., 1/2 or 1. This allows the pdf mean estimates of the data set to follow the data values closely in regions of large transition in value that are identified by the slope detection method described below. In order to make a smooth transition between the large default smoothness value and this small value to be employed at slopes of data values, an array of intermediate smoothness values, Ftrans, is preferably employed. The use of this array of smoothness values prohibits the pdf mean estimates from developing value “kinks” that could introduce unwanted artifacts into a data set to be normalized by the estimates. In the initialization task 52 of FIG. 23A, an example Ftrans array size of four is indicated, but a larger transition window can be introduced if such is warranted.

The variable HALFSLOPE is defined and initialized as half the size of the examination window that will be imposed on the data set to enable slope detection in the manner described below. Said more precisely, when performing slope detection in the X direction at a data element indexed as n, m, information from those data elements that fall between indices n,m-HALFSLOPE and n,m+HALFSLOPE are considered. Thus, the window size is given as 2*HALFSLOPE+1.

The variable SLOPETHRESHOLD is defined and initialized as an integer value. SLOPETHRESHOLD is the number of successive differences of the data element values in the slope detection window that must have the same sign in order to declare a slope detection. An example will make this clearer. Suppose HALFSLOPE is taken to be 10 and the SLOPETHRESHOLD is taken to be 18. 20 successive differences are computed as x[n][m+k-HALFSLOPE+1]-x[n][m+k-HALFSLOPE] where k runs from 0 to 2*HALFSLOPE-1. If 18 or more of these differences are positive or if 18 or more of these differences are negative, then a slope direction in the X direction is declared. A similar example would hold true for slope detections in the Y direction where the window would now be over the n index.

The variable threshold is defined and initialized for slope detection as well. Before the above-described slope detection is performed, a simple difference is preferably taken between the data element values at the edges of the defined slope detection window. If the absolute value of this difference, fabs(x [n][m+HALFSLOPE]-x[n][m-HALFSLOPE])/(2*HALFSLOPE+1) divided by the number of pixels in the window exceeds the value of the threshold variable, then a possible slope is declared and the window is sent on to do the additional further slope test described previously.

The 25 element array, e[25], is defined and initialized to hold the coefficients that will be employed for an initial step of block averaging the data element values, if such averaging is to be carried out for a given application. This averaging can be carried out in one dimension or in two dimensions as explained previously. In an example of two-dimensional averaging, a sliding weighted block average is carried out on successive 5×5 blocks, or groups, of data element values in the data set. The N by M array ediag[N][M] is defined and initialized to hold the diagonal elements of the system matrix as the pdf mean estimates are produced. The N by M array eup [N][M] is defined and initialized used to hold the off-diagonal elements of the block diagonal submatrices of the system matrix. The N by M array dup [N][M] is defined and initialized to hold the diagonal elements of the off block diagonal submatrices of the system matrix. The N by M array F[N][M] is defined and initialized to hold the smoothness values for the data elements. For most data elements, this will be the value Fval, as explained above. However, those data elements which are found to be on slopes of data values will be assigned the value of the smoothness parameter Fsmall and their neighboring data elements will be assigned corresponding smoothness values from the smoothness value array Ftrans.

The array lookuptable is defined and initialized to hold precomputed values of the w-functions employed to solve the estimation expressions in the manner described above. This enables a degree of processing efficiency by eliminating the need to compute transcendental functions for every data set that is processed. The N by M array x[N][M] is defined and initialized to hold the pdf mean estimates of the data elements. The N by M array z[N][A] is defined and initialized to hold the data set element values themselves. It is assumed that this is single precision floating point. The data set can be presented in any of a range of formats of data, such as integer counts. It is assumed that the conversion from the presented data set format to single precision floating point is carried out prior to the initialization step.

FIG. 23B defines the steps in a next initialization process step, namely, generation 54 of a lookup table for the w-functions of the estimation expressions. In a first step 56, the probability of a data element value being far from the mean of its pdf, Pₛ, the probability of a discontinuity in data element values occurring in the X direction of the data set, P_{d},and the probability of a discontinuity in data element values occurring in the Y direction of the data set, P_{d}_{_{y}}, are all initialized as equal to, e.g., 0.5. The extent across data elements of data values far from pdf means, Δ, the discontinuity extent, Δₓ, for the X dimension, and the discontinuity extent, Δ_{y}, for the Y dimension, are all set equal to, e.g., 3.0. This implies that the constant C is the same for each type of w-function, and with the example values chosen is equal to 0.8355.

The size of the lookup table is 3001 and this value is stored as the parameter TABLETOP. The increment size chosen for the table is 0.005 and the reciprocal of this is 200.0, which is stored as the parameter GAIN. The maximum value that the table can be applied to is thus 3000/200=15.0. This value is stored as the parameter MAXVAL. The minimum value that the table will contain is then given by

$$\frac{{ⅇ}^{- 15.0}}{{ⅇ}^{- 15} + C} = 3.661 * {10}^{- 7} ,$$

and this value is stored as the parameter MINVAL. This serves as a clipping value to prevent single precision underflow. Finally, the loop variable n is initialized to 0.

The production of the look-up table proceeds as follows. In a first step 58, the exponential of -n divided by the value of the parameter GAIN is computed and stored as the parameter expoval. The w-function for this value is then computed by dividing the parameter value for expoval by the parameter value for expoval+C and this is stored in the array loopuptable at index n. The loop counter variable is then incremented 60 and compared 62 to the size of the table. If it is less than the value of the parameter TABLETOP, then the loop continues. The table is filled in this way until the value of the parameter n equals the value of the parameter TABLETOP, at which point the loop terminates and the function returns 64.

In a next process task, referring to FIG. 23C, the data set is optionally scaled 70 by its global mean. For many applications, an initial scaling by a global mean can be advantageous for improving process efficiency. In a first step 72 of this task, a variable sum and the index n are set equal to 0. The index m is the set equal 74 to zero. Then the value of the data element indexed by n and m, z[n][m], is added 76 to the value of the parameter sum and the index m is incremented. This incremented value is then compared 78 with the dimensional limit M.

If the current value of m is less than the value of M, then the loop continues; if the current value of m is equal to the value of M, then the loop ends and the value of the index parameter n is incremented 80 and compared 82 to the other dimensional limit N. If the current value of n is less than the value of N, then processing loops back by resetting 74 the value of the index m to zero and the processing loop over that value of the index m is begun again. If the current value of the index n is equal to the dimensional limit value of N then the two nested loops end and the value of the parameter sum is divided 84 by the product of N and M to produce the value of the mean of the data which is stored in variable mean; with the index n is then being reset to zero.

Next the index m is reset 86 to zero. Then a loop over the index value m is begun, and the value of the data element that is indexed by the current values of n and m, z[n][m], is divided 88 by the value of the parameter mean, with the result is stored back at location z[n][m]. The value of the index m is then incremented and compared 90 to the dimensional limit value M. If the current value of index m is less than the limit value M, then the loop continues with the new value of m. If the current index value m is equal to the dimensional limit M, then the loop terminates. Here the index n is then incremented 92 and compared 94 with the dimensional limit value N. If the current value of the index n is less than N, then processing begins again by resetting 74 the index value m to zero and the process loop over the value of m is begun anew. If the current value of the index n equals the dimensional limit value N, then the outer loop over the value of n is terminated and the function is returned 96.

Referring back to FIG. 22, in a first step of the two-dimensional pdf mean estimation and data set normalization process 50, one or two-dimensional block averaging 100 can optionally be carried out to reduce the computational requirements of the pdf estimation steps. FIG. 23D provides the steps of this task 100, here specifically implemented as a two-dimensional averaging process.

Given that two-dimensional block to be applied for determining data element average values is here as an example given as size 5 by 5 data elements, then the boundaries of the data set of elements, which are 2 data elements wide, must be treated separately. For the sake of simplicity it can be preferred that the values of the initializer, x[n][m], be equal to the data values, z[n][m], along these boundary data elements. The averages for all of the interior data elements, which do not lie on these boundaries, are determined by taking a 5 by 5 block window that multiplies the data element values lying in the window by the coefficients stored in the array initialized array e. The e array is preferably provided with weights that sum to unity to therefor enable an unbiased estimator of the data element pdf means.

The outer boundary of the block window is given by the array elements, e[0], e[1], e[2, e[3], e[4], e[5], e[9], e[10], e[14], e[15], e[19], e[20], e[21], e[22], e[23], and e[24]. These all are given the value of, e.g., 0.03. The inner boundary of the block window is given by the array elements e [6], e [7], e[8], e[11], e[13], e[16], e[17], and e[18]. These inner boundary elements are given a value of, e.g., 0.05. The data element in the middle of the block is the one for which an average determined, and therefore is weighted by the value of the element e[12]. This element is given a value of, e.g., 0.12.

The data element averaging process 100 is begun by initializing 102 the value of the index m to zero. Then the four boundary data elements, x[0][m], x[1][m], x[N−2][m], and x[N−1][m] of the initializer array are set equal 104 to their corresponding data elements values, z[0][m], z[1][m], z[N−2][m], and z[N−1][m]. The value of the index m is incremented and then compared 106 to the value dimension limit value M. If the current value of the index m is less than the value of M, then the loop continues with the newly incremented value of the index m at step 104. If the value of the index m is equal to the value of M, then the loop terminates.

Here the other index n is then initialized 108 to 2 because all the boundary data elements for n=0 and 1 have already been computed. The boundary pixels x[n][0], x[n][1], x[n][M−2], x[n][M−1] of the initial are the set equal 110 to their corresponding data element values z[n][0], z[n][1], z[n][M−2], and z[n][M−1]. The value of the index m is reset to 2 and then the full block averaging 112 is performed on the data values. This is indicated by the multiplication of the array elements e as described above with the data array element values indexed from n−2 to n+2 and m−2 to m+2. The result of this two-dimensional averaging is stored in the initializer data element that is indexed by the current values of the indices n and m.

The value of the index m is then incremented and compared 114 to a value corresponding to M−2, given that the two data element-wide boundary elements have already been considered. If the incremented value of the index m is less than M−2 the loop continues. But if the value of the index m is equal to M−2, then the loop terminates. Here the current value of the index n is incremented 116 and compared 118 to the value of N−2. If the incremented value of the index n is less than N−2 then the outer processing loop is resumed and to determine 110 average values for the four boundary data elements, and then the value of the index m is reset to 2 and averaging 112 of the interior data elements is completed. If the incremented value of the index n is equal to N−2, then the outer processing loop is terminated and the function is returned 120.

Referring back to the flow diagram of FIG. 22, as explained above, a slope detection process 125 can be carried out in accordance with the invention if such is beneficial for a given application for specifying region-specific smoothness parameter values. If slope detection is to be carried out, then the data set element values Z are employed in the slope detection process. Alternatively, as shown in the diagram, if a block averaging process 100 is first to be carried out for a given application, then the output of that averaging process, X⁽⁰⁾, is employed in the slope detection process.

FIG. 23E provides a flow diagram of the tasks in carrying out slope detection 130 in a first direction, e.g., the X direction, of a two-dimensional data element array. This X-direction slope detection process 130 is employed in the overall slope detection for the data set array as described below. This X direction slope detection process determines acceptable regions of slope in the change of data values across a sequence of data elements in the X direction of the data set. The process thereby produces a Boolean variable SlopeYes which is given as true if the examination window of data elements contains an acceptable slope, and is given as false if it does not.

The X-direction process is begun defining and initializing 132 variables CountUp and CountDown to zero. The variable SlopeYes is initially set to false. The index k is set equal to zero. With this initialization complete, the mathematical difference is determined 134 between the data values of adjacent data elements that are indexed as k+m+1-HALFSLOPE and k+m-HALFSLOPE as the column index and having the same row index value, n. If the data value difference is positive, then the variable CountUp is incremented 136, while if the difference is negative the variable CountDown is incremented 138.

The value of the index k is then incremented 140 and compared 142 to 2*HALFSLOPE. If the incremented value of the index k is less than 2*HALFSLOPE, then the current window of data elements has not been fully analyzed, and more successive differences are computed and compared 134. If the value of the index k is equal to 2*HALFSLOPE then the processing loop is terminated because the current window of data elements has been fully examined. The variables CountUp and CountDown are then compared 144 with an integer threshold parameter, SLOPETHRESHOLD. If either one is greater than the specified value for SLOPETHRESHOLD then SlopeYes is set 146 to a value of true. The variable SlopeYes is then returned 148 being false if no slope was detected and true if a slope was detected.

A similar slope detection process is also to be carried out in the second dimension of the data set array, e.g., the Y direction. FIG. 23F provides a flow diagram of the tasks for carrying out Y-direction slope detection 150. This Y-direction slope detection processing is very similar to that of the X-direction and thus is not described here explicitly; FIG. 23F provides each task of the process in detail. Note that the Y direction slope detection process successive differences are computed 154 in data values between adjacent data elements that are indexed by k+n+1-HALFSLOPE and k+n-HALFSLOPE as a row index and that have the same column index value, m. Again those differences are accumulated 156, 158 in the counters CountUp and CountDown. These counter values are compared 164 to the integer threshold value specified for the parameter SLOPETHRESHOLD, and if either is greater than the value of SLOPETHRESHOLD then SlopeYes is set 166 to a value of true. The variable SlopeYes is then returned 166, being false if no slope was detected and true if a slope was detected.

Tasks for carrying out a full slope detection process 170 are provided in the flow diagram of FIG. 23G. This process employs the X direction slope detection process 130 of FIG. 23E and the Y direction slope detection process 150 of FIG. 23F. Because the process is specified to operate on a window of data elements of size 2*HALFSLOPE+1, the boundary data elements of the two-dimensional data set array are not slope-detected.

The process is begun by initializing 172 the value of the index parameter, n to the value of HALFSLOPE. The index parameter m is then initialized 174 to the value of HALFSLOPE. Two variables gradx and grady are then initialized and set equal 176 to the values (x[n][m+HALFSLOPE]-x[n][m-HALFSLOPE])/(2*HALFSLOPE+1), and to (x[n+HALFSLOPE]-x[n-HALFSLOPE])/(2*HALFSLOPE+1), respectively. Both values are then compared 178 to the threshold value threshold. If either exceeds the value of threshold then a comparison 180 of gradx is made to the value of threshold to see if there is a defined data value slope in the X direction. If gradx does exceed the value of threshold then the SlopeDetectX process 130 of FIG. 23E is carried out. If the SlopeDetectX process returns a value of true 184 then a slope detection in data values is declared and the smoothness parameter value for the current data element, having the current n and m index values, as well as the four nearest neighbor data elements in the X direction, having indices of n,m+1, n,m+2, n,m−1, and n,m−2, are set 186 equal to the specified small smoothness value Fsmall.

To make a smooth transition between the small smoothness parameter value Fsmall and the larger default smoothness value Fual, a transition region of data elements having indices given as n,m+3, n,m+4, n,m+5, n,m+6, n,m−3, n,m−4, n,m−5, and n,m−6 is defined, and the data values of those elements are set at intermediate values between the two extremes. This prevents the production of an abrupt change in pdf mean estimates for those data elements; such could introduce unwanted anomalies if the data set were to be normalized by the pdf mean estimates. Each data element has an associated smoothness parameter value that is compared 188, 192, 196, 200, 204, 208, 212, 216 to a transition value Ftrans. The smoothness value of each data element in the transition region is then set 190, 194, 198, 202, 206, 210, 214, 218 to the smaller of the two values based on the comparison. This comparison is required because the transition data elements may themselves have already been determined to be part of a data value slope and thus already been assigned a small smoothness value.

In a next process step, the value of the variable grady is compared 220 to the value of the parameter threshold. If the grady value exceeds the threshold value, then the Y direction slope detection process, SlopeDetectY 150, of FIG. 23F, is carried out to determine is there is a significant slope in data values in the Y direction of the data array. If the SlopeDetectY process produces 224 a true value, then a slope detection in the Y direction is declared and the smoothness value for the current data element, indexed by the current values of n and m, as well as its four nearest neighbor data elements in the Y direction, having index values of n+1,m, n+2,m, n−1,m, n−2,m, are set 226 equal to a small smoothness value Fsmall.

Just as in with the X direction processing, a transition region of data elements is then defined, indexed in the manner just described for the X direction case but here based on the value of the index n and not m. Each transition data element is compared 228, 232, 236, 240, 244, 248, 252, 256 to a transition value and based on the comparison, is assigned 230, 234, 238, 242, 246, 250, 254, 258 a transition value for that data element's smoothness parameter.

With this smoothness parameter assignment complete, the value of the index m is incremented 260 and compared 262 to the value of M-HALFSLOPE-1. If the index value m is less than this value, then the slope detection process continues 176. If the value of the index m is equal to M-HALFSLOPE-1 then the X direction processing is terminated. The value of the index n is then incremented 264 and compared 266 to the value of N-HALFSLOPE-1. If the index value n is less than this value, then the processing of the Y direction slope detection, over index n continues with the value of the index m being reset 174 to the value of HALFSLOPE, and the slope detection process then continuing for the new values of the indices n and m. If the value of the index n is equal to N-HALFSLOPE-1 then the X direction and the Y direction slope detection processes are both complete and the assigned data element smoothness parameters can be returned 268.

If this optional slope detection process is not carried out, then the data elements are all assigned the default smoothness parameter value or another selected value. Alternatively, as explained above, a first smoothness value can be specified for the X direction of the data set and a second smoothness value specified for the Y direction of the data set. Other logic for imposing smoothness parameter values can also be employed if desired.

Referring back to the flow diagram of FIG. 22, with slope detection and smoothness parameter assignment complete, the pdf mean estimation process for each data element value is begun. Here a system matrix, e.g., a MAP expression matrix, is formed 300 for enabling a first iteration solution of the nonlinear pdf mean estimation expressions. As explained previously, and as shown in the flow diagram, to enable this first iteration, the values of the data element pdf means are initially designated as the data element values themselves, or if block averaging of data element values was carried out, then the data element pdf means are initially designated as the averaged data element values.

Also as explained previously, for the first iteration solution of the estimation expressions, the smoothness parameters assigned from the previous step are imposed, but the probability parameters accounting for large data values, discontinuities of data values in the X direction, and discontinuities of data values in the Y direction, Pₛ, P_{d}_{ₓ}, and P_{d}_{_{y}}. are all set equal to zero. This results in the corresponding w-functions all being equal to unity for this first iteration processing step.

The formation of system expression matrix is relatively straight forward; the only complication is presented by the boundary data elements, which must be treated separately. The reason for this is that the general expression for non-boundary elements contains terms like eup[n][m−1] and dup [n−1][m] which of course don't exist for the data set indices m=0 or n=0. Likewise for data elements having index values of m=M−1 or n=N−1, the terms eup[n][m] and dup[n][m], respectively, don't exist. Thus in addition to the general case there are eight separate boundary cases that have to be treated. The order in which these boundary cases are treated is important to ensure that required terms are defined when needed for other cases.

FIG. 23H provides a description of the tasks of the process of forming 300 a system matrix, A, for a first iteration of pdf mean estimation processing. This diagram specifically provides processing details for the three cases of index values where n=0 and m is set to m=0,0<m<M−1, and m=M−1. In a first step, the values of the indices n and m are set 302 equal to zero. Also in this step, the variable recip is initialized with a value of the inverse of x[n][m] where at this point in the processing x[n][m] has a value that is the corresponding data element value z[n][m]. or is the output of the block averaging of the input data.

Also in this step, the value of recip is squared and stored as the variable recip2. The storage locations eup[n][m] and dup[n][m] both are initialized with a value −F[n][m]*recip2. Note that this is for a particular example in which the same value of smoothness parameter has been imposed in the X and Y directions of the data set. In the general case two different values can be employed for the smoothness parameters, as explained above. The storage location which holds the values for the right hand side of the system equations is defined as rhs[n][m] and is initialized with the value recip2*z[n][m]. Finally, the storage locations that hold the diagonal elements of the system matrix, ediag[n][m], are initialized with a value recip2-eup[n][m]-dup[n][m].

At this point the value of the index m is incremented 304 and then compared 306 to the value of M−1. If the value of the index m is less than M−1 then processing is continued over a loop in index m, to again computes 308 the value recip and its square recip2. The values of the storage locations eup[n][m], dup[n][m], and rhs[n][m] are here then assigned corresponding values, in the manner given for the step above. But in the current step, the value of the index m is greater than zero and so the term eup[n][m−1] is defined. As a result, the term ediag[n][m] is assigned a value of recip2-eup[n][m]-eup[n][m−1]-dup[n][m].

If the comparison 306 indicates that the value of the index m equals M−1, then the processing loop is terminated and the third boundary case of n=0 and m=M−1 is addressed 310. Here the term eup[n][m] does not exist and therefore is not calculated. The storage locations are populated as given above, with a difference that in this case the ediag[n][m] element is now given by recip2-eup[n][m−-1]-dup[n][m].

In the next step, the value of the row index n is incremented 312, and then compared 314 to N−1. If the value of the row index n is less than N−1, then the value of the index m is reset 316 to zero. Also in this step, the variable recip is again set equal to the reciprocal of x[n][m] and this value is squared and stored in the variable recip2. The elements eup[n][m], dup[n][m], and rhs[n][m] are populated in the manner given above, but here the value dup[n−1][m] does now exist and so the element ediag[n][m] is set equal to the value recip2-eup[n][m]-dup[n][m]-dup[n−1[m].

In the next step, the value of the index m is incremented 318 and then compared 320 to M−1. If the value of the index m is less than M−1, then the matrix is populated 322 for the general case of interior data elements in the manner described above. Here ediag[n][m] is assigned the value of term recip2-eup[n][m]-eup[n][m−1]-dup[n][m]-dup[n−1][m]. If m is equal to M−1 then another set of boundary cases are addressed 324, specifically those data elements having an index m=M−1 and n satisfies 0<n<N−1. Here the matrix is populated as described above, but the term eup[n][m] does not exist and therefore is not calculated. The diagonal elements ediag[n][m] are assigned the values recip2-eup[n][m−1-dup[n][m]-dup[n−1[m]. Processing continues in this way until the value of the index n equals N−1.

When the value of the index n equals N−1, the three boundary cases of n=N−1 and m=0, 0<m<M−1, and m=M−1 are then addressed. Notice that for all three of the boundary cases for which n=N−1, dup[n][m] is not calculated because it does not exist, and only the term dup [n−1][m] is included in the diagonal terms ediag[n][m]. For the first case with m=0, the elements are populated 326 in the manner given above with ediag[n][m] given by the value recip2-eup[n][m]-dup[n−1[m]. For the more general case 0<m<M−1, the elements are similarly populated 332; here the term eup [n][m−1] exists and ediag[n][m] equals recip2-eup[n][m]-eup[n][m−1]-dup[n−1][m]. For the final boundary case where n=N−1 and m=M−1, neither eup[n][m] nor dup [n][m] exists and therefore are not calculated. The elements are here populated 334 in the manner given above, with the diagonal term ediag[n][m] given by recip2-eup[n][m−1]-dup[n−1][m]. With this population complete, the formation of a system matrix for a first iteration of pdf mean estimation is complete and thus returned, 336, ready for solving.

Turning back to the flow diagram of FIG. 22, in a next process step, the first iteration solution of the system matrix just formed is carried out 350. Before describing this solution process, there will first be described the process for forming the matrix expression to be solved for a second iteration solution of the system expression. The steps for producing each iteration of pdf mean estimation solution are the same, and therefore such will be described for clarity only after a description of matrix formation for a second iteration. In the current example, only two iterations of pdf mean estimation solution are employed, but as explained above additional iterations can be employed of desired for a given application.

The formation of the system matrix and right hand side of the system expression for a second pdf mean estimation solution iteration is considerably more complex than for the first iteration because the probability parameters are here assigned non-zero values, whereby the w-functions must be analyzed using the look up table formed during the first initialization process. However, matrix population of the boundary data elements having data set boundary indices is identical to that of the first iteration.

Turning to FIG. 23I, the formation 400 of the system matrix for a second iteration of pdf mean estimation solution is begun by addressing boundary data elements, with an assignment 402 of index values of n=0 and m=0. In this step, the variable recip is assigned a value of the reciprocal of x[n][m] which is then squared and stored as recip2. The variable dif is then defined and initialized to a value of recip*(z[n][m]-x[n][m]) which is then squared and stored as the value of the dif parameter. This value is then multiplied by NVAL and by 0.5 and stored as the variable y.

In a next processing step, the value of the variable y is then compared 404 to MAXVAL. If the value of the variable y is greater than MAXVAL then the clipping value MINVAL is stored 406 as the variable wzx. This clipping value is defined to prevent single precision floating point underflow. If the value of the variable y is not greater than MAXVAL then y is multiplied 408 by GAIN and 0.499 is added to this value and rounded to an integer, which is then stored as the variable index. The variable index is then used as an index into the array lookuptable, which holds the precomputed values of the w-functions. The value obtained from the table is then stored as wzx.

In a next step, the variable dif is then set 410 equal to recip*(x[n][m+1]-x[n][m]). This value is then squared and stored back into dif. This value is then multiplied by 0.5, NVAL, and the smoothness value F[n][m] and stored as the variable y. A comparison 412 of the value of the variable y is then again carried out with respect to MAXVAL, and the assignment steps 406, 408 then again carried out 414, 416, here with the resulting value is stored into the variable wxxalpha.

In a next step, the variable dif is then set 418 equal to recip*(x[n+1][m]-x[n][m]). This value is squared and then stored back as the variable dif. This value is then multiplied by 0.5, NVAL, and the smoothness value F[n][m] and stored as the variable y. A comparison 420 of the value of the variable y is then made again against MAXVAL as before. The assignment steps of 414, 416 are then again carried out, here 422, 424 with the resulting value stored as the variable wxxbeta.

Then, the value −F[n][m]*recip2*wxxalpha is stored 426 as the element eup[n][m]. Also in this step, the value −F[n][m]*recip2*wxxbeta is stored as dup[n][m]. The value recip2*wzx*z[n][m] is here stored as rhs[n][m]; and the diagonal element ediag[n][m] is assigned the value recip2*wzx-eup[n][m]-dup[n][m].

The processing then continues for the boundary cases of data elements have indices of n=0 and 0<m<M−1. The value of the index m is incremented 428 and then compared 430 to M−1. If value of the index m is less than M−1, then the processing continues 432 in a similar fashion 432 as described above. The values of wzx, wxxalpha, and wxxbeta are computed 436, 438, 444, 446, 452, 454 and then eup[n][m], dup [n][m], and rhs[n][m] are populated 456 as before. In this last step, the diagonal term ediag[n][m] here is assigned the value recip2*wzx-eup[n][m]-eup[n][m−1]-dup[n][m].

If at this point in the processing the comparison operation 430 proves the value of the index m to equal M−1 then the processing continues for the boundary data element having an index of n=0 and m=M−1. For this case the element eup[n][m] does not exist and so the term wxxalpha does not need to be calculated. The value of the variables wzx and wxxbeta are computed 462, 464, 470, 472 as before and the element values of dup[n][m] and rhs[n][m] are computed 474 as in the previous cases. Here the diagonal element ediag[n][m] now receives the value recip2*wzx-eup [n][m−1]-dup[n][m].

Next the boundary cases of data elements having indices of m=0 and 0<n<N−1 are addressed. The value of the index m is set 476 equal to zero and the index n is incremented and then compared to N−1. If the value of the index n is less than N−1 then wzx, wxxalpha, and wxxbeta are computed 484, 486, 492, 494, 500, 502 in the manner given above. Then the matrix element values for eup[n][m], dup[n][m], and rhs[n][m] are computed 504 in the manner given above, here with the diagonal terms ediag[n][m] assigned the values recip2*wzx-eup[n][m]-dup[n][m]-dup[n−1][m].

The interior, non-boundary data element matrix terms are next addressed, where 0<m<M−1 and 0<n<N−1. Here the index n is first initialized 506 to zero and then incremented 508, with the index m here reset to zero. The value of the index n is then compared 510 to N−1. If the value of the index n is less than N−1, then the value of the index m is incremented 512 and compared 514 to M−1. If the value of the index m is less than M−1 then the general case matrix element values are computed. The values of the variables wzx, wxxalpha, and wxxbeta are computed 520, 522, 528, 530, 536, 538 in the manner given above. Similarly, the array elements eup[n][m], dup[n][m], and rhs[n][m] are assigned 540 values in the manner given above. Here the diagonal elements ediag[n][m] are assigned a general value of recip2*wzx-eup[n][m]-eup[n][m−1]-dup[n][m]-dup[n−1][m].

If at the comparison step 514 it is found that the index m equals M−1 then this loop of processing is complete and the index m is reset 508 to zero and the index n is incremented. Here, if a comparison 510 proves the value of the index n to be less than N−1, then the value of the index m is incremented 512 and the inner loop of processing over the index m is restarted with the new value of the index n. If the comparison 510 proves the value of the index n to be equal to N−1, then the current processing loop is complete.

For the next set of boundary cases to be addressed, with indices m=M−1 and 0<n<N−1, the value of the index m is set 542 as m=M−1 and the value of the index n is initialized as zero. Note that it is important that the general non-boundary cases have been previously computed at this point because the diagonal terms of the matrix require that the elements eup [n][M−2] be available now and this will only be true if the general case has previously been addressed. Note that because the element m=M−1 eup[n][m] does not exist the value of variable wxxalpha need not be computed here. The values of the variables wzx, wxxbeta, dup[n][m], and rhs[n][m] are computed 552, 554, 560, 562 in the manner given above. The values of the terms dup[n][m], and rhs[n][m] are also produced 564 in the manner given above. The diagonal terms for these boundary cases, ediag[n][m], are here assigned the values recip2*wzx-eup[n][m−1]-dup[n][m]-dup[n−1][m]. When the comparison step 546 indicates that value of the index n to be equal to N−1, then the processing loop over the values of the index n is terminated.

The next boundary element case to be addressed is that for which a data element has the indices m=0 and n=N−1; here in a next step, these index values are assigned 566. Because the matrix term dup[n][m] does not exist for this index of n, the value of the variable wxxbeta is not computed. The values of the variables wzx, wxxalpha are computed 570, 572, 578, 580 in the manner given above, and the terms eup[n][m], and rhs[n][m] are assigned 582 values in the manner given above. Here the diagonal element ediag[n][m] is assigned the value recip2*wzx-eup[n][m]-dup[n−1][m].

The next boundary case to be addressed is for data elements having indices 0<m<M−1and n=N−1; in a next step the value of the index n is initialized 584 to N−1 and the value of the index m is initialized to zero. Again the term dup[n][m] does not here exist for this index of n and a value for the variable wxxbeta is therefore not computed. Values for the variables wzx and wxxalpha are produced 594, 596, 602, 604 in the manner previously given, and values for the terms eup[n][m] and rhs[n][m] are assigned 606 in the manner given above. The value of the diagonal element ediag[n][m] is here assigned a value of recip2*wzx-eup[n][m]-eup[n][m−1]-dup[n−1][m]. When the value of the index m is equal to M−1 this processing loop can be terminated.

A final boundary case to be addressed is given for the values of indices of m=M−1 and n=N−1; in the next process step these index values are assigned 608. For this boundary condition, neither the elements eup[n][m] nor the elements dup[n][m] exist, and thus, no values for the variables wxxalpha or wxxbeta need be computed. Thus, a value only for the variable wzx is computed 614, 616 and the term rhs[n][m] is assigned 618 a value of recip2*wzx*z[n][m] and ediag[n][m] is assigned a value recip2*wzx-eup[n][m−19 -dup[n−1][m]. With this assignment, the entire system matrix and the right hand side of the MAP estimation expression are fully defined and, thus the processing routine can be returned 620 with the corresponding values.

Referring now back to the flow diagram of FIG. 22, after the system matrix is formed 300 for a first pdf mean estimation iteration or formed 400 for a second pdf mean estimation iteration, the system expression is solved 350, 650 respectively. FIG. 23J is a flow diagram of the tasks to be carried out for producing solutions for each of these estimation iterations. The previous discussion of solution techniques described a range of suitable techniques for solving the MAP system expression. While those techniques are indeed widely applicable, it is found that for many applications, an alternative technique, namely, a successive line over relaxation (SLOR) technique, can be most often preferred for solving the MAP system expression.

To illustrate the SLOR method, consider the MAP system equations in their block diagonal form, where the block diagonal matrices E₁, E₂, . . . ,Eₙ, are symmetric tridiagonal matrices, the off block diagonal matrices D₁, D₂, . . . , D_{N-1} are diagonal matrices, and the block diagonal matrices on the right hand side, the B₁, B₂, . . . , B_{N}, are diagonal matrices. The system equation is then given as:

$$\begin{matrix}( \begin{matrix}{E}_{1} & {D}_{1} & 0 & 0 & 0 \\ {D}_{1} & {E}_{2} & {D}_{2} & 0 & 0 \\ 0 & {D}_{2} & {E}_{3} & ⋰ & 0 \\ 0 & 0 & ⋰ & ⋰ & {D}_{N - 1} \\ 0 & 0 & 0 & {D}_{N - 1} & {E}_{N}\end{matrix} ) ( \begin{matrix}{X}_{1} \\ {X}_{2} \\ ⋮ \\ ⋮ \\ {X}_{N}\end{matrix} ) =\end{matrix} \begin{matrix}( \begin{matrix}{B}_{1} & 0 & 0 & 0 & 0 \\ 0 & {B}_{2} & 0 & 0 & 0 \\ 0 & 0 & {B}_{3} & 0 & 0 \\ 0 & 0 & 0 & ⋰ & 0 \\ 0 & 0 & 0 & 0 & {B}_{N}\end{matrix} ) ( \begin{matrix}{Z}_{1} \\ {Z}_{2} \\ ⋮ \\ ⋮ \\ {Z}_{N}\end{matrix} )\end{matrix} \qquad ( 76 )$$

This matrix equation can be solved iteratively by the Successive Line Over Relaxation method (SLOR) as follows. Let Xₙ^{(m)} denote the m^{th} iterative result. Then the solution is obtained by iterating over the following pair of block matrix equations:

$${E}_{n} {\hat{X}}_{n}^{( m + 1 )} = {B}_{n} {Z}_{n} - {D}_{n - 1} {X}_{n - 1}^{( m + 1 )} - {D}_{n} {X}_{n + 1}^{( m )} , 1 \leq n \leq N \\ {X}_{n}^{( m + 1 )} = ω {\hat{X}}_{n}^{( m + 1 )} - ( ω - 1 ) {X}_{n}^{( m )} , 1 \leq n \leq N \qquad ( 77 )$$

Note the computational advantage obtained by this method in that every matrix with the exception of the Eₙ's are diagonal and the Eₙ's themselves are simple tridiagonal matrices. Thus, solving the first equation is of order M and there N such block equations to solve, whereby the overall computation is of order M*N, which is the exact size of the system matrix. The scalar parameter c is the overrelaxation parameter and is specified to speed the convergence of the solution. The overrelaxation parameter must lie strictly between 1 and 2, 1<w<2, and for most applications, an optimal value is about 1.8.

Tridiagonal systems like this are relatively easily solved. Because the Eₙ's are fixed during the iterations and only new right hand sides of the expression appear during the iterations, it behooves one to find a method which doesn't require Gaussian pivoting on each iteration. Such a method is the following. Suppose one has the following system Ex=z where E is tridiagonal and of the form:

$$E = ( \begin{matrix}{e}_{1} & {c}_{1} & 0 & 0 & 0 \\ {c}_{1} & {e}_{2} & {c}_{2} & 0 & 0 \\ 0 & {c}_{2} & {e}_{3} & ⋰ & 0 \\ 0 & 0 & ⋰ & ⋰ & {c}_{M - 1} \\ 0 & 0 & 0 & {c}_{M - 1} & {e}_{M}\end{matrix} ) ; z = ( \begin{matrix}{z}_{1} \\ {z}_{2} \\ ⋮ \\ ⋮ \\ {z}_{M}\end{matrix} ) \qquad ( 78 )$$

This matrix problem can be solved directly by the following simple algorithm.

First making the following definitions:

$${w}_{1} = \frac{{c}_{1}}{{e}_{1}} , {w}_{i} = \frac{{c}_{i}}{{e}_{i} - {c}_{i - 1} {w}_{i - 1}} , 2 \leq i \leq M \\ {g}_{1} = \frac{{z}_{1}}{{e}_{1}} , {g}_{i} = \frac{{z}_{i} - {c}_{i - 1} {g}_{i - 1}}{{e}_{i} - {c}_{i - 1} {w}_{i - 1}} , 2 \leq i \leq M \qquad ( 79 )$$

the components of the solution vector x are then given recursively by:

x_{M}=g_{M}, Xᵢ=gᵢ−wᵢxᵢ₊₁, 1≦i≦M−1 (80)

Note that once the reciprocal of the denominator,

$$\frac{1}{{e}_{i} - {c}_{i - 1} {w}_{i - 1}} ,$$

and the weights wᵢ are computed and stored, they can be used over and over on a succession of new right hand sides z. This is exactly the case of the iterative SLOR method that is preferred in accordance with the invention.

Referring then to FIG. 23I for the tasks of carrying out a successive line over relaxation technique to solve the system equations for each iteration of pdf mean estimation, first the value of the index n is initialized 652 at zero. Then the value of the index m is initialized at zero and values of the weights w[n][m] and denominator values denom[n][m] used for producing the solution iteratively are specified 654. The advantage of first computing and then storing these values is that they don't change during the iterations. This is unlike the pdf mean estimate itself, x[n][m], which is recomputed in place at each iteration. The value 1.0/ediag[n][0] is stored in the array element denom[n][0] and the value eup[n][0]*denom[n][0] is stored in the array element w[n][0].

The value of the index m is then incremented 656 and compared 658 to M. If the value of the index m is less than M, then the value 1.0/(ediag[n][m]-eup[n][m−1]*w[n][m−1]) is stored 664 as the array element denom[n][m] and then the value eup[n][m]*denom[n][m] is stored as w[n][m]. Note that this is a recursive definition for the weights because weight w[n][m] is defined in terms of w[n][m−1]. This is to be expected as this is nothing more than the recursive definition for solving a tridiagonal matrix. If the comparison 658 indicates the value of the index m to be equal to M, then the value of the index n is incremented 660 and compared 662 to N. If the value of the index n is less than N. then the index m is reset 654 to zero and the inner loop is restarted with the new value of the index n. If the comparison 662 indicates that the index n is equal to N, then the outer loop can be terminated as and all the denominator and weights are defined.

To begin the iterative solution, the value of the index k, which controls the number of iterations, is set 666 equal to zero. Then the index m is set equal to zero 668 and the first intermediate helper array element g[0] is set equal to the value denom[0][0]*(rhs[0][0]-dup[0][0]*x[1][m]). The index m is then incremented 670 and compared 672 to the value M. If the value of the index m is less than M, then helper array element g[m] is set 674 equal to the value denom[0][m]*(rhs[0][m]-dup[0][m]*x[1][m]-eup[0][m−1]*g[m−1]).

If the comparison 672 indicates that value of the index m is equal to M, then the upward loop on the index m is terminated. The value contained in the helper array element g[M−1] is then stored 676 as the variable temp. The new value of the pdf mean estimate for data element x[0][M−1] is then given in terms of the previous estimate value by omega*temp-omegam1*x[0][M−1], and the value of the index m is then set to M−2 The variables omega and omegam1 are global parameters that were previously defined in the initialization process described above.

In a next step, the new intermediate result temp is defined 678 in terms of the previous result as g[m]-w[0][m]*temp. A corresponding new value for the pdf mean estimate, x[0][m], is here computed in terms of the previous value as omega*temp-omegaml*x[0][m]. The value of the index m is then decremented and in a next step is compared 678 to the value 0. If the value of the index m is greater than or equal to 0, then the downward loop continues 678 with the newly assigned value of m. If the value of the index m is less than zero, then the downward loop is terminated.

The general processing loop for the SLOR iterative solution is now completed, with a first step of setting 682 the value of the index n to 1. In a next step, the value of the index m is reset 684 to zero and the first element of the helper array g[0] is computed as denom[n][0]*(rhs[n][0]-dup[n][0]*x[n+1][0]-dup[n−1][0]*x[n−1][0]). Note that this describes the iterative nature of the solution. The term x[n−1][0] is the new estimate of the pdf mean for the data element with indices n−1 and 0, while the term x[n+1][0] is the old estimate of the pdf mean for the data element having indices n+1 and 0. This is the nature of the iterative SLOR algorithm. As new estimates for the solution become available they are used in computing the current new estimate for a different pixel.

The value of the index m is then incremented 686 and compared 688 to M. If the value of the index m is less than M, then M helper array element g[m] is computed 690 as denom[n][m]*(rhs[n][m]-dup[n][m]*x[n+1[m]-dup[n−1][m]*x[n−1][m]-eup[n][m−1]*g[m−1]). If on the other hand the value of the index m is equal to M, then the upward loop on the index m is terminated and the value of g[M−1] is assigned 692 to the variable temp. The new estimate for x[n][M−1] is then defined in terms of the old estimate as omega*temp-omegam1*x[n][M−1] and the index m is set equal to M−2. In a next step, a new value for the variable temp is computed 694 in terms of the old one as g[m]-w[n][m]*temp. A new estimate of a pdf mean x[n][m] is then given in terms of the old estimate as omega*temp-omegam1*x[n][m] and the index m is then decremented. This decremented value of the index m is then compared 696 to 0. If the value of the index m is greater than or equal to 0, then the downward loop of processing 694 over the index m continues.

If the value of the index m is less than zero, then the index n is incremented 698 and compared 700 to N−1. If the value of the index n is less than N−1, then the index m is reset 684 to 0 and the upward and downward loops of processing over the index m continue with the new value of the index n. If the value of the index n is equal to N−1, then in a next step, the value of the index m is set 702 equal to zero. The array element g[0] is in this step set equal to denom[N−1][0]*(rhs[N−1][0]-dup[N−2][0]*x[N−2][0]).

The index m is then incremented 704 and compared 706 to M. If the value of the index m is less than M, then g[m] is computed as 708 denom[N−1][m]*(rhs[N−1][m]-dup[N−2][m]*x[N−2[m]-eup[N−1][m−1]*g [m−1]). If the value of the index m is found equal to M, then the value of g[M−1] is designated 710 as the variable temp. Here a new estimate of the pdf data element mean x[N−1][M−1] is then computed in terms of the old estimate by the value omega*temp-omegam1*x[N−1][M−1], and the value of index m is then set to M−2.

A new value of the variable temp is then computed 712 in terms of the old value as g[m]-w[N−1][m]*temp. A new estimate of the data element pdf mean x[N−1][m] is then given in terms of the old estimate by the value omega*temp-omegam1*x[N−1][m], and the index m is decremented. The decremented index m is then compared 714 to 0. If the value of the index m is greater than or equal to zero, then the downward loop of processing 712 over the index m is continued. If the value of the index m is less than zero, then the downward loop of processing over the index m is terminated.

In this case, the index k, which controls the number of iterations, is incremented 716 and then compared 718 to the value Niter. This value is assumed to be passed into the routine. If the value of the index k is less than Niter, then a new iteration of processing 668 is begun for the n=0 case. If k equals Niter then the iterative solution is complete and the solution to the pdf mean estimate for the data set is returned 720.

The SLOR solution technique just described, employing a value of an overrelaxation parameter a, of e.g., about 1.8, is found to generally exhibit good convergence behavior on a wide range of data set characteristics. However, for some applications an optimum overrelaxation parameter value may not be a priori discernable, resulting in a suboptimal SLOR implementation that may not converge as quickly as required. In accordance with the invention, for such applications alternative iterative solution techniques can be preferred. One class of alternative iterative solution techniques, namely, Alternating-Direction Implicit (ADI) iterative methods, can be found well suited as MAP estimation solution methods, and in this class, the Peaceman-Rachford method can be preferred for many applications. This solution technique generally requires more computation per iterative step than other techniques such as the SLOR technique, but with optimum acceleration parameters selected, the Peaceman-Rachford method enables an asymptotic rate of convergence that can be much better than that of the SLOR method. Thus, in accordance with the invention, for applications where the SLOR solution technique is found to converge too slowly, the Peaceman-Rachford solution technique is preferred.

Whatever pdf mean estimation solution technique is selected, it can be employed for the first as well as all subsequent iterations of estimation solution. For many applications it is found that no more than two iterations of estimation solution are required to produce acceptable estimation results. Such a two-iteration estimation process is reflected in the flow diagram of FIG. 22 by the first system solving step 350 and the second system solving step 650. Additional iterations of estimation solution can also be carried out if desired for a given application.

With a selected number of estimation solution iterations complete, the pdf mean estimate of each data element value in a data set is achieved. If a data element averaging step was carried out previously to improve estimation computational efficiency, then in a next step, shown in FIG. 22, an interpolation process 725 is carried out to restore the pdf mean estimates to the original data set extent. The flow diagram of FIG. 23K provides specific tasks for carrying out an example interpolation process, here specifically a bilinear interpolation process where it is assumed that a 2×2 block averaging method was carried out on the data element values prior to the pdf mean estimation processing of the averaged values. This interpolation technique, and indeed the previous averaging technique, assumes that an even number of data set elements exist in each of the two dimensions of the data set.

The interpolation process accepts the final solution of pdf mean estimates, e.g., X⁽²⁾ where two iterations of estimation solution are carried out, and produces an interpolated set of pdf mean estimates, \hat{X}. Referring to FIG. 23K, in a first step, the index, n, is initialized 726 to a value of 0, and then doubled 728 and designated as the parameter n2. Then the index, m, is likewise initialized 730 to 0, and in a next step, is doubled 732 and designated as the parameter m2.

In this step, the pdf mean values are processed to specify interpolated pdf mean values over a 2×2 block. This interpolation process extends over the pdf mean estimates corresponding to the first data set row and first data set column and the data set elements at the interior of the data set. In a next step, the index, m, is incremented 734, and compared 736 to M−1. If the value of the index, m, is less than M−1, then this processing loop over the index m is continued to complete interpolation of all pdf mean estimates for data elements that are not at the M−1 or N−1 boundaries of the data set.

If the value of the index, m, is equal to M−1, then the index, n, is incremented 738 and compared 740 to N−1. If the value of the index, n, is less than N−1, then the loop over n is continued by again doubling 728 the current value of the index n to continue interpolating pdf mean estimates out to 2×2 blocks. If the value of the index, n, is equal to N−1, then the value of the index m is set equal 742 to 0 and the value of the index n is set equal to N−1.

Then, in a next step, with the index n value set at N−1, corresponding to the last row of the data set, the pdf mean estimates corresponding to data elements of that last data set row are specified 744 based on the interpolated pdf mean estimates from the previous row. After each pdf mean estimate is interpolated for the row, the value of the column index, m, is incremented 748 and compared 748 to M−1. If the column index, m, is less than M−1, then the pdf mean estimate interpolation is continued to fill out the row.

If the column index, m, is equal to M−1, then the value of the column index, m, is set 750 to M−1, corresponding to the last column of the data set, and the value of the row index, n, is set at zero. This enables interpolation to produce pdf mean estimates corresponding to data elements of the last column of the data set. Accordingly, in a next step, the pdf mean estimates for the last data set column are specified 752 based on the interpolated pdf mean estimates from the previous column. After each pdf mean estimate is interpolated for the column, the value of the row index, n, is incremented 754 and compared 756 to N−1. If the row index, n, is less than N−1, then the pdf mean estimate interpolation is continued to fill out the last column.

If the row index, n, is equal to N−1, then in a final interpolation step 758 an interpolated pdf mean estimate is produced corresponding to the data set element in the last row and last column of the data set. Here the row index, n, is set at N−1 and the column index, m, is set at M−1. Then with the index values doubled, the final interpolated pdf mean estimate values are determined. With this last interpolation complete, the interpolated pdf mean estimate set is returned 760.

As explained above, the pdf mean estimates produced by the invention can be particularly effective for enabling normalization of a data set, e.g., to reduce the dynamic range of the data set. Referring back to FIG. 22, such a normalization process 800 is here shown as an example step, with the two-dimensional data set of data element values, z[n][m], being normalized by the estimate of the data element pdf means, x[n][m].

FIG. 23L provides detail of the tasks in completing this normalization process. In a first step, the value of the index n is initialized 802 at zero and the index m is initialized 804 at zero. Each data set element value z[n][m]0 is then replaced 806 by its normalized value, given as, e.g., z[n][m]/x[n][m], and the index m is then incremented. Note that this particular normalization by division is but one example of a range of normalization techniques provided by the invention. Normalization can alternatively be implemented by, e.g., subtraction of a pdf mean estimate from a data element value, with an optional addition of a constant value to the resulting difference values, or by other selected technique.

After the normalization of the current data element, the incremented value of the index, m, is then and compared 808 to M. If the value of the index m is less than M, then the normalization process is continued 806 with the new value of m. If the value of the index m is equal to M, then the index n is incremented 810 and compared 812 to N. If the value of the index n is less than N, then the index m is reset 804 to 0 and the inner loop of processing 806 is restarted with the new value of n. If the value of the index n equals N, then processing is complete and the routine is returned 814 with normalized data element values contained in the data set.

The normalized data element values resulting from this process are characterized by a reduced dynamic range. This characteristic enables, e.g., the production of an image, like that of FIG. 21C, that provides local contrast across the entire image even where quite dramatic shifts in dynamic range characterize the raw image data across the image. As a result, image detail from distant regions of an image that conventionally could not be displayed or analyzed in a single image is here fully realized. Accordingly, referring back to FIG. 22, the normalized data set can be displayed 850 on a selected display device, or otherwise analyzed for an intended application. If the data set element values were initially scaled based on a global mean, then prior to display, the normalized data set can be again scaled, if desired, to center the normalized data set dynamic range based on characteristics of the display device.

For some applications it can be preferred to retain in a normalized data set some knowledge of the data elements'original, pre-normalized values. For example, in an image processing application, it may be desired that “light areas remain light and dark areas remain dark” where the term “areas” is meant here to connote large regions of an image, not local features. For such an application, partial, rather than full, normalization of the data set can be preferred.

Partial normalization can be imposed in accordance with the invention through, e.g., a linear transformation process. Consider that a data set that has been first normalized by its global mean so that the data values are clustered about unity, and that an estimate of the pdf mean of each data value in the set has been obtained by one of the processes of the invention. If the value unity is subtracted from each element of the produced pdf mean array and then each element of the resulting mean array is multiplied by a contraction factor, λ, where 0≦λ≦1 and then unity is added back to each element of the mean array, one can accomplish such a partial normalization.

Considering a two-dimensional data set, and designating this new partial normalization pdf mean set, here an array, \hat{x}, then on an element by element basis the array is given in terms of the full normalization mean estimate as:

\hat{x}ₙₘ=λ(xₙₘ−1.0)+1.0=λ\hat{x}ₙₘ+1.0−λ, (81)

which is a simple linear transformation. Any pdf mean estimate values that lie above unity are still positive when 1.0 is subtracted from them. Thus when multiplied by a value less than one, λ, the values shrink towards zero. Any pdf mean estimate values that lie below unity are negative when 1.0 is subtracted from them. Then when multiplied by a value less than one, λ, the values again shrink towards zero. When 1.0 is then added to the new mean estimates to move them back to the appropriate range for normalization, the estimates have been appropriately modified so that high-valued regions, those above unity, remain high and low-valued regions, those below unity, remain low. In this way absolute amplitude information about large regions of the data element array can be retained in a user-controllable way, namely through the specification of the scaling parameter λ.

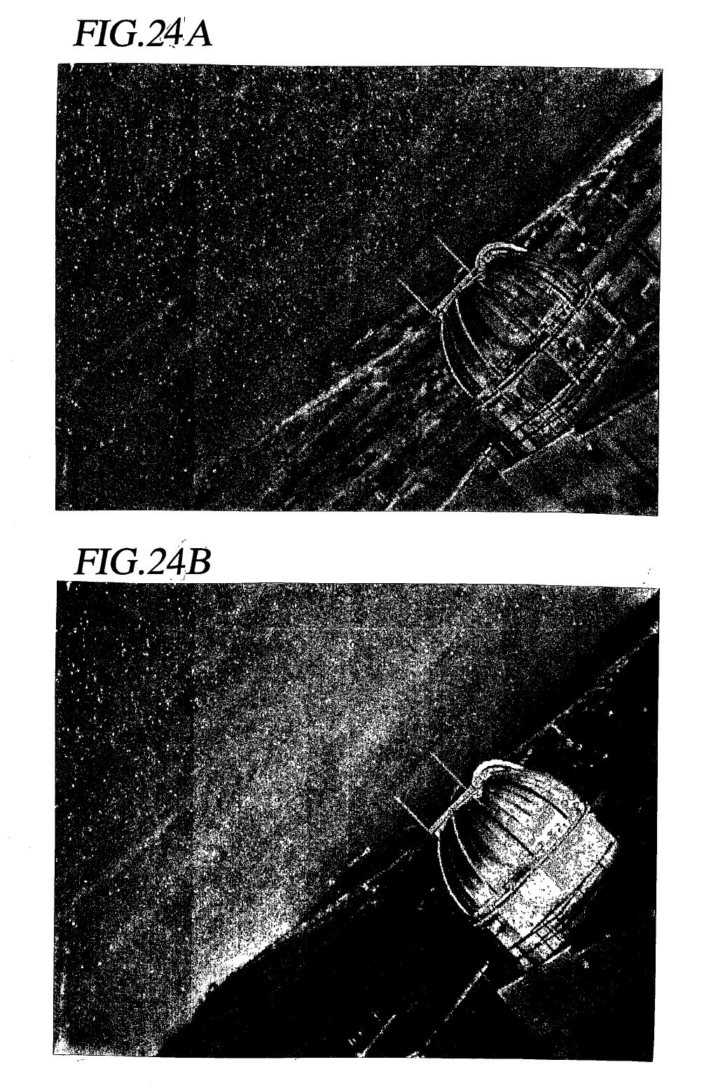

An example of this technique is shown by comparing FIGS. 24A-24B. FIG. 24A is the image of FIG. 21C, wherein full normalization has been performed on the image, i.e., λ=1, to reduce dynamic range such that local contrast across the entire image is achieved. FIG. 24B is a version of the same image, here with partial normalization performed employing a contraction factor of λ=0.7. Note that with this partial normalization, the brighter sky and observatory more closely represent the original, un-normalized image data. However, details of the desert floor are now less apparent than in the full-normalized image version of FIG. 24A. This is an example of the sort of trade-off required in selecting a contraction factor and a partial normalization process. This also demonstrates, however, the powerful processing techniques that are enabled by the pdf mean estimation process of the invention.

Turning now to the breadth of applicability of the processing techniques provided by the invention, the MAP pdf mean estimation method is not limited to processing in only one or two dimensions but can be extended to further data dimensions if an application suggests itself. For clarity, this discussion will specifically consider an extension to three dimensions, but it is to be recognized that an extension to four or more dimensions would follow the same reasoning.

Consider a two-dimensional data element array, such as an image pixel data array. In this example, as discussed previously, two directional dimensions were defined, namely, an X direction and a Y direction. For many applications a third dimension is relevant, e.g., for three-dimensional image or acoustic data, or for a time sequence of image arrays. Taking this example, if m is given as the running data element index for data elements in the X direction of an image array, and n is the running data element index for data elements in the Y of the image array, an additional index, e.g., k is here employed for the third dimension, say, the number of image arrays in a time sequence of arrays.

With three such data element indices, the data element pdf measurement model correspondingly accounts for all three dimensions. As discussed above, any suitable pdf distribution form can be employed for the measurement model; for many applications, a gaussian distribution can be preferred. Here the measurement model is then given as:

$${p}_{z \vert x} ( Z \vert X ) = {\prod }_{{m = 1}_{{n = 1}_{k = 1}}}^{{k = K}^{{n = N}^{m = M}}} ( 1 - {P}_{s} ) \frac{{ⅇ}^{- {( {z}_{nmk} - {x}_{nmk} )}^{2} / 2 {σ}_{nmk}^{2}}}{\sqrt{2 π {σ}_{nmk}^{2}}} + \frac{{P}_{s}}{{Δσ}_{nmk}} , \qquad ( 82 )$$

where M is the total number of data elements in the X direction, N is the total number of data elements in the Y direction, and K is the total number of data arrays in the time sequence under consideration. The probability, Pₛ, and the data value range, Δσₙₘₖ have the same interpretation as for the two dimensional case described above. In this three-dimensional model, the variance of a data element pdf is given as:

$${σ}_{nmk}^{2} = \frac{{x}_{nmk}^{2}}{{N}_{int}} \qquad ( 83 )$$

that is, the variance equals the square of the pdf mean divided by the number of data elements that have been block averaged or noncoherently integrated, if any, in the manner described above.

Like the measurement model, the mean model now requires, for the three dimensional case, a factor which accounts for nearest neighbor coupling in the added third dimension. Again any suitable distribution function form can be employed for the mean model, but for many applications a gaussian form is found preferable. In this case, the mean model is then given as:

$$\begin{matrix}{p}_{x} ( X ) = {\prod }_{{1 \leq n \leq N}_{{1 \leq m < M}_{1 \leq k \leq K}}} [ ( 1 - {P}_{dx} ) \frac{{ⅇ}^{- {( {x}_{n , m + 1 , k} - {x}_{nmk} )}^{2} / 2 {α}_{nmk}^{2}}}{\sqrt{2 {πα}_{nmk}^{2}}} + \frac{{P}_{dx}}{{Δ}_{x} {α}_{nmk}} ] \\ {\prod }_{{1 \leq n < N}_{{1 \leq m \leq M}_{1 \leq k \leq K}}} [ ( 1 - {P}_{dy} ) \frac{{ⅇ}^{- {( {x}_{n + 1 , mk} - {x}_{nmk} )}^{2} / 2 {β}_{nmk}^{2}}}{\sqrt{2 {πβ}_{nmk}^{2}}} + \frac{{P}_{dy}}{{Δ}_{y} {β}_{nmk}} ] \\ {\prod }_{{1 \leq k \leq N}_{{1 \leq l \leq M}_{1 \leq k < K}}} [ ( 1 - {P}_{dz} ) \frac{{ⅇ}^{- {( {x}_{n m , k + 1} - {x}_{nmk} )}^{2} / 2 {γ}_{nmk}^{2}}}{\sqrt{2 {πγ}_{nmk}^{2}}} + \frac{{P}_{dz}}{{Δ}_{z} {γ}_{nmk}} ] ,\end{matrix} \qquad ( 84 )$$

where the three parameters αₙₘₖ², βₙₘₖ², γₙₘₖ² are the logical extension of their two dimensional counterparts αₙₘ² and βₙₘ², where:

$$\begin{matrix}{α}_{nmk}^{2} = \frac{{σ}_{nmk}^{2}}{{F}_{x}} , & ( 85 ) \\ {β}_{nmk}^{2} = \frac{{σ}_{nmk}^{2}}{{F}_{y}} , & ( 86 ) \\ {γ}_{nmk}^{2} = \frac{{σ}_{nmk}^{2}}{{F}_{z}} . & ( 87 )\end{matrix}$$

The terms Fₓ and F_{y} are the smoothness parameters for the X and Y directions, as in the two dimensional case, and F_{z} is the added smoothness parameter for the third dimension, e.g., time.

To evaluate the measurement and mean models, derivatives with respect to Xₙₘₖ of the natural logarithms of P_{z|x}(Z|X) and pₓ(X) are required. To simplify the notation of these operations, the symbols [P_{S}]ₙₘₖ, [P_{dx}]ₙₘₖ, [P_{dy}]ₙₘₖ, and [P_{dz}]ₙₘₖ are here employed to refer to the full bracketed expressions with those indices. The derivative of the measurement model, In p_{z|x}(Z|X), is then given as:

$$\frac{\partial }{\partial {x}_{nmk}} ln {p}_{z \vert x} ( Z \vert X ) = \frac{( 1 - {P}_{s} )}{{[ {P}_{s} ]}_{nmk}} \frac{{ⅇ}^{- {( {z}_{nmk} - {x}_{nmk} )}^{2} 2 {σ}_{nmk}^{2}}}{\sqrt{2 {πσ}_{nmk}^{2}}} \frac{1}{{σ}_{nmk}^{2}} ( {z}_{nmk} - {x}_{nmk} ) . \qquad ( 88 )$$

To obtain the derivative of the log of the mean model, lnpₓ(X), it is convenient to employ primes on the indices in expression (3) above differentiate those indices from the indices with respect to which derivatives are now taken. With this notation, the derivative of the mean model is given as:

$$\begin{matrix}\frac{\partial }{\partial {x}_{nmk}} ln {p}_{x} ( X ) = \frac{( 1 - {P}_{dx} )}{{[ {P}_{dx} ]}_{{n}^{′} {m}^{′} {k}^{′}}} \frac{{ⅇ}^{- {( {x}_{{n}^{′} , {m}^{′} + 1 , {k}^{′}} - {x}_{{n}^{′} {m}^{′} {k}^{′}} )}^{2} \text{/} 2 {α}_{{n}^{′} {m}^{′} {k}^{′}}^{2}}}{\sqrt{2 {πα}_{{n}^{′} {m}^{′} {k}^{′}}^{2}}} \\ \frac{( {x}_{{n}^{′} , {m}^{′} + 1 , {k}^{′}} - {x}_{{n}^{′} {m}^{′} {k}^{′}} )}{{α}_{{n}^{′} {m}^{′} {k}^{′}}^{2}} {δ}_{{nn}^{′}} ( {δ}_{{mm}^{′}} - {δ}_{m , m + 1} ) {δ}_{{kk}^{′}} + \\ \frac{( 1 - {P}_{dy} )}{{[ {P}_{dy} ]}_{{n}^{′} {m}^{′} {k}^{′}}} \frac{{ⅇ}^{- {( {x}_{{n}^{′} + 1 , {m}^{′} {k}^{′}} - {x}_{{n}^{′} {m}^{′} {k}^{′}} )}^{2} \text{/} 2 {β}_{{n}^{′} {m}^{′} {k}^{′}}^{2}}}{\sqrt{2 {πβ}_{{n}^{′} {m}^{′} {k}^{′}}^{2}}} \\ \frac{( {x}_{{n}^{′} + 1 {m}^{′} {k}^{′}} - {x}_{{n}^{′} {m}^{′} {k}^{′}} )}{{β}_{{n}^{′} {m}^{′} {k}^{′}}^{2}} {δ}_{{mm}^{′}} ( {δ}_{{nn}^{′}} - {δ}_{n , {n}^{′} + 1} ) {δ}_{{kk}^{′}} + \\ \frac{( 1 - {P}_{dz} )}{{[ {P}_{dz} ]}_{{n}^{′} {m}^{′} {k}^{′}}} \frac{{ⅇ}^{- {( {x}_{{n}^{′} {m}^{′} , {k}^{′} + 1} - {x}_{{n}^{′} {m}^{′} {k}^{′}} )}^{2} \text{/} 2 {γ}_{{n}^{′} {m}^{′} {k}^{′}}^{2}}}{\sqrt{2 {πγ}_{{n}^{′} {m}^{′} {k}^{′}}^{2}}} \\ \frac{( {x}_{{n}^{′} {m}^{′} , {k}^{′} + 1} - {x}_{{n}^{′} {m}^{′} {k}^{′}} )}{{γ}_{{n}^{′} {m}^{′} {k}^{′}}^{2}} {δ}_{{nn}^{′}} {δ}_{{mm}^{′}} ( {δ}_{{kk}^{′}} - {δ}_{k , {k}^{′} + 1} ) .\end{matrix} \qquad ( 89 )$$

This expression will generate twelve terms in the general case. The boundary conditions of the data set at which the data element indices are given as n=1, m=1, n=N, m=M, k=1, and k=K will result in expressions having corresponding terms removed.

To consider the non-boundary expressions, it is convenient to define the following function:

$$w ( x , y , LF , P , Δ ) = \frac{( 1 - P ) \frac{{ⅇ}^{- {( x - y )}^{2} LF \text{/} 2 {y}^{2}}}{\sqrt{2 π \frac{{y}^{2}}{LF}}}}{( 1 - P ) \frac{{e}^{- {( x - y )}^{2} LF \text{/} 2 {y}^{2}}}{\sqrt{2 π \frac{{y}^{2}}{LF}}} + \frac{P}{Δ} \frac{\sqrt{LF}}{y}} . \qquad ( 90 )$$

Note that in this expression the dependence on L, the number of block averaged data elements in the X direction, which earlier was called Nᵢₙₜ, is explicitly shown. With this function, the following shorthand notation can be developed:

w_{σ}(zₙₘₖ,xₙₘₖ) for the w function with Pₛ, ΔZ, L,

w_{α}(x_{n,m+1,k},xₙₘₖ) for the w function with P_{dx}, ΔX_{dx},LFₓ,

w_{β}(x_{n+1, mk}, xₙₘₖ) for the w function with P_{dy}, ΔX_{dy}, LF_{y},

w_{γ}(x_{nm,k+1}, xₙₘₖ) for the w function with P_{z}, ΔX_{dz}, LF_{z}.

Then the derivative of the mean model, pₓ(X) can be expressed as:

$$\begin{matrix}\frac{\partial }{\partial {x}_{nmk}} ln {p}_{x} ( X ) = \frac{{w}_{α} ( {x}_{n , m + 1 , k} , {x}_{nmk} )}{{α}_{nmk}^{2}} ( {x}_{n , m + 1} - {x}_{nm} ) + \\ \frac{{w}_{α} ( {x}_{nmk} , {x}_{n , m - 1 , k} )}{{α}_{n , m - 1 , k}^{2}} ( {x}_{n , m - 1 , k} - {x}_{nmk} ) + \\ \frac{{w}_{β} ( {x}_{n + 1 , mk} , {x}_{nmk} )}{{β}_{nmk}^{2}} ( {x}_{n + 1 , mk} - {x}_{nmk} ) + \\ \frac{{w}_{β} ( {x}_{nmk} , {x}_{n - 1 , mk} )}{{β}_{n - 1 , mk}^{2}} ( {x}_{n - 1 , mk} - {x}_{nmk} ) + \\ \frac{{w}_{γ} ( {x}_{nm , k + 1} , {x}_{nmk} )}{{γ}_{nmk}^{2}} ( {x}_{nm , k + 1} - {x}_{nmk} ) + \\ \frac{{w}_{γ} ( {x}_{nmk} , {x}_{nm , k - 1} )}{{γ}_{nm , k - 1}^{2}} ( {x}_{nm , k - 1} - {x}_{nmk} ) .\end{matrix} \qquad ( 91 )$$

With these expressions, the following MAP system is to be solved:

$$\frac{\partial }{\partial {x}_{nmk}} [ ln {p}_{z \vert x} ( Z \vert X ) + ln {p}_{x} ( X ) ] = 0. \qquad ( 92 )$$

Each of the non-boundary data element cases will here be expressed. The data set boundary cases can be similarly produced from the general case by eliminating terms whose indices exceed the particular boundary range or are zero for that boundary case. The w factors given above are guaranteed to be less than or equal to one and are themselves clipped if their exponent becomes too negative and would otherwise underflow computational precision. In this way any numerical instabilities associated with large dynamic range data are isolated into well understood terms.

The general case is then expressed as:

$$\begin{matrix}[ {w}_{σ} ( {z}_{nmk} , {x}_{nmk} ) \text{/} {x}_{nmk}^{2} + {F}_{x} {w}_{α} ( {x}_{n , m + 1 , k} , {x}_{nmk} ) \text{/} {x}_{nmk}^{2} + \\ {F}_{x} \frac{1}{{x}_{n , m - 1 , k}^{2}} {w}_{α} ( {x}_{nmk} , {x}_{n , m - 1 , k} ) + \\ {F}_{y} {w}_{β} ( {x}_{n + 1 , mk} , {x}_{nmk} ) \text{/} {x}_{nmk}^{2} + \\ {F}_{y} \frac{1}{{x}_{n - 1 , m}^{2}} {w}_{β} ( {x}_{nmk} , {x}_{n - 1 , mk} ) + \\ {F}_{z} {w}_{γ} ( {x}_{nm , k + 1} , {x}_{nmk} ) \text{/} {x}_{nmk}^{2} + \\ {F}_{z} \frac{1}{{x}_{nm , k - 1}^{2}} {w}_{γ} ( {x}_{nmk} , {x}_{nm , k - 1} ) ] {x}_{nmk} - \\ {F}_{x} {w}_{α} ( {x}_{n , m + 1 , k} , {x}_{nmk} ) {x}_{n , m + 1 , k} \text{/} {x}_{nmk}^{2} - \\ {F}_{x} \frac{1}{{x}_{n , m - 1 , k}^{2}} {w}_{α} ( {x}_{nmk} , {x}_{n , m - 1 , k} ) {x}_{n , m - 1 , k} - \\ {F}_{y} {w}_{β} ( {x}_{n + 1 , mk} , {x}_{nmk} ) {x}_{n + 1 , mk} \text{/} {x}_{nmk}^{2} - \\ {F}_{y} \frac{1}{{x}_{n - 1 , mk}^{2}} {w}_{β} ( {x}_{nmk} , {x}_{n - 1 , mk} ) {x}_{n - 1 , mk} - \\ {F}_{z} {w}_{γ} ( {x}_{nm , k + 1} , {x}_{nmk} ) {x}_{nm , k + 1} \text{/} {x}_{nmk}^{2} - \\ {F}_{z} \frac{1}{{x}_{nm , k - 1}^{2}} {w}_{γ} ( {x}_{nmk} , {x}_{nm , k - 1} ) {x}_{nm , k - 1} = \\ {w}_{σ} ( {z}_{nmk} , {x}_{nmk} ) {z}_{nmk} \text{/} {x}_{nmk}^{2} .\end{matrix} \qquad ( 93 )$$

The indices of this expression need to be grouped in order to form a matrix. In one example, the Y-direction indices are grouped first with the X-direction second, just as in the two dimensional case. This results in a matrix structure like that for the two dimensional processing implementation described above. This structure is then employed to form the diagonal blocks of the three-dimensional matrix here. The off-diagonal blocks are here formed by the F_{z}w_{y} terms in the above expression. These very large off-diagonal blocks are themselves diagonal as they consist only of the factors multiplying x_{nm, k+1} and x_{nm,k-1}.

With this description, an extension of the MAP estimation process to a general case of D dimensions is clear. First, a measurement model is defined employing D indices on the variables for the data element values, z, and the unknown pdf mean values x. Similarly, a mean model is defined, having a number, D of factors in which each successive factor couples a different index to its nearest neighbor. As an example the fourth factor would be given as:

$${\prod }_{{1 \leq n \leq N}_{{1 \leq m \leq M}_{{1 \leq k \leq K}_{1 \leq l \leq L}}}} [ ( 1 - {P}_{d4} ) \frac{{ⅇ}^{- {( {x}_{nmk , l + 1 , …} - {x}_{nmkl , …} )}^{2} \text{/} 2 {δ}_{nmkl , …}^{2}}}{\sqrt{2 {πδ}_{nmkl , …}^{2}}} + \frac{{P}_{d4}}{Δ {X}_{4}} \qquad ( 94 )$$

where the “. . . ” denotes following indices past the fourth. Next, the natural logarithms of the measurement model, p_{z|x}(Z|X) and the mean model, pₓ(X), are differentiated with respect to x_{nmkl, . . .} . Two terms will be produced by the p_{z|x}(Z|X) differentiation and 4D terms will be produced by the pₓ(X) differentiation. With this differentiation complete, in accordance with the MAP expression, then a system matrix is formed by collecting indices of the expressions in any desired order. Solutions to the matrix expression then provide the desired pdf mean estimate for a D-dimensional set of data elements.

Turning to other implementation particulars, the pdf mean estimation process of the invention, as well as associated normalization or other processes, can be implemented in software or hardware as-prescribed for a given application. For many applications digital processing can be most suitable for implementation of the system, but it is to be recognized that analog processing, e.g., by neural network, can also be employed. Workstation or personal computer software can employed with very good results for static data sets and images. But real-time applications, e.g., real-time video or ultrasound, can be implemented preferably with custom hardware to enable a reasonable data flow rate.

It is to be recognized, of course, that each application typically will suggest a particular implementation. For example, if full-video rates of data processing are not required for an image application, then a dedicated processing board providing, e.g., 4-8 Altavec G4 processors, can be employed, with each processor processing a separate band, or region, of images provided by the application. After the pdf mean estimates for the element data of each band are determined, the results for each band can be constructed for application to the original image.

For image applications warranting real-time analysis, a real-time embedded processor can be preferred and implemented by, e.g., employing a massively parallel VLSI architecture. Here an image can be divided into a large number of overlapping sub-blocks of image data elements, with each sub-block assigned to a dedicated special-purpose image processor. Approximately 512-1024 high-performance VLSI processors would be required to process in real time an image having pixel element dimensions of 1024×1024. Considering a particular hardware implementation, 8-16 image processors could reside on a single semiconductor chip, resulting in a requirement for 32-128 processor chips per system, assuming a reasonable level of estimation process efficiency and a fixed-point implementation. But it is anticipated that as future improvements to both hardware and software are generated, it is possible that only 4-16 processor chips, or fewer, could be required for a system implementation. Each processor should preferably include an input data distribution and control processor, an image processor array, and an image reassembly processor. Off-the-shelf digital signal processing boards, as well as single chip implementations, can be employed for each of these processing functions.

From the description and examples above, it is clear that the pdf mean estimation process of the invention is widely applicable to data sets in any number of dimensions, and finds important utility for a range of applications. Image data, e.g., digital camera image data, X-ray data, and other image data, in two or more dimensions, can be accurately displayed and analyzed with normalization and other processing enabled by the pdf mean estimations. Acoustic data, e.g., sonar data in which the dimensions of frequency and time epoch are employed, ultrasound data, and other acoustic data likewise can be normalized by the pdf mean estimates enabled by the invention. Of important note is that a normalization process employing the pdf mean estimates enabled by the invention can be used to filter out data measurement noise as well as to reduce the dynamic range of the data.

The example results presented in FIG. 21C for a night time image demonstrate the superior adaptability of the processing techniques of the invention to low light digital photography of single images as well as low light applications for digital camcorders at real time video rates. The mean estimation and normalization processes are likewise applicable to color images and video. Here, normalization can be carried out on, e.g., value components of a hue, saturation, and value (HSV) color model. Such color image processing is of particular importance for medical applications.

For example, given a medical image acquired in an RGB color plane model, each RGB triplet can be converted to an HSV triplet such that the image is converted to HSV and value components of the image normalized. The normalized data can then be converted back to the RGB color plane model. The MatLabTM rgb2hsv function enables the first conversion, and the MatLab™ function hsv2rgb enables the inverse transformation. It is found in practice that this conversion from an RGB color model to HSV, normalization, and then reconversion to the RGB model does not distort the color values of the image.

In a similar application, the computation of a quantity called “redness” is important for many analyses of color medical images. Given an RGB color model in which R, G, and B define the level of an image pixel's red, green, and blue values, the “redness” of a pixel can be expressed as:

$$redness = \frac{R - G}{R + G} + \frac{R - B}{R + B} \qquad ( 95 )$$

This specifically quantifies the “overage” of redness for a given pixel, and has significance for biomedical researchers in determining the amount of capillary action in a given imaged region. Because the value of redness may vary widely over an image, this color image characteristic it is a candidate for normalization to enable meaningful display and analysis of an image.

Other biomedical images that can benefit from pdf mean estimation and normalization processes provided by the invention include magnetic resonance imaging (MRI) as well as other image acquisition and analysis processes, including video transmission and display. Radio transmission, reception, and play, and other communication signals similarly can be enhanced by the processes of the invention.

Further applications of the pdf mean estimation and data normalization processes of the invention include Synthetic Aperture Radar (SAR) imagery; low light digital image processing in connection with night vision devices, ,which do not record images but rather present normalized digital image data directly to a user; and signals intelligence (SIGINT), where the communications region of the electromagnetic spectrum is monitored over time and the resulting time-frequency data could be normalized. The advantage for the SIGINT application is that the adaptability and flexibility of the pdf estimation process of the invention can enable preservation of “bursty” signals having short time duration but wide bandwidth. This enables the detection of possibly covert communication signals being transmitted in the communications spectrum.

An example of a further important application of the pdf mean estimation and normalization processes of the invention is with Constant-False-Alarm-Rate (CFAR) processing of radar signal data. Radar signal returns can often be contaminated by energy that is reflected by clutter, or by active jamming that can change the mean of the noise power received at different ranges. This nonstationary mean level of received energy can introduce false alarms into radar systems, reducing their ability to detect and track targets. The pdf mean estimation process of the invention enables estimation of this possibly varying mean noise level, and the resulting estimate of the noise level mean can be used to produce a range-varying threshold for detecting targets while maintaining a Constant False Alarm Rate for the radar signal to which the CFAR is being applied.

A further important application of the pdf mean estimation and normalization processes of the invention is airport and other security X-ray scanning of baggage and materials. Low density, suspicious or threatening objects and/or materials, such as plastic guns or plastic knives, which do not strongly absorb or scatter X-ray photons, generally are characterized by small X-ray signatures in such scans. In accordance with the invention, the faint signatures, or features, of such materials are enhanced by normalizing acquired X-ray image scan data to reduce the dynamic range of the data and thereby enhance the contrast of the scan, resulting in enhanced appearance of such faint objects or materials.

The X-ray image scan data is here specifically normalized by the pdf mean estimates of the scan data produced in accordance with the invention. An X-ray image scan having a thusly produced reduced dynamic range and corresponding enhanced contrast can then in accordance with the invention be processed by, e.g., pattern recognition software that is optimized for reduced dynamic range X-ray data to enable enhanced X-ray data analysis and correspondingly enhanced security at X-ray scanning stations such as airport baggage checkpoints and other locations of security interest.

With this discussion, the very broad applicability and superior performance of the pdf mean estimation and normalization processes of the invention are demonstrated. It is recognized, of course, that those skilled in the art may make various modifications and additions to the pdf mean estimation technique and normalization processes of the invention described above without departing from the spirit and scope of the present contribution to the art. Accordingly, it is to be understood that the protection sought to be afforded hereby should be deemed to extend to the subject matter of the claims and all equivalents thereof fairly within the scope of the invention.

We claim:

1. A method of normalizing a data set of data element values, comprising:
selecting a form of a statistical distribution of a probability density function for each data element of the data set based on the value of that data element;
estimating a mean of the probability density function of each data element by a digital processing technique; and
processing each data element value based on the estimated mean of the probability density function of that data element to normalize each data element value, producing a normalized data set.

2. The normalization method of claim 1 wherein the as-produced data set is characterized by a dynamic range in data element values, and wherein processing of each data element value to produce a normalized data set comprises reducing the dynamic range of the as-produced data set.

3. The normalization method of claim 2 wherein processing of each data element value to produce a normalized data set comprises reducing the dynamic range of the data set by an amount sufficient to enable display of the entire data set dynamic range on a selected display device.

4. The normalization method of claim 2 wherein processing of each data element value to produce a normalized data set comprises reducing the dynamic range of the data set by an amount sufficient to enable analysis of the entire data set dynamic range by a single analysis process.

5. The normalization method of claim 1 wherein the as-produced data set is characterized by a noise level in data element values, and wherein processing of each data element value to produce a normalized data set comprises reducing the noise level of the as-produced data set.

6. The normalization method of claim 1 further comprising a first step of producing an n-dimensional data set of data element values to be normalized.

7. The normalization method of claim 6 wherein producing an n-dimensional data set of data element values comprises producing an n-dimensional data set based on radar signals, wherein the data element values represent radar signal values.

8. The normalization method of claim 6 wherein producing an n-dimensional data set of data element values comprises producing an n-dimensional data set based on an acquired image, wherein the data element values represent image pixel values.

9. The normalization method of claim 6 wherein producing an n-dimensional data set of data element values comprises producing an n-dimensional data set based on sonar signals, wherein the data element values represent sonar signal values.

10. The normalization method of claim 6 wherein producing an n-dimensional data set of data element values comprises producing an n-dimensional data set based on an ultrasound image, wherein the data element values represent ultrasound image values.

11. The normalization method of claim 6 wherein producing an n-dimensional data set of data element values comprises producing an n-dimensional data set based on an acquired X-ray image, wherein the data element values represent X-ray image values.

12. The normalization method of claim 6 wherein producing an n-dimensional data set of data element values comprises producing an n-dimensional data set based on radio signals, wherein the data element values represent radio signal values.

13. The normalization method of claim 6 wherein producing an n-dimensional data set of data element values comprises producing an n-dimensional data set based on communications signals, wherein the data element values represent communications signal values.

14. The normalization method of claim 6 wherein producing an n-dimensional data set of data element values comprises producing an n-dimensional data set based on a video stream of images, wherein the data element values represent image pixel values.

15. The normalization method of claim 6 wherein producing an n-dimensional data set of data element values comprises producing an n-dimensional data set based on computed tomography signals, wherein the data element values represent tomography values.

16. The normalization method of claim 6 wherein producing an n-dimensional data set of data element values comprises producing an n-dimensional data set based on an acquired magnetic resonance image, wherein the data element values represent magnetic resonance image values.

17. The normalization method of claim 6 wherein producing an n-dimensional data set of data element values comprises producing a data set characterized by n=1.

18. The normalization method of claim 6 wherein producing an n-dimensional data set of data element values comprises producing a data set characterized by n=2.

19. The normalization method of claim 6 wherein producing an n-dimensional data set of data element values comprises producing a data set characterized by n=3.

20. The normalization method of claim 1 wherein estimating the mean of the probability density function of each data element by a digital processing technique comprises computer processing of the data element values to estimate the mean of the probability density function of each data element.

21. The normalization method of claim 1 wherein estimating the mean of the probability density function of each data element by a digital processing technique comprises digital hardware processing of the data element values to estimate the mean of the probability density function of each data element.

22. The normalization method of claim 1 wherein processing of each data element value to produce a normalized data set comprises dividing each data element value by the estimated mean of the probability density function of that data element.

23. The normalization method of claim 1 wherein processing of each data element value to produce a normalized data set comprises subtracting from each data element value the estimated mean of the probability density function of that data element.

24. The normalization method of claim 23 wherein processing of each data element value to produce a normalized data set further comprises adding a constant to each data value after subtraction of the estimated mean from that data value.

25. The normalization method of claim 1 wherein processing of each data element value to produce a normalized data set comprises processing the estimated probability density function means by biasing the estimated probability density function mean of each data element having a data value outside a specified data value range, and then processing each data element value based on the processed estimated probability density function means.

26. The normalization method of claim 1 further comprising determining a global statistical mean of the data set and dividing each data element value by the determined global mean before selecting a form of a probability density function statistical distribution for each data element.

27. The normalization method of claim 1 further comprising:
averaging together data element values in each of specified data element groups that together span the entire data set to produce an averaged data set of average data element values before selecting a form of a probability density function statistical distribution for each averaged data element and estimating the mean of the probability density function of each averaged data element; and
interpolating the estimated probability density function means of the averaged data element values based on the data element grouping and data element averaging before processing the data element values based on the estimated means.

28. The normalization method of claim 1 further comprising imposing on the estimation of the mean of the probability density function of each data element a smoothness parameter corresponding to a selected degree of allowable variation in estimated probability density function mean between adjacent data elements in the data set.

29. The normalization method of claim 28 further comprising:
detecting groups of data elements in the data set that exhibit a degree of variation in data value between adjacent data elements that exceeds a specified variation threshold; and
imposing on data element values in the detected data element groups a smoothness parameter corresponding to a selected degree of allowable variation in estimated mean between adjacent data elements in a data element group.

30. The normalization method of claim 1 further comprising imposing on the estimation of the mean of the probability density function of each data element a constant bias parameter corresponding to a selected probability of a specified allowable departure of a data element value from the probability density function mean to be estimated for that data element.

31. The normalization method of claim 1 further comprising imposing on the estimation of the mean of the probability density function of each data element a selected probability of a specified allowable degree of discontinuity in estimated probability density function means across the data set.

32. The normalization method of claim 1 wherein selecting a form of a probability density function statistical distribution for each data element based on the value of that data element comprises selecting a continuously distributed probability density function that is defined over a specified range of data element values.

33. The normalization method of claim 32 wherein selecting a form of a probability density function statistical distribution for each data element based on the value of that data element comprises selecting a gaussian probability density function form.

34. The normalization method of claim 32 wherein selecting a form of a probability density function statistical distribution for each data element based on the value of that data element comprises selecting a chi-squared probability density function form.

35. The normalization method of claim 32 wherein selecting a form of a probability density function statistical distribution for each data element based on the value of that data element comprises selecting an exponential probability density function form.

36. The normalization method of claim 1 wherein estimating the mean of the probability density function of each data element comprises mean-squared estimation of the mean.

37. The normalization method of claim 1 wherein estimating the mean of the probability density function of each data element comprises absolute cost function estimation of the mean.

38. The normalization method of claim 1 wherein estimating the mean of the probability density function of each data element comprises a maximum a posteriori estimation of the mean.

39. The normalization method of claim 38 wherein the maximum a posteriori estimation of the mean comprises a successive-line-over-relaxation solution of a maximum a posteriori matrix system expression.

40. The normalization method of claim 38 wherein the maximum a posteriori estimation of the mean comprises at least two iterations of solution of a maximum a posteriori system expression.

41. The normalization method of claim 38 wherein the maximum a posteriori estimation of the mean of the probability density function of each data element comprises selecting a form of a statistical distribution, across the data set, of the probability density function means to be estimated for the data elements of the data set.

42. The normalization method of claim 41 wherein selecting a form of a statistical distribution, across the data set, of the probability density function means to be estimated for the data elements of the data set comprises selecting a continuously distributed probability density function that is defined over a specified range of the probability density function means to be estimated.

43. The normalization method of claim 42 wherein selecting a form of a statistical distribution, across the data set, of the probability density function means to be estimated for the data elements of the data set comprises selecting a gaussian probability density function.

44. The normalization method of claim 42 wherein selecting a form of a statistical distribution, across the data set, of the probability density function means to be estimated for the data elements of the data set comprises selecting a chi-squared probability density function.

45. The normalization method of claim 42 wherein selecting a form of a statistical distribution, across the data set, of the probability density function means to be estimated for the data elements of the data set comprises selecting an exponential probability density function.

46. A method of normalizing a data set of data element values, comprising:
selecting a form of a statistical distribution of a probability density function for each data element of the data set based on the value of that data element;
estimating a mean of the probability density function of each data element by an analog digital processing technique; and
processing each data element value based on the estimated mean of the probability density function of that data element to normalize each data element value, producing a normalized data set.

47. A method of determining a mean for a data set of data element values, comprising:
selecting a form of a probability density function statistical distribution for each data element based on the value of that data element;
estimating a mean of the probability density function of each data element by a digital processing technique; and
designating as the mean of each data element the probability density function mean that was estimated for that data element.

48. The mean determination method of claim 47 further comprising a first step of producing an n-dimensional data set of data element values the means of which are to be determined.

49. The mean determination method of claim 48 wherein producing an n-dimensional data set of data element values comprises producing an n-dimensional data set based on radar signals, wherein the data element values represent radar signal values.

50. The mean determination method of claim 48 wherein producing an n-dimensional data set of data element values comprises producing an n-dimensional data set based on an acquired image, wherein the data element values represent image pixel values.

51. The mean determination method of claim 48 wherein producing an n-dimensional data set of data element values comprises producing an n-dimensional data set based on sonar signals, wherein the data element values represent sonar signal values.

52. The mean determination method of claim 48 wherein producing an n-dimensional data set of data element values comprises producing an n-dimensional data set based on an ultrasound image, wherein the data element values represent ultrasound image values.

53. The mean determination method of claim 48 wherein producing an n-dimensional data set of data element values comprises producing an n-dimensional data set based on an acquired X-ray image, wherein the data element values represent X-ray image values.

54. The mean determination method of claim 48 wherein producing an n-dimensional data set of data element values comprises producing an n-dimensional data set based on radio signals, wherein the data element values represent radio signal values.

55. The mean determination method of claim 48 wherein producing an n-dimensional data set of data element values comprises producing an n-dimensional data set based on communications signals, wherein the data element values represent communications signal values.

56. The mean determination method of claim 48 wherein producing an n-dimensional data set of data element values comprises producing an n-dimensional data set based on a video stream of images, wherein the data element values represent image pixel values.

57. The mean determination method of claim 48 wherein producing an n-dimensional data set of data element values comprises producing an n-dimensional data set based on computed tomography signals, wherein the data element values represent tomography values.

58. The mean determination method of claim 48 wherein producing an n-dimensional data set of data element values comprises producing an n-dimensional data set based on an acquired magnetic resonance image, wherein the data element values represent magnetic resonance image values.

59. The mean determination method of claim 48 wherein producing an n-dimensional data set of data element values comprises producing a data set characterized by n=1.

60. The mean determination method of claim 48 wherein producing an n-dimensional data set of data element values comprises producing a data set characterized by n=2.

61. The mean determination method of claim 48 wherein producing an n-dimensional data set of data element values comprises producing a data set characterized by n=3.

62. The mean determination method of claim 47 wherein estimating the mean of the probability density function of each data element by a digital processing technique comprises computer processing of the data element values to estimate the mean of the probability density function of each data element.

63. The mean determination method of claim 47 wherein estimating the mean of the probability density function of each data element by a digital processing technique comprises digital hardware processing of the data element values to estimate the mean of the probability density function of each data element.

64. The mean determination method of claim 47 further comprising determining a global statistical mean of the data set and dividing each data element value by the determined global statistical mean before selecting a form of a probability density function statistical distribution for each data element.

65. The mean determination method of claim 47 further comprising:
averaging together data element values in each of specified data element groups that together span the entire data set to produce an averaged data set of average data element values before selecting a form of a probability density function statistical distribution for each averaged data element and estimating the mean of the probability density function of each averaged data element; and
interpolating the estimated probability density function statistical means of the averaged data element values based on the data element grouping and data element averaging before processing the data element values based on the estimated means.

66. The mean determination method of claim 47 further comprising imposing on the estimation of the mean of the probability density function of each data element a smoothness parameter corresponding to a selected degree of allowable variation in estimated probability density function mean between adjacent data elements in the data set.

67. The mean determination method of claim 66 further comprising:
detecting groups of data elements in the data set that exhibit a degree of variation in data value between adjacent data elements that exceeds a specified variation threshold; and
imposing on data element values in the detected data element groups a smoothness parameter corresponding to a selected degree of allowable variation in estimated mean between adjacent data elements in a data element group.

68. The mean determination method of claim 47 further comprising imposing on the estimation of the mean of the probability density function of each data element a constant bias parameter corresponding to a selected probability of a specified allowable departure of a data element value from the probability density function mean to be estimated for that data element.

69. The mean determination method of claim 47 further comprising imposing on the estimation of the mean of the probability density function of each data element a selected probability of a specified degree of allowable discontinuity in estimated probability density function means across the data set.

70. The mean determination method of claim 47 wherein selecting a form of a probability density function statistical distribution for each data element based on the value of that data element comprises selecting a continuously distributed probability density function that is defined over a specified range of data element values.

71. The mean determination method of claim 70 wherein selecting a form of a probability density function statistical distribution for each data element based on the value of that data element comprises selecting a gaussian probability density function form.

72. The mean determination method of claim 70 wherein selecting a form of a probability density function statistical distribution for each data element based on the value of that data element comprises selecting a chi-squared probability density function form.

73. The mean determination method of claim 70 wherein selecting a form of a probability density function statistical distribution for each data element based on the value of that data element comprises selecting an exponential probability density function form.

74. The mean determination method of claim 47 wherein estimating the mean of the probability density function of each data element comprises mean-squared estimation of the mean.

75. The mean determination method of claim 47 wherein estimating the mean of the probability density function of each data element comprises absolute cost function estimation of the mean.

76. The mean determination method of claim 47 wherein estimating the mean of the probability density function of each data element comprises a maximum a posteriori estimation of the mean.

77. The mean determination method of claim 76 wherein the maximum a posteriori estimation of the mean comprises a successive-line-over-relaxation solution of a maximum a posteriori matrix system expression.

78. The mean determination method of claim 76 wherein the maximum a posteriori estimation of the mean comprises at least two iterations of solution of a maximum a posteriori system expression.

79. The mean determination method of claim 76 wherein the maximum a posteriori estimation of the mean of the probability density function of each data element comprises selecting a form of a statistical distribution, across the data set, of the probability density function means to be estimated for the data elements of the data set.

80. The mean determination method of claim 79 wherein selecting a form of a statistical distribution, across the data set, of the probability density function means to be estimated for the data elements of the data set comprises selecting a continuously distributed probability density function that is defined over a specified range of the probability density function means to be estimated.

81. The mean determination method of claim 80 wherein selecting a form of a statistical distribution, across the data set, of the probability density function means to be estimated for the data elements of the data set comprises selecting a gaussian probability density function.

82. The mean determination method of claim 80 wherein selecting a form of a statistical distribution, across the data set, of the probability density function means to be estimated for the data elements of the data set comprises selecting a chi-squared probability density function.

83. The mean determination method of claim 80 wherein selecting a form of a statistical distribution, across the data set, of the probability density function means to be estimated for the data elements of the data set comprises selecting an exponential probability density function.

84. A method of determining a mean for a data set of data element values, comprising:
selecting a form of a probability density function statistical distribution for each data element based on the value of that data element;
estimating a mean of the probability density function of each data element by an analog processing technique; and
designating as the mean of each data element the probability density function mean that was estimated for that data element.

85. The mean determination method of claim 60 wherein estimating a mean of the probability density function of each data element by a digital processing technique comprises estimating a first mean of the probability density function of each data element based on processing along a first dimension of the data set and estimating a second mean of the probability density function of each data element based on processing along a second dimension of the data set; and
wherein designating as the mean of each data element the probability density function mean that was estimated for that data element comprises comparing the first and second estimated means for each data element and designating as the mean of that data element the smaller of the first and second estimated means.
